(19) United States
(12) Patent Application Publication
(10) Pub. No.: US 2013/0077672 A1
(43) Pub. Date: Mar. 28, 2013

(54) IMAGE PROCESSING APPARATUS AND METHOD

(71) Applicant: Kazushi Sato, Kanagawa (JP)

(72) Inventor: Kazushi Sato, Kanagawa (JP)

(21) Appl. No.: 13/701,968

(22) PCT Filed: Jun. 2, 2011
(86) PCT No.: PCT/JP2011/062648

§ 371 Date: Dec. 4, 2012

(30) Foreign Application Priority Data
Jun. 11, 2010 (JP) 2010 134036

(51) Int. Cl. H04N 7/26

(52) U.S. Cl. CPC H04N 19/00018
USPC 375/240.02

(57) ABSTRACT

The disclosure relates to an image processing apparatus and method that can improve encoding efficiency. The image processing apparatus includes: an intra prediction unit that performs intra prediction by using a plurality of prediction modes and selects an optimum prediction mode, based on an obtained result of prediction; an updating unit that updates allocation of code number for the respective prediction modes of the intra prediction performed by the intra prediction unit such that a smaller value is allocated to a prediction mode with a higher frequency of occurrence; and an encoding unit that encodes a code number allocated to the prediction mode of the intra prediction, executed by the intra prediction unit, the code number being allocation according to the updated code number allocation. The technology is applicable to, for example, an image processing apparatus.

### TECHNICAL FIELD

The disclosure relates to an image processing apparatus and method, and more particularly to an image processing apparatus and method which can improve encoding efficiency.

### BACKGROUND ART

In recent years, devices that comply with an encoding scheme such as MPEG (Moving Picture Experts Group) have come into widespread use for both information dissemination by broadcasting stations and information reception by ordinary households, where the devices handles image information as digital signals and at this time compress the image by orthogonal transformation such as discrete cosine transformation or the like, or motion compensation, taking advantage of redundancy which is a feature of the image information, in order to achieve highly efficient transmission and storage of information.

In particular, MPEG2 (ISO (International Organization for Standardization)/IEC (International Electrotechnical Commission) 13818-2) is defined as a general-purpose image encoding scheme and is a standard encompassing both interlaced-scanning images and sequential scanning images, standard resolution images, and high definition images. MPEG2 is employed now by a broad range of applications for professional uses and consumer uses. By employing the MPEG2 compression scheme, for instance, a code amount (bit rate) of 4 through 8 Mbps is allocated in the event of an interlaced-scanning image of a standard resolution with 720×480 pixels, and a code amount (bit rate) of 18 through 22 Mbps is allocated in the event of an interlaced-scanning image of a high resolution with 1920×1088 pixels. With this, a high compression ratio and a good image quality can be realized.

The MPEG2 has principally aimed at high resolution image encoding suited for broadcasting, but it does not respond to an encoding scheme which encodes a smaller amount of codes (lower bit rate) than MPEG1, that is, an encoding scheme that encodes at a high compression rate. With the popularity of mobile terminals, the demand for such an encoding scheme is expected to increase in the future. To respond this, standardization of MPEG4 encoding schemes have been confirmed. With regard to an image encoding scheme, the specification thereof was confirmed as the international standard ISO/IEC 14496-2 in December in 1998.

In addition, in recent years, originally for the purpose of video coding for television conferencing, standardization of specifications of a standard called H.26L ((ITU-T) International Telecommunication Union Telecommunication Standardization Sector) Q6/16 VCEG (Video Coding Expert Group) has progressed. H.261, is known to achieve higher encoding efficiency although it requires a greater amount of computations for encoding and decoding than conventional encoding schemes such as MPEG2 and MPEG4. Also, currently, as part of the activity of MPEG4, standardization for incorporating functions, which are not supported by H.26L, into the H.26L is performed as Joint Model of Enhanced-Compression Video Coding to realize high encoding efficiency.

The schedule of standardization showed that, it became an international standard under the name of H.264 and MPEG-4 Part 10 (Advanced Video Coding, hereinafter referred to as AVC) in March, 2003.

Further, as an expansion thereof, standardization of FRExt (Fidelity Range Extension) which includes encoding tools necessary for business operations, such as RGB, 4:2:2, 4:4:4, and so forth, and MPEG-2 stipulated 8×8DCT (Discrete Cosine Transform) and quantization matrices has been completed in February, 2005. It became an encoding scheme capable of expressing well film noise included in movies using the AVC, and will be used in a wide range of applications such as Blu-Ray Disc.

However, nowadays, there is an increasing demand for even further high compression rate encoding, such as to compress images of about 4000×2000 pixels which account for four times the high-definition television image pixels, or such as to distribute high-definition television images in the environment with limited transmission capacity such as the Internet. Therefore, VCEG (Video Coding Expert Group) under the ITU-T is continuing study on improved encoding efficiency.

Incidentally, setting the size of a macroblock to 16 pixels×16 pixels which has been in practice so far is not optimal for a big image frame named UHD (Ultra High Definition; 4000 pixels×2000 pixels) that will become an object of the next generation encoding scheme. Therefore, Non-Patent Document 2 proposes a larger size, for example, 64×64 pixels or 32 pixel×32 pixels, as the size of a macroblock.

### CITATION LIST

### Non-Patent Document

Non-Patent Document 1: Sung-Chang Lim, Hahyun Lee, Jinho Lee, Jongho Kim, Haechul Choi, Seyoon Jeong, Jin Soo Choi, “Intra coding using extended block size”, VCEG-AL28, July, 2009

### SUMMARY OF THE INVENTION

### Problems to be Solved by the Invention

Incidentally, the intra prediction technique improves the encoding efficiency by allocating a shorter code number (code_number) to a more frequently occurring prediction mode. However, the AVC encoding scheme employs fixed allocation although the more frequently occurring prediction mode changes depending on the sequence or bit rate. Accordingly, it is difficult to achieve the optimal encoding efficiency with the AVC encoding scheme.

The present disclosure is made in view of the situations, and is intended to provide means capable of improving the encoding efficiency by allocating more appropriate code numbers to prediction modes.

### Solutions to Problems

An aspect of the present disclosure is an image processing apparatus including: an intra prediction unit that performs intra prediction by using a plurality of prediction modes and selects an optimum prediction mode based on an obtained result of prediction; an updating unit that updates allocation of code numbers for the respective prediction modes of the intra prediction performed by the intra prediction unit such that a smaller value is allocated to the prediction mode with a higher frequency of occurrence; and an encoding unit that encodes the code number allocated to the prediction mode of the intra prediction, executed by the intra prediction unit, according to the code number allocation updated by the updating unit.

The updating unit may update the allocation of code numbers, according to the frequency of occurrence, for at least one prediction mode among an intra 4×4 prediction mode, an intra 8×8 prediction mode, an intra 16×16 prediction mode, an intra prediction mode for an expanded macroblock, which is an encoding process unit, expanded to have a size larger than 16×16 pixels, and an intra prediction mode for a chrominance signal.

The image processing apparatus may further include: an IDR slice detecting unit that detects an IDR slice and determines whether the current slice is an IDB slice, wherein the updating unit may initialize the allocation of code numbers with respect to the slice and set the allocation of code numbers to a predetermined initial value when the slice is determined to be the IDR slice by the detection of the IDR slice detecting unit.

The initial value of the allocation of code numbers may be a code number allocation method stipulated in an AVC encoding scheme.

The image processing apparatus may further include a scene change detecting unit that detects a scene change in the current slice, wherein the updating unit may initialize the allocation of code numbers with respect to the slice and set the allocation of code numbers to a predetermined initial value when the scene change detecting unit determines that the scene change is included in the scene.

The updating unit may set a value of flag information indicating that the allocation of code numbers with respect to the slice is the allocation of code numbers updated by the updating unit or the predetermined initial value, to a value indicating the initial value when the scene change detecting unit determines that the scene change is included in the scene.

The updating unit may update the allocation of code numbers with respect to a next I slice after encoding processing on the current I slice is finished, in a manner that a smaller value is allocated to each prediction mode with a higher frequency of occurrence in the I slice.

The updating unit may set the allocation of code numbers for intra macroblocks included in a P slice or a B slice to a predetermined initial value.

The updating unit may update the allocation of code numbers for intra macroblocks included in a P slice or a B slice to the allocation of code numbers which is set with respect to an immediately previous I slice.

The updating unit may update, when the number of intra macroblocks included in a P slice or a B slice is larger than a predetermined reference, the allocation of code numbers for intra macroblocks included in the P slice or the B slice such that a smaller value is allocated to a prediction mode with a higher frequency of occurrence.

The updating unit may update even allocation of a code number for a motion compensation partition mode according to the frequency of occurrence of the mode.

An aspect of the present disclosure is an image processing method of an image processing apparatus, including: by an intra prediction unit, performing intra prediction by using a plurality of prediction modes and selecting an optimum prediction mode, based on an obtained result of prediction; by an updating unit, updating allocation of code numbers for the respective prediction modes of the intra prediction such that a smaller value is allocated to a prediction mode with a higher frequency of occurrence; and by an encoding unit, encoding a code number for an executed prediction mode of the intra prediction, the code number being allocated according to the updated code number allocation.

Another aspect of the present disclosure is an image processing apparatus including: a decoding unit that decodes a code number for a prediction of intra prediction; an updating unit that updates allocation of code numbers for the respective prediction modes of the intra prediction such that a smaller value is allocated to a prediction mode with a higher frequency of occurrence; and an intra prediction unit that performs the intra prediction in a prediction mode corresponding to the code number decoded by the decoding unit, according to the allocation of code numbers updated by the updating unit.

Another aspect of the present disclosure is an image processing method of an image processing apparatus, including: by a decoding unit, decoding a code number for a prediction of intra prediction; by an updating unit, updating allocation of code numbers for the respective prediction modes of the intra prediction such that a smaller value is allocated to a prediction mode with a higher frequency of occurrence; and by an intra prediction unit, performing the intra prediction in a prediction mode corresponding to the decoded code number, according to the updated allocation of code numbers.

In one aspect of the disclosure, intra prediction is performed by using a plurality of prediction modes, a most optimal prediction mode is selected based on the obtained result of prediction, allocation of code numbers to the respective predictions modes of the intra prediction is updated such that a smaller value is allocated to a more frequently occurring prediction mode, and a code number allocated to the executed prediction mode of the intra prediction which is allocated according to the updated code number allocation is encoded.

In another aspect of the disclosure, a code number for a prediction mode of intra prediction is decoded, allocation of code numbers to the respective prediction modes of the intra prediction is updated such that a smaller value is allocated to a more frequently occurring prediction mode, and the intra prediction is performed in the prediction mode corresponding to the decoded code number according to the updated code number allocation.

### Effects of the Invention

According to the disclosure, an image can be processed. In particular, encoding efficiency can be improved.

### BRIEF DESCRIPTION OF THE DRAWINGS

FIG. 1 is a block diagram that illustrates an example of a main configuration of an image encoding device.

FIG. 2 is a diagram that illustrates a processing sequence of a 4×4 block included in a macroblock in AVC encoding scheme.

FIG. 3 is a diagram that illustrates an intra 4×4 prediction mode stipulated in the AVC encoding scheme.

FIG. 4 is a diagram that illustrates an intra 4×4 prediction mode stipulated in the AVC encoding scheme.

FIG. 5 is a diagram that illustrates a prediction direction of an intra 4×4 prediction mode stipulated in the AVC encoding scheme.

FIG. 6 is a diagram for describing a prediction method of an intra 4×4 prediction mode stipulated in the AVC encoding scheme.

FIG. 7 is a diagram for describing an encoding method of an intra 4×4 prediction mode stipulated in the AVC encoding scheme.

FIG. 8 is a diagram that illustrates an intra 8×8 prediction mode stipulated in the AVC encoding scheme.

FIG. 9 is a diagram that illustrates an intra 8×8 prediction mode stipulated in the AVC encoding scheme.

FIG. 10 is a diagram that illustrates an intra 16×16 prediction mode stipulated in the AVC encoding scheme.

FIG. 11 is a diagram that illustrates an intra 16×16 prediction mode stipulated in the AVC encoding scheme.

FIG. 12 is a diagram for describing a method of calculating a prediction value in an intra 16×16 prediction mode stipulated in the AVC encoding scheme.

FIG. 13 is a diagram that illustrates an example of a prediction mode for a chrominance signal which is stipulated in the AVC encoding scheme.

FIG. 14 is a diagram that illustrates an example of a code number according to a CAVLC scheme stipulated in the AVC encoding scheme.

FIG. 15 is a diagram that illustrates an example of a code number for a motion vector according to the CAVLC scheme stipulated in the AVC encoding scheme.

FIG. 16 is a diagram that illustrates an example of a scanning system stipulated in the AVC encoding scheme.

FIG. 17 is a diagram that illustrates a specific example of an operation principle of the CAVLC stipulated in the AVC encoding scheme.

FIG. 18 is a diagram for describing an operation principle of a binary arithmetic coding.

FIG. 19 is a diagram for describing renormalization processing in a binary arithmetic coding.

FIG. 20 is a diagram that illustrates an outline of a CABAC scheme.

FIG. 21 is a diagram that describes an example of unary_code.

FIG. 22 is a diagram that describes an example of a table that defines I raster.

FIG. 23 is a diagram that describes an example of a table that defines P raster.

FIG. 24 is a diagram that describes an example of a table that defines B raster.

FIG. 25 is a diagram that illustrates a detailed configuration example of code number allocation of FIG. 1.

FIG. 26 is a flowchart that describes an example of the flow of encoding processing.

FIG. 27 is a flowchart that describes an example of the flow of intra prediction processing.

FIG. 28 is a flowchart that describes an example of the flow of code number allocation processing for raster.

FIG. 29 is a flowchart that describes an example of the flow of code number allocation processing for P raster or B raster.

FIG. 30 is a block diagram that illustrates a main configuration example of an image encoding device.

FIG. 31 is a block diagram that illustrates a detailed configuration example of a code number allocating unit of FIG. 30.

FIG. 32 is a flowchart that describes an example of the flow of decoding processing.

FIG. 33 is a flowchart that describes an example of the flow of prediction processing.

FIG. 34 is a flowchart that describes an example of the flow of code number allocation processing.

FIG. 35 is a diagram that illustrates an example of a macroblock.

FIG. 36 is a block diagram that illustrates a main configuration example of a personal computer.

FIG. 37 is a block diagram that illustrates a main configuration example of a television receiver.

FIG. 38 is a block diagram that illustrates a main configuration example of a mobile phone.

FIG. 39 is a block diagram that illustrates a main configuration example of a hard disc recorder.

FIG. 40 is a block diagram that illustrates a main configuration example of a camera.

### MODE FOR CARRYING OUT THE INVENTION

Hereinafter, forms for embodying the present technology (hereafter, referred to as embodiments) are described. The description is made in the following order.

1. First embodiment (an image encoding device)

2. Second embodiment (an image decoding device)

3. Third embodiment (a personal computer)

4. Fourth embodiment (a television receiver)

5. Fifth embodiment (a mobile phone)

6. Sixth embodiment (a hard disc recorder)

7. Seventh embodiment (a camera)

### 1. First Embodiment

### Image Encoding Device

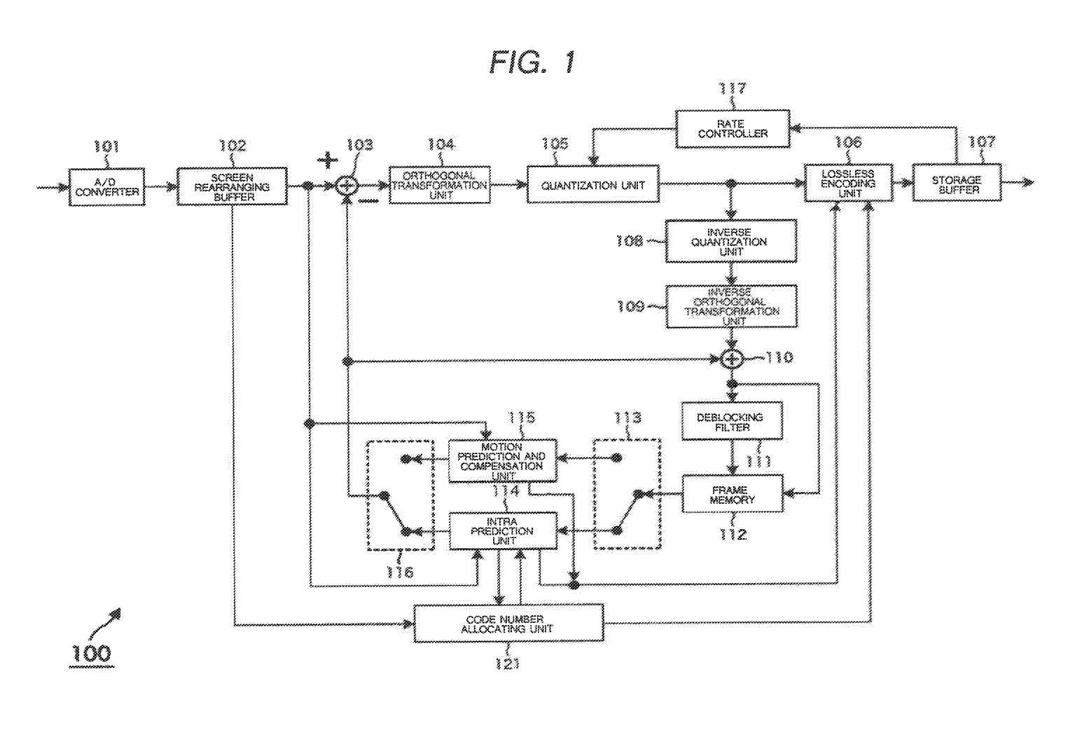

FIG. 1 illustrates a configuration of one embodiment of an image encoding device serving as an image processing apparatus.

An image encoding device 100 illustrated in FIG. 1 is, for example, an encoding device that encodes an image in a similar manner with the H.264 and MPEG (Moving Picture Experts Group) 4 Part 10 (AVC (Advanced image Coding)) (hereinafter, called H.264/AVC). However, the image encoding device 100 adaptively allocates code numbers (code_number) to intra prediction modes according to the frequency of occurrence. In this way, the image encoding device 100 can further improve the encoding efficiency of the encoded data which is output.

In the example of FIG. 1, the image encoding device 100 includes an A/D (Analog/Digital) converter 101, a screen rearranging buffer 102, a computing unit 103, an orthogonal transformation unit 104, a quantization unit 105, a lossless encoding unit 106, and a storage buffer 107. The image encoding device 100 further includes an inverse quantization unit 108, an inverse orthogonal transformation unit 109, a computing unit 110, a deblocking filter 111, a frame memory 112, a selecting unit 113, an intra prediction unit 114, a motion prediction and compensation unit 115, a selecting unit 116, and a rate controller 117.

In addition, the image encoding device 100 yet further includes a code number allocating unit 121.

The A/D converter 101 converts input image data from analog to digital, and outputs the resultant data to the screen rearranging buffer 102 for storage.

The screen rearranging buffer 102 rearranges the images of frames stored in the order for display so as to be in the order of frames for encoding, according to GOP (Group of Picture) structure. The screen rearranging buffer 102 supplies the images, in which the frames thereof are rearranged, to the computing unit 103. Moreover, the screen rearranging buffer 102 supplies the images, in which the frames thereof are rearranged, to the intra prediction unit 114 and the motion prediction and compensation unit 115.

The computing unit 103 subtracts a prediction image supplied from the intra prediction unit 114 or the motion prediction and compensation unit 115 through the selecting unit 116, from an image which is read from the screen rearranging buffer 102, and outputs difference information to the orthogonal transformation unit 104.

For example, for the image to be subjected to intra coding, the computing unit 103 subtracts the prediction image supplied from the intra prediction unit 114, from the image which is read from the screen rearranging buffer 102. For example, for the image to be subjected to inter coding, the computing unit 103 subtracts the prediction image supplied from the motion prediction and compensation unit 115, from the image which is read from the screen rearranging buffer 102.

The orthogonal transformation unit 104 performs orthogonal transformation such as discrete cosine orthogonal transformation and Karhunen-Loeve transformation on the difference information supplied from the computing unit 103, and supplies transformation coefficients to the quantization unit 105.

The quantization unit 105 quantizes the transformation coefficients output from the orthogonal transformation unit 104. The quantization unit 105 sets quantization parameters based on information supplied from the rate controller 117, and performs the quantization. The quantization unit 105 supplies the quantized transformation coefficients to the lossless encoding unit 106.

The lossless encoding unit 106 performs lossless encoding such as variable length coding and arithmetic coding on the quantized transformation coefficients.

The lossless encoding unit 106 acquires information that indicates the intra prediction from the intra prediction unit 114, and acquires information that indicates the inter prediction mode, motion vector information, etc. from the motion prediction and compensation unit 115. Hereafter, the information that indicates the intra prediction (in-screen prediction) is called intra prediction mode information. Hereafter, the information that indicates information mode that indicates the inter prediction (inter-screen prediction) is called inter prediction mode information.

The lossless encoding unit 106 encodes the quantized transformation coefficients, and uses (multiplexes), as part of header information of encoded data, various kinds of information such as filter coefficients, intra prediction mode information, inter prediction mode information, and quantization parameters. The lossless encoding unit 106 supplies the encoded data obtained through the encoding, to the storage buffer 107 so that the encoded data may be stored.

For instance, in the lossless encoding unit 106, lossless encoding processing such as variable length coding and arithmetic coding is performed. The CAVLC (Context-Adaptive Variable Length Coding), etc. provided by the H.264/AVC scheme are examples of the variable length coding. The CABAC (Context-Adaptive Binary Arithmetic Coding), etc. are examples of the arithmetic coding.

The storage buffer 107 temporarily holds the encoded data supplied from the lossless encoding unit 106, and outputs it to a recording apparatus, a transmission path, or the like provided in a subsequent stage, for example, as the encoded image which is encoded based on the H.264/AVC scheme at given timing.

The transformation coefficients quantized by the quantization unit 105 are also supplied to the inverse quantization unit 108. The inverse quantization unit 108 performs inverse quantization on the quantized transformation coefficients by a method corresponding to the quantization method performed by the quantization unit 105. The inverse quantization unit 108 supplies the obtained transformation coefficients to the inverse orthogonal transformation unit 109.

The inverse orthogonal transformation unit 109 performs inverse orthogonal transformation on the supplied transformation coefficients by a method corresponding to the orthogonal transformation processing performed by the orthogonal transformation unit 104. The output (decoded difference information) which is a result of the inverse orthogonal transformation is supplied to the computing unit 110.

The computing unit 110 adds the prediction image which is supplied from the intra prediction unit 114 or the motion prediction and compensation unit 115 through the selecting unit 116, to the result of the inverse orthogonal transformation, that is, the decoded difference information, supplied from the inverse orthogonal transformation unit 109, and obtains locally decoded image (decoded image).

For instance, when the difference information corresponds to an image to be subjected to the intra encoding, the computing unit 110 adds the prediction image supplied from the intra prediction unit 114 to the difference information. Moreover, for example, when the difference information corresponds to an image to be subjected to the inter coding, the computing unit 110 adds the prediction image supplied from the motion prediction and compensation unit 115 to the difference information.

The addition result is supplied to the deblocking filter 111 or the frame memory 112.

The deblocking filter 111 removes the block distortion by performing appropriate deblocking filtering, and then performs appropriate loop filtering by using, for example, a Wiener filter, thereby improving the image quality. The deblocking filter 111 classifies each pixel, and performs appropriate filtering processing for each class. The deblocking filter 111 supplies the result of the filtering processing to the frame memory 112.

At given timing, the frame memory 112 outputs stored reference images to the intra prediction unit 114 or the motion prediction and compensation unit 115 through the selecting unit 113.

For example, for the image to be subjected to the intra encoding, the frame memory 112 supplies the reference image to the intra prediction unit 114 through the selecting unit 113. Moreover, for the image to be subjected to the inter encoding, the frame memory 112 supplies the reference image to the motion prediction and compensation unit 115 through the selecting unit 113.

When the reference image supplied from the frame memory 112 is an image for the intra encoding, the selecting unit 113 supplies the reference image to the intra prediction unit 114. When the reference image supplied from the frame memory 112 is an image for the inter encoding, the selecting unit 113 supplies the reference image to the motion prediction and compensation unit 115.

The intra prediction unit 114 performs an intra prediction (in-screen prediction) which generates a prediction image by using pixel values in a screen. The intra prediction unit 114 performs the intra prediction in a plurality of modes (intra prediction modes).

The intra prediction unit 114 generates the prediction images in all intra prediction modes, evaluates each prediction image, and selects an optimal mode. When an optimal intra prediction mode is selected, the intra prediction unit 114 supplies the prediction image generated in the optimal mode to the computing unit 103 and the computing unit 110 through the selecting unit 116.

Moreover, as described above, the intra prediction unit 114 properly supplies information such as the intra prediction mode information that indicates the adopted intra prediction mode to the lossless encoding unit 106.

In addition, the intra prediction unit 114 supplies information such as the intra prediction mode information that indicates the adopted intra prediction mode to the code number allocating unit 121 so that the code number allocating unit 121 can perform adaptive code number allocation according to the frequency of occurrence of the intra prediction mode.

The motion prediction and compensation unit 115 performs a motion prediction with respect to the image which is to be subjected to the inter coding by using an input image supplied from the screen rearranging buffer 102 and the reference image supplied from the frame memory 112 through the selecting unit 113, performs motion compensation processing according to the detected motion vector, and generates a prediction image (inter prediction image information).

The motion prediction and compensation unit 115 performs inter prediction processing in all candidate inter prediction modes, and generates the prediction images. The motion prediction and compensation unit 115 supplies the generated prediction images to the computing unit 103 and the computing unit 110 through the selecting unit 116.

Moreover, the motion prediction and compensation unit 115 supplies the inter prediction mode information that indicates the adopted inter prediction mode, and motion vector information that indicates the calculated motion vector, to the lossless encoding unit 106.

The selecting unit 116 supplies the output of the intra prediction unit 114 to the computing unit 103 and the computing unit 110 when the image is to be subjected to the intra coding, and supplies the output of the motion prediction and compensation unit 115 to the computing unit 103 and the computing unit 110 when the image is to be subjected to the inter coding.

The rate controller 117 controls the rate of the quantization operation of the quantization unit 105, based on the compressed image stored in the storage buffer 107, so as not to cause overflow or underflow.

When the information that indicates the adopted intra prediction mode supplied from the intra prediction unit 114 is acquired, the code number allocating unit 121 adaptively allocates a code number to each of the intra prediction modes according to the frequency of occurrence of each intra prediction mode.

[Intra Prediction Mode]

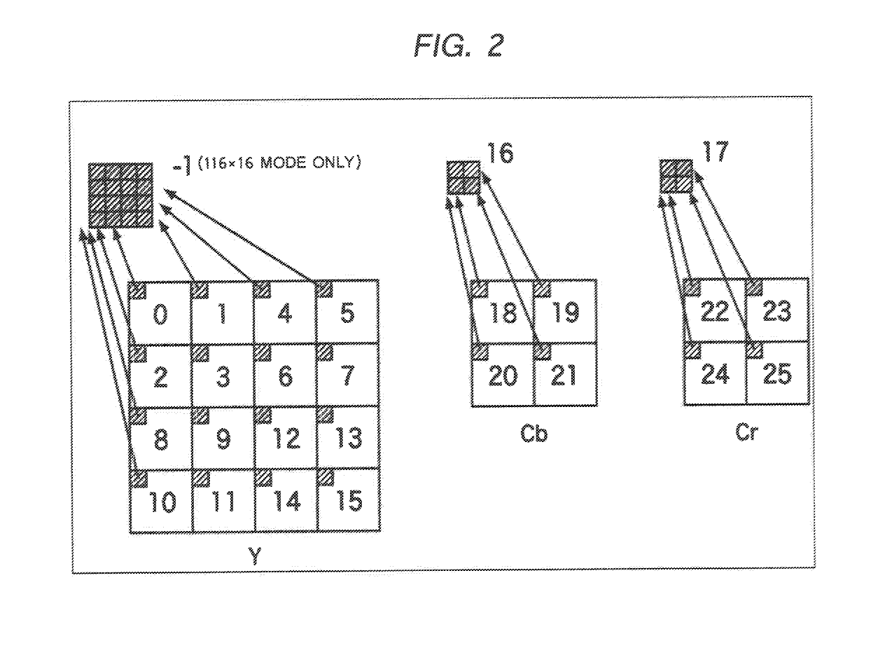

Next, an intra prediction method provided by the AVC encoding scheme is described. The AVC encoding scheme provides three prediction modes including a 4×4 intra prediction mode, a 8×8 intra prediction mode, and a 16×16 intra prediction mode for a luminance signal. As illustrated in FIG. 2, in the 16×16 intra prediction mode, DC components of each block are collected to generate a 4×4 matrix. Then, the matrix is subjected to the orthogonal transformation.

The intra 8×8 prediction mode can be used only when the 8×8 orthogonal transformation is performed on the macroblock with a profile equal to or exceeding a high profile.

[4×4 Intra Prediction Mode]

Hereinbelow, the 4×4 intra prediction mode is first described.

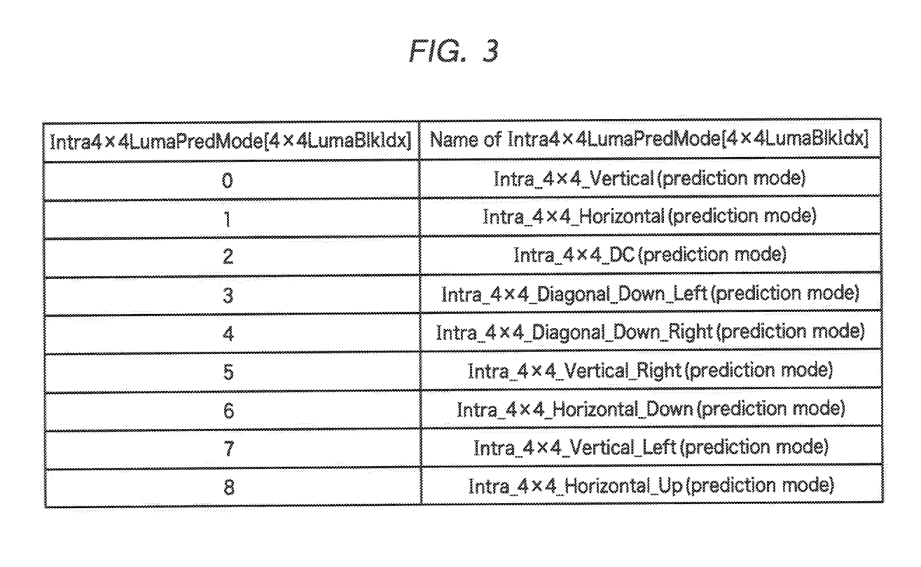

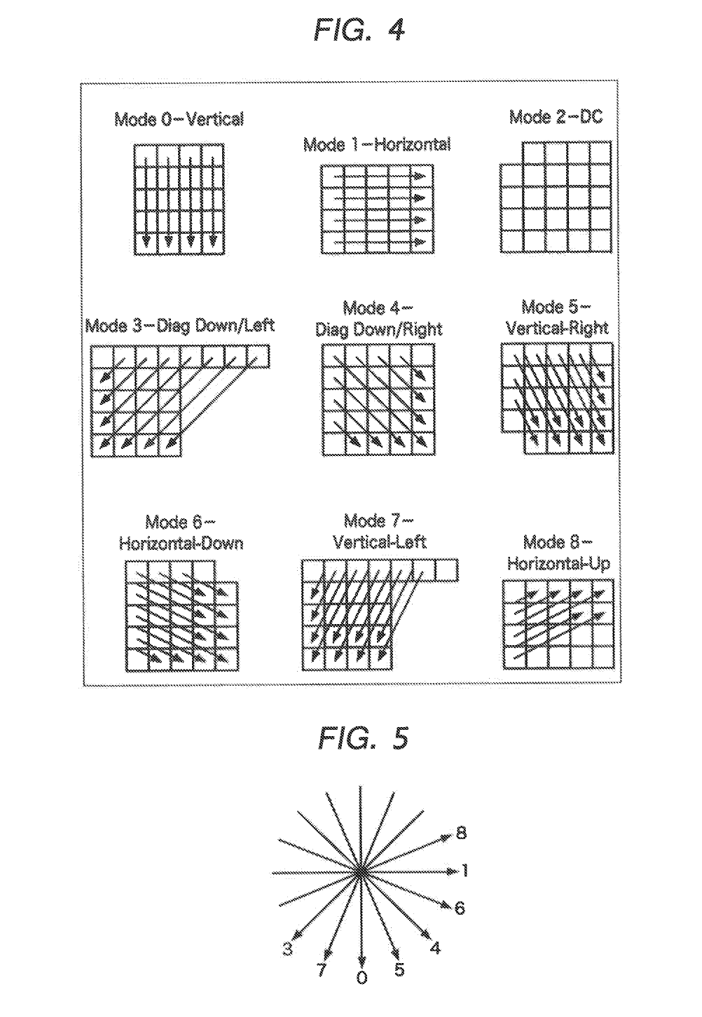

FIGS. 3 and 4 illustrate 9 kinds of 4×4 intra prediction modes provided by the AVC encoding scheme. Among these, each of the modes other than DC prediction mode (Mode 2) exhibits a predetermined direction as illustrated in FIG. 5.

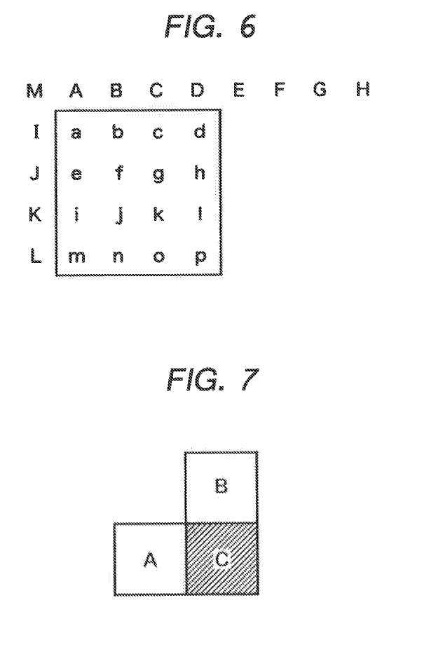

In FIG. 6, ‘a’ through ‘p’ represent pixel values of the block, and ‘A’ through ‘M’ represent pixel values of adjacent blocks. In each mode listed in a table, prediction pixel values of ‘a’ through ‘p’ are generated by using ‘A’ through ‘M’ as described below.

Mode 0 (Mode 0) is Vertical Prediction and is applied only when A, B, C, and D are “available”. The prediction pixel values are as follows.

a, e, i, m: A

b, f, j, n: B

c, g, k, o: C

d, h, l, p: D

Mode 1 (Mode 1) is Horizontal Prediction and is applied only when I, J, K, and L are “available”. Each of the prediction pixel values is generated as follows.

a, b, c, d: I

e, f, g, h: J

i, j, k, l: K

m, n, o, p: L

Mode 2 (Mode 2) is DC Prediction, and prediction values are generated as indicated by the following Expression (1) when all of A, B, C, D, I, J, K, and L are “available”.

[Expression 1]

(A+B+C+D+I+J+K+L+4)>>3 (1)

In addition, the prediction values are generated as indicated by the following Expression (2) when all of A, B, C, and D are “unavailable”.

[Expression 2]

(I+J+K+L+2)>>2 (2)

In addition, the prediction values are generated as indicated by the following Expression (3) when all of I, J, K, and L are “unavailable”.

[Expression 3]

(A+B+C+D+2)>>2 (3)

When all of A, B, C, D, I, J, K, and L are “available”, 128 is used as the prediction value.

Mode 3 (Mode 3) is Diagonal_Down_Left Prediction and is applied only when A, B, C, D, I, J, K, L, and M are “available”. Each of the prediction pixel values is generated as follows.

a: (A+2B+C+2)>>2

b, e: (B+2C+D+2)>>2

c, f, i: (C+2D+B+2)>>2

d, g, j, m: (D+2E+F+2)>>2

h, k, n: (E+2F+C+2)>>2

l, o: (F+2G+H+2)>>2

p: (G+3H+2)>>2

Mode 4 (Mode 4) is Diagonal_Down_Right Prediction and is applied only when A, B, C, C, I, J, K, L, and M are “available”. Each of the prediction pixel values is generated as follows.

m: (J+2K+L+2)>>2

i, n: (I+2J+K+2)>>2

e, j, o: (M+2I+J+2)>>2

a, f, k, p: (A+2M+I+2)>>2

b, g, l: (M+2A+B+2)>>2

c, h: (A+2B+C+2)>>2

d: (B+2C+D+2)>>2

Mode 5 (Mode 5) is Diagonal_Vertical_Right Prediction and is applied only when A, B, C, D, I, J, K, L, and M are “available”. Each of the prediction pixel values is generated as follows.

a, j: (M+A+1)>>1

b, k: (A+B+1)>>1

c, l: (B+C+1)>>1

d: (C+D+1)>>1

e, n: (I+2M+A+2)>>2

f, o: (M+2A+B+2)>>2

g, p: (A+2B+C+2)>>2

h: (B+2C+D+2)>>2

i: (M+2I+J+2)>>2

m: (I+2J+K+2)>>2

Mode 6 (Mode 6) is Horizontal_Down Prediction and is applied only when A, B, C, D, I, J, K, L, and M are “available”. Each of the prediction pixel values is generated as follows.

a, g: (M+I+1)>>1

b, h: (I+2M+A+2)>>2

c: (M+2A+B+2)>>2

d: (A+2B+C+2)>>2

e, k: (I+J+1)>>1

f, l: (M+2I+2)>>2

i, o: (J+K+1)>>1

j, p: (I+2J+K+2)>>2

m: (K+L+1)>>1

n: (J+2K+L+2)>>2

Mode 7 (Mode 7) is Vertical_Left Prediction and is applied only when A, B, C, D, I, J, K, L, and M are “available”. Each of the prediction pixel values is generated as follows.

a: (A+B+1)>>1

b, i: (B+C+1)>>1

c, j: (C+D+1)>>1

d, k: (D+E+1)>>1

l: (E+F+1)>>1

e: (A+2B+C+2)>>2

f, m: (B+2C+D+2)>>2

g, n: (C+2D+B+2)>>2

h, o: (D+2E+F+2)>>2

p: (B+2F+G+2)>>2

Mode 8 (Mode 8) is Horizontal_Up Prediction and is applied only when A, B, C, C, I, J, K, L, and M are “available”. Each of the prediction pixel values is generated as follows.

a: (I+J+1)>>1

b: (I+2J+K+2)>>2

c, e: (J+K+1)>>1

d, f: (J+2K+L+2)>>2

g, i: (K+L+1)>>1

h, j: (K+3L+2)>>2

k, l, m, n, o, p: L

Next, an encoding scheme of the intra 4×4 prediction mode (Intra_{—}4×4_pred_mode) is described.

In FIG. 7, when C is assumed to be the 4×4 block and A and B are assumed to be adjacent 4×4 blocks, the 4×4 intra prediction mode (Intra_{—}4×4_pred_mode) for C and the 4×4 intra prediction mode (Intra_{—}4×4_pred_mode) for A and B are considered to have a high correlation. Based on this fact, a higher encoding efficiency can be achieved when the following encoding processing is performed.

That is, in FIG. 7, when the intra 4×4 prediction modes (Intra_{—}4×4_prod_mode) for A and B are assumed to be an intra 4×4 prediction mode A (Intra_{—}4×4_pred_modeA) and an intra 4×4 prediction mode B (Intra_{—}4×4_pred_modeB) respectively, the most frequently occurring mode (MostProbableMode) is defined by the following Expressions (4).

MostProbableMode=Min(Intra_{—}4×4_pred_modeA,Intra_{—}4×4_pred_modeB) (4)

That is, between A and B, either one to which a relatively small mode number (mode_number) is allocated is determined as the most frequently occurring mode (MostProbableMode).

Two values named prev_intra4×4_pred_mode_flag [luma4×4BlkIdx] and rem_intra4×4_pred_mode [luma4×4BlkIdx] are defined as parameters for the 4×4 block in the bit stream, and the decoding processing is performed by a process which is based on a pseudo code shown below, so that the value “Intra4×4PredMode [luma4×4BlkIdx]” that indicates the 4×4 prediction mode (Intra_{—}4×4_pred_mode) for the 4×4 block can be obtained.

if (prev_intra4×4_pred_mode_flag[luma4×4BlkIdx]),
Intra4×4PredMode[luma4×4BlkIdx]=MostProbableMode

else
if (rem_intra4×4_pred_mode[luma4×4BlkIdx]<MostProbableMode),
   Intra4×4PredMode[luma4×4BlkIdx]=rem_intra4×4_pred_mode[luma4×4BlkIdx], else
Intra4×4PredMode[luma4×4BlkIdx]=rem_intra4×4_pred_mode[luma4×4BlkIdx]+1

[Intra 8×8 Prediction Mode]

Next, an encoding scheme of the intra 8×8 prediction scheme is described.

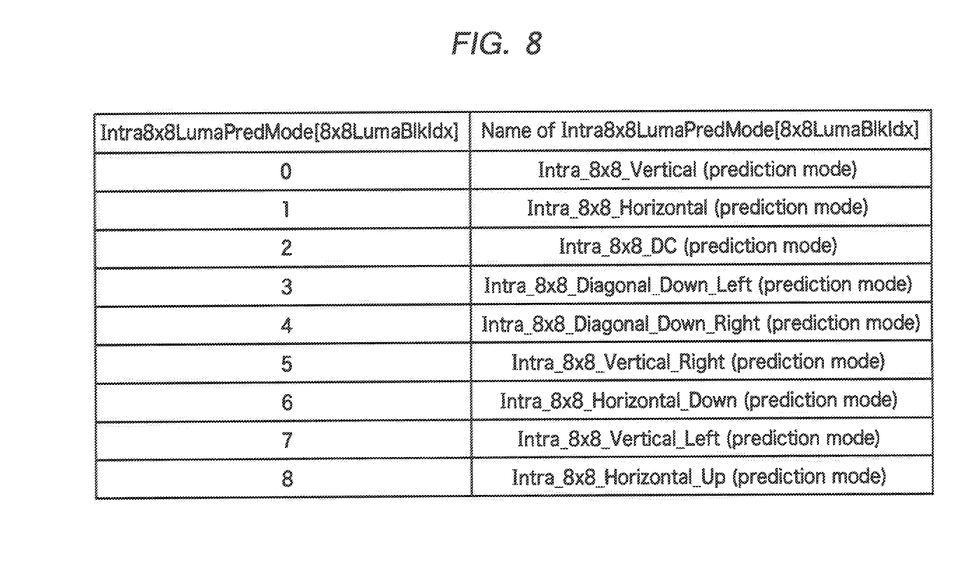

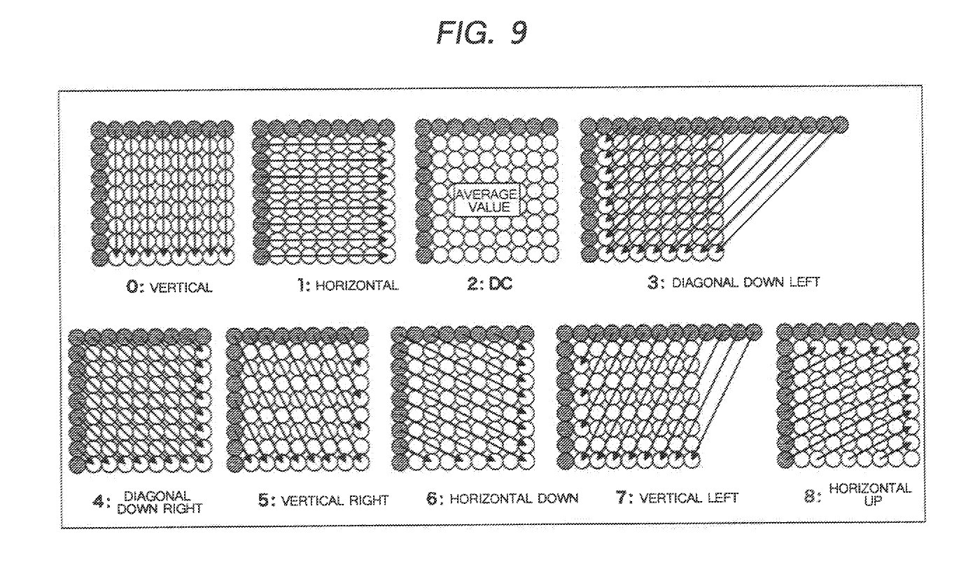

In the AVC, 9 kinds of the intra 8×8 prediction modes (Intra_{—}8×8_pred_mode) are defined as illustrated in FIG. 8 and FIG. 9. The pixel values of a 8×8 block are assumed to be p[x, y] (0≦x≦7; 0≦y≦7), and the pixel values of the adjacent blocks are assumed to be p[−1, −1], . . . , p[−1, 15], p[−1, 0], . . . , p[−1, 7].

For the intra 8×8 prediction mode, as described below, low-pass filtering processing is performed on the adjacent pixels before generating the prediction values. Here, the pixel values before performing the low-pass filtering processing are represented as p[−1, −1], . . . , p[−1, 15], p[−1, 0], . . . , p[−1, 7] and the pixel values after performing the low-pass filtering processing are represented as p′[−1, −1], . . . , p′[−1, 15], p′[−1, 0], . . . , p′[−1, 7].

First, when the p[−1, −1] is “available”, p′[0, −1] is calculated as in the following Expression (5).

p′[0,−1]=(p[−1,−1]+2*p[0,−1]+p[1,−1]+2)>>2 (5)

When the p[−1, −1] is “not available”, the p′[0, −1] is calculated as in the following Expression (6).

p′[0,−1]=(p[−1,−1]+3*p[0,−1]+p[1,−1]+2)>>2 (6)

p′[x, −1] (x=0, . . . , 7) is calculated as in the following Expression (7).

p′[x,−1]=(p[x−1,−1]+2*p[x,−1]+p[x+1,−1]+2)>>2 (7)

When the p[x, −1] (x=8, . . . , 15) is “available”, the p′[x, −1] (x=8, . . . , 15) is calculated as in the following Expression (8) and Expression (9).

p′[x,−1]=(p[x−1,−1]+2*p[x,−1]+p[x+1,−1]+2)>>2 (8)

p′[15,−1]=(p[14,−1]+3*p[15,−1]+2)>>2 (9)

Next, a case where p[−1, −1] is “available” is described. When both the p[0, −1] and p[−1, 0] are “available”, the p′[−1, −1] is calculated as in the following Expression (10).

p′[−1,−1]=(p[0,−1]+2*p[−1,−1]+p[−1,0]+2)>>2 (10)

First, when the p[−1, 0] is “unavailable”, the p′[−1, −1] is calculated as in the following Expression (11).

p′[−1,−1]=(3*p[−1,−1]+p[0,−1]+2)>>2 (11)

First, the p[0, −1] is “unavailable”, p′[−1, −1] is calculated as in the following Expression (12).

p′[−1,−1]=(3*p[−1,−1]+p[−1,0]2)>>2 (12)

In addition, when p[−1, y] (y=0, . . . , 7) is “available”, p′ [−1, y] (y=0, . . . , 7) is calculated as in the following expression. First, when the p[−1, −1] is “available”, p′[−1, 0] is calculated as in the following Expression (13).

p′[−1,0]=(p[−1,−1]+2*p[−1,0]+p[−1,1]+2)>>2 (13)

First, when p[−1, 1] is “unavailable”, p′[−1, 0] is calculated as in the following Expression (14).

p′[−1,0]=(3*p[−1,0]+p[−1,1]+2)>>2 (14)

In addition, p′[−1, y] (y=1, . . . , 6) is calculated as in the following Expression (15).

p[−1,y]=(p[−1,y−1]+2*p[−1,y]+p[−1,y+1]+2)>>2 (15)

In addition, p′[−1, 7] is calculated as in the following Expression (16).

p′[−1,7]=(p[−1,6]+3*p[−1,7]+2)>>2 (16)

The prediction value in each intra prediction mode illustrated in FIG. 8 is calculated as follows by using p′ which is calculated in the way described above.

Mode 0 (Mode 0) is Vertical Prediction and is applied only when p[x, −1] (x=0, . . . , 7) is “available”. In addition, the prediction value pred8×8L[x, v] is calculated as in the following Expression (17).

pred8×8L[x,y]=p′[x,−1]x,y=0, . . . ,7 (17)

Mode 1 (Mode 1) is Horizontal Prediction and is applied only when p[−1, y] (y=0, . . . , 7) are “available”. In addition, the prediction value pred8×8L[x, y] is calculated as in the following Expression (18).

pred8×8L[x,y]=p′[−1,y]x,y=0, . . . ,7 (18)

Mode 2 (Mode 2) is DC Prediction, and the prediction values “pred8×8L[x, y] are calculated as follows. When both of p[x,−1] (x=0, . . . , 7) and p[−1,y] (y=0, . . . , 7) are “available”, the prediction values pred8×8L[x, y] are calculated as in the following Expressions (19).

$$\begin{matrix}[ Expression 4 ] & \\ pred 8 {x8}_{L} [ x , y ] = ( {\sum }_{{x}^{′} = 0}^{7} {p}^{′} [ {x}^{′} , - 1 ] + {\sum }_{{y}^{′} = 0}^{7} {p}^{′} [ - 1 , y ] + 8 ) >> 4 & ( 19 )\end{matrix}$$

When p[x, −1] (x=0, . . . , 7) is “available” but p[−1, y] (y=0, . . . , 7) is “unavailable”, the prediction values pred8×8L[x, y] are calculated as in the following Expressions (20).

$$\begin{matrix}[ Expression 5 ] & \\ pred 8 {x8}_{L} [ x , y ] = ( {\sum }_{{x}^{′} = 0}^{7} {p}^{′} [ {x}^{′} , - 1 ] + 4 ) >> 3 & ( 20 )\end{matrix}$$

When p[x, −1] (x=0, . . . , 7) is “unavailable” but p[−1, y] (y=0, . . . , 7) is “available”, the prediction values pred8×8L[x, y] are calculated as in the following Expressions (21).

$$\begin{matrix}[ Expression 6 ] & \\ pred 8 {x8}_{L} [ x , y ] = ( {\sum }_{{y}^{′} = 0}^{7} {p}^{′} [ - 1 , y ] + 4 ) >> 3 & ( 21 )\end{matrix}$$

When both of p[x, −1] (x=0, . . . , 7) and p[−1, y] (y=0, . . . , 7) are “unavailable”, the prediction values pred8×8L[x, y] are calculated as in the following Expressions (22) (only when the input, is 8 bits).

pred8×8L[x,y]=128 (22)

Mode 3 (Mode 3) is Diagonal_Down_Left_prediction, and the prediction values “pred8×8L[x, y] are calculated as follows. That is, the Diagonal_Down_Left_prediction is applied only when p[x, −1], x=0, . . . , 15 is “available”. When x=7 and y=7, the prediction values pred8×8L[x,y] are calculated as in the following Expression (23).

pred8×8L[x,y]=(p′[14,−1]+3*p[15,−1]+2)>>2 (9)

Other prediction values pred8×8L[x, y] are calculated as in the following Expression (24).

pred8×8L[x,y]=(p′[x+y,−1]+2*p′[x+y+1,−1]+p′[x+y+2,−1]+2)>>2 (24)

Mode 4 (Mode 4) is Diagonal_Down_Right_prediction, and the prediction values pred8×8L[x, y] are calculated as follows. That is, the Diagonal_Down_Right_prediction is applied only when p[x, −1], x=0, . . . , 7 and p[−1, y], y=0, . . . , 7 are “available”. When x>y, the prediction values pred8×8L[x, y] are calculated as in the following Expression (25).

pred8×8L[x,y]=(p′[x−y−2,−1]+2*p′[x−y−1,−1]+p′[x−y,−1]+2)>>2 (25)

In addition, when x<y, the prediction values pred8×8L[x, y] are calculated as in the following Expression (26).

pred8×8L[x,y]=(p′[−1,y−x−2]+2*p′[−1,y−x−1]+p′[−1,y−x]+2)>>2 (26)

In addition, when x=y, the prediction values pred8×8L[x, y] are calculated as in the following Expression (27).

pred8×8L[x,y]=(p′[0,−1]+2*p′[−1,−1]+p′[−1,0]+2)>>2 (27)

Mode 5 (Mode 5) is Vertical_Right_prediction, and the prediction values pred8×8L[x, y] are calculated as follows. That is, the Vertical_Right_prediction is applied only when p[x, −1], x=0, . . . , 7 and p[−1, y], y=−1, . . . , 7 are “available”.

zVR is defined as in the following Expression (28).

zVR=2*x−y (28)

When zVR is 0, 2, 4, 6, 8, 10, 12, or 14, the prediction values pred8×8L[x, y] are calculated as in the following Expression (29).

pred8×8L[x,y]=(p′[x−(y>>1)−1,−1]+p′[x−(y>>1),−1]+1)>>1 (29)

When zVR is 1, 3, 5, 7, 9, 11, or 13, the prediction values pred8×8L[x, y] are calculated as in the following Expression (30).

pred8×8L[x,y]=(p′[x−(y>>1)−2,−1]+2*p′[x−(y>>1)−1,−1]+p′[x−(y>>1),−1]+2)>>2 (30)

When zVR is −1, the prediction values pred8×8L[x, y] are calculated as in the following Expression (31).

pred8×8L[x,y]=(p′[−1,0]+2*p′[−1,−1]+p′[0,−1]+2)>>2 (31)

In other cases, that is, when zVR is −2, −3, −4, −5, −6, or −7, the calculation is performed according to the following Expression (32).

pred8×8L[x,y]=(p′[−1,y−2*x−1]+2*p′[−1,y−2*x−2]+p′[−1,y−2*x−3]+2)>>2 (32)

Mode 6 (Mode 6) is Horizontal_Down_prediction, and the prediction values pred8×8L[x, y] are calculated as follows. The Horizontal_Down_prediction is applied only when p[x, −1], x=0, . . . , and 7 and p[−1, y], y=−1, . . . , and 7 are “available”.

zVR is defined as in the following Expression (33).

zHD=2*y−x (33)

When zHD is 0, 2, 4, 6, 8, 10, 12, or 14, the prediction values pred8×8L[x, y] are calculated as in the following Expression (34).

pred8×8L[x,y]=(p′[−1,y−(x>>1)−1]+p′[−1,y−(x>>1)+1]>>1 (34)

When zHD is 1, 3, 5, 7, 9, 11, or 13, the prediction values pred8×8L[x, y] are calculated as in the following Expression (35).

pred8×8L[x,y]=(p′[−1,y−(x>>1)−2]+2*p′[−1,y−(x>>1)−1]+p′[−1,y−(x>>1)]+2)>>2 (35)

When zHD is −1, the prediction values pred8×8L[x, y] are calculated as in the following Expression (36).

pred8×8L[x,y]=(p′[−1,0]+2*p[−1,−1]+p′[0,−1]+2)>>2 (36)

In addition, when zHD is a value other than that, that is, when zHD is −2, −3, −4, −5, −6, or −7, the prediction values pred8×8L[x, y] are calculated as in the following Expression (37).

pred8×8L[x,y]=(p′[x−2*y−1,−1]+2*p′[x−2*y−2,−1]+p′[x−2*y−3,−1]+2)>>2 (37)

Mode 7 (Mode 7) is Vertical_Left_prediction, and the prediction values pred8×8L[x, y] are calculated as follows. That is, the Vertical_Left_prediction is applied only when p[x, −1], x=0, . . . , 15 is “available”. When y=0, 2, 4, or 6, the prediction values pred8×8L[x,y] are calculated as in the following Expression (38).

pred8×8L[x,y]=(p′[x+(y>>1),−1]+p′[x+(y>>1)+1,−1]+1)>>1 (38)

In the other cases, that is, when y=1, 3, 5, 7, the prediction values pred8×8L[x, y] are calculated as in the following Expression (39).

pred8×8L[x,y]=(p′[x+(y>>1),−1]+2*p′[x+(y>>1)+1,−1]+p′[x+(y>>1)+2,−1]+2)>>2 (39)

Mode 8 (Mode 8) is Horizontal_Up_prediction, and the prediction values pred8×8L[x, y] are calculated as follows. That is, the Horizontal_Up_prediction is applied only when p[−1, y], y=0, . . . , 7 “is available”. Hereinbelow, zHU is defined in the following Expression (40).

zHU=x+2*y (40)

When zHU is 0, 2, 4, 6, 8, 10, 12, 14, the prediction values pred8×8L[x, y] are calculated as in the following Expression (41).

pred8×8L[x,y]=(p′[−1,y+(x>>1)]+p′[−1,y+(x>>1)+1]+1)>>1 (41)

When the value of zHU is 1, 3, 5, 7, 9, 11, the prediction values pred8×8L[x, y] are calculated as in the following Expression (42).

pred8×8L[x,y]=(p′[−1,y+(x>>1)] (42)

When the value of zHU is 13, the prediction values pred8×8L[x, y] are calculated as in the following Expression (43).

pred8×8L[x,y]=(p′[−1,6]+3*p′[−1,7]+2)>>2 (43)

In the other cases, that is, when the value of zHU is larger than 13, the prediction pixel value are calculated as in the following Expression (44).

pred8×8L[x,y]=p′[−1,7] (44)

[Intra 16×16 Prediction System]

Next, an intra 16×16 prediction scheme is described.

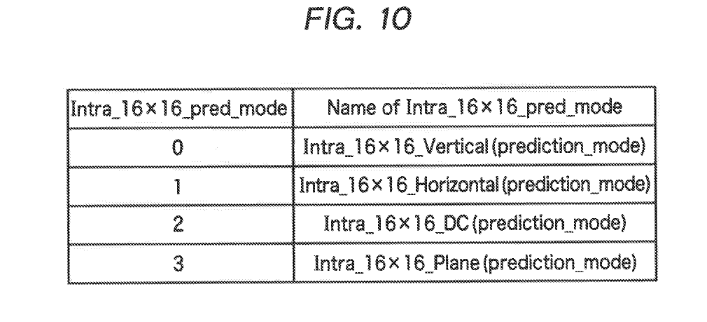

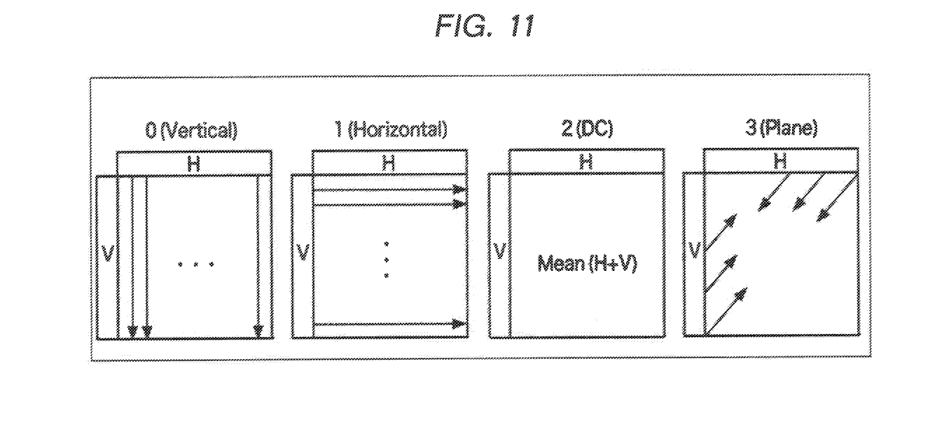

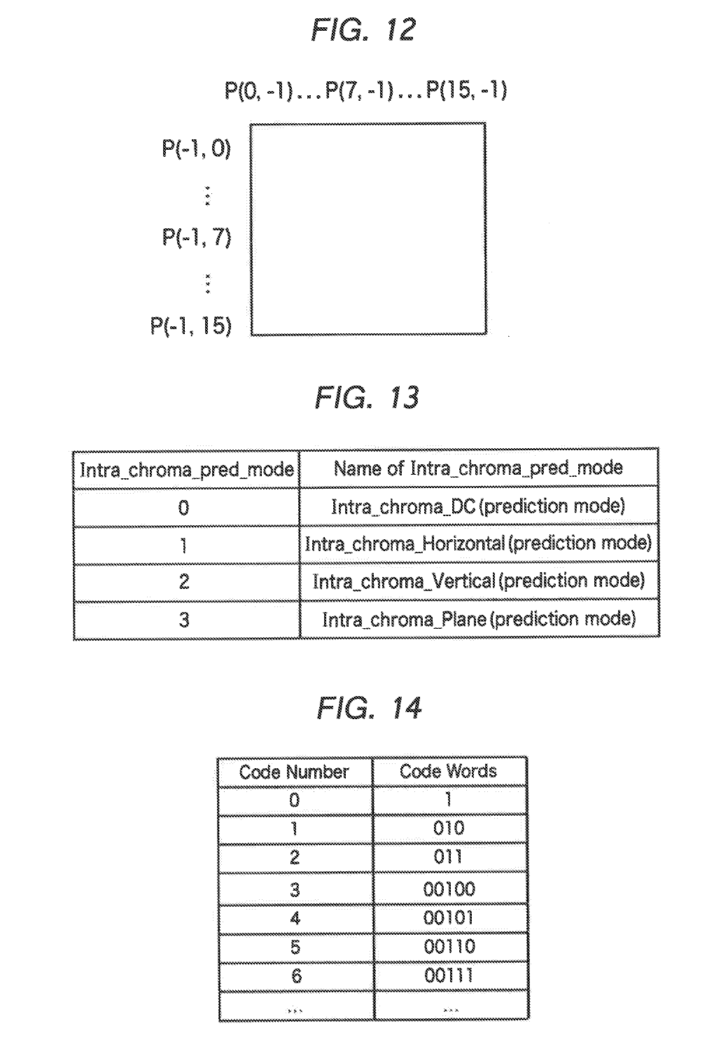

In the AVC, the four kinds of intra 16×16 prediction modes (Intra_{—}16×16_pred_mode) are defined as illustrated in FIG. 10 and FIG. 11. When the pixel values included in the macroblock and the adjacent pixel values are defined as illustrated in FIG. 12, each prediction value is generated as follows.

Mode 0 (Mode 0) is Vertical Prediction and is applied only when P(x, −1); x, y=−1, . . . , 15 is “available”. The prediction values are calculated as in the following Expression (45).

[Expression 7]

pred(x,y)=P(x,−1);x,y=0 . . . 15 (45)

Mode 1 (Mode 1) is Horizontal Prediction, and is applied only when P(−1, y); x, y=−1, . . . , 15 is “available”. The prediction values are calculated as in the following Expression (46).

[Expression 8]

pred(x,y)=P(−1,y);x,y=0 . . . 15 (46)

Mode 2 (Mode 2) is DC Prediction, and the prediction values are calculated as in the following Expression (47) when both of P(x, −1) and P(−1, y); x, y=−1, . . . , 15 are “available”.

$$\begin{matrix}[ Expression 9 ] & \\ pred ( x , y ) = [ {\sum }_{{x}^{′} = 0}^{15} p ( {x}^{′} , - 1 ) + {\sum }_{{y}^{′} = 0}^{15} P ( - 1 , {y}^{′} ) + 16 ] >> 5 \\ with x , y = 0 … 15 & ( 47 )\end{matrix}$$

First, when P(x, −1); x, y=−1, . . . , 15 is “not available”, the prediction values are generated as in the following Expression (48).

$$\begin{matrix}[ Expression 10 ] & \\ pred ( x , y ) = [ {\sum }_{{y}^{′} = 0}^{15} p ( - 1 , {y}^{′} ) + 8 ] >> 4 \\ with x , y = 0. … 15 & ( 48 )\end{matrix}$$

When P(−1, y); x, y=−1, . . . , 15 is “not available”, the prediction values are generated as in the following Expression (49).

$$\begin{matrix}[ Expression 11 ] & \\ pred ( x , y ) = [ {\sum }_{{x}^{′} = 0}^{15} p ( {x}^{′} , - 1 ) + 8 ] >> 5 \\ with x , y = 0. … 15 & ( 49 )\end{matrix}$$

In addition, when both of P(x, −1) and P(−1, y); x, y=−1, . . . , 15 are “not available”, 128 is used as the prediction value.

Mode 3(Mode 3) is Plane Prediction, and is applied only when both of P(x, −1) and P(−1, y); x, y=−1, . . . , 15 are “available”. Each of the prediction values is generated as in the following Expressions (50) to (55).

[Expression 12]

pred(x,y)=clip1((a+b·(x−7)+c·(y−7)+16)>>5) (50)

[Expression 13]

a=16·(P(−1,15)+P(15,−1)) (51)

[Expression 14]

b=(5·H+32)>>6 (52)

[Expression 15]

c=(5·V+32)>>6 (53)

$$\begin{matrix}[ Expression 16 ] & \\ H = {\sum }_{x = 1}^{8} x \cdot ( P ( 7 + x , - 1 ) - P ( 7 - x , - 1 ) ) & ( 54 ) \\ [ Expression 17 ] & \\ V = {\sum }_{y = 1}^{8} y \cdot ( P ( - 1 , 7 + y ) - P ( - 1 , 7 - y ) ) & ( 55 )\end{matrix}$$

[Intra Prediction Mode for Chrominance Signal]

Next, an intra prediction mode with respect to a chrominance signal is described. The intra prediction mode for a chrominance signal is performed based on the intra 16×16 prediction mode as follows. However, the intra prediction mode for a chrominance signal handles a 8×8 block as a processing target while the intra 16×16 prediction mode handles a 16×16 block as a processing target. In addition, to be noted is that mode numbers (mode number) are different from corresponding modes (mode).

The prediction mode for a chrominance signal can be set independently of the mode for a luminance signal.

Hereinafter, the definitions of pixel values included in the macroblock (Macroblock) and pixel values of adjacent pixels are the same as those in the case of the intra 16×16 mode (Intra16×16Mode). The prediction values in each Intra_chroma_pred_mode are generated as follows.

As illustrated in FIG. 13, the Intra_chroma_pred_mode includes four modes, Mode 0 through Mode 3.

Mode 0 (Mode 0) is DC Prediction, and the prediction values are calculated as in the following Expression (56) when both of P(x, −1) and P(−1, y) are “available”.

$$\begin{matrix}[ Expression 18 ] & \\ pred ( x , y ) = ( ( {\sum }_{n = 0}^{7} ( P ( - 1 , n ) + P ( n , - 1 ) ) ) + 8 ) >> 4 \\ with x , , y = 0 … 7 & ( 56 )\end{matrix}$$

In addition, when P(−1, y) is “not available”, the prediction values are calculated as in the following Expression (57).

$$\begin{matrix}[ Expression 19 ] & \\ pred ( x , y ) = [ ( {\sum }_{n = 0}^{7} P ( n , - 1 ) ) + 4 ] >> 3 \\ with x , y = 0 …7 & ( 57 )\end{matrix}$$

In addition, when P(x, −1) is “not available”, the prediction values are calculated as in the following Expression (58).

$$\begin{matrix}[ Expression 20 ] & \\ [ ( {\sum }_{n = 0}^{7} P ( - 1 , n ) ) + 4 ] >> 3 \\ with x , y = 0 …7 & ( 58 )\end{matrix}$$

Mode 1 (Mode 1) is Horizontal prediction and is applied only when P(−1, y) is “available”. The prediction values are calculated as in the following Expression (59).

[Expression 21]

pred(x,y)=P(−1,y),x,y=0, . . . ,7 (59)

Mode 2 (Mode 2) is Vertical Prediction and is applied only when P(x, −1) is “available”. The prediction values are calculated as in the following Expression (60).

[Expression 22]

pred(x,y)=P(x,−1),x,y=0, . . . ,7 (60)

Mode 3 (Mode 3) is Plane Prediction and is applied only when P(x, −1) and P(−1, y) are “available”. The prediction values are calculated as in the following Expression (61) through Expression (66).

$$\begin{matrix}[ Expression 23 ] & \\ \begin{matrix}pred ( x , y ) = clip 1 ( a + b \cdot ( x - 3 ) + c \cdot ( y - 3 ) + 16 ) >> 5 ) ; \\ x , y \\ = 0 , … , 7\end{matrix} & ( 61 ) \\ [ Expression 24 ] & \\ a = 16 \cdot ( P ( - 1 , 7 ) + P ( 7 , - 1 ) ) & ( 62 ) \\ [ Expression 25 ] & \\ b = ( 17 \cdot H + 16 ) >> 5 & ( 63 ) \\ [ Expression 26 ] & \\ c = ( 17 \cdot V + 16 ) >> 5 & ( 64 ) \\ [ Expression 27 ] & \\ H = {\sum }_{x = 1}^{4} x \cdot [ P ( 3 + x , - 1 ) - P ( 3 - x , - 1 ) ] & ( 65 ) \\ [ Expression 28 ] & \\ V = {\sum }_{y = 1}^{4} y \cdot [ P ( - 1 , 3 + y ) - P ( - 1 , 3 - y ) ] & ( 66 )\end{matrix}$$

Incidentally, in the AVC encoding scheme, two kinds of schemes which are CAVLC (Context-based Adaptive Variable Length Coding) and CABAC (Context-based Adaptive Binary Arithmetic Coding) are standardized as lossless encoding schemes. Hereinafter, in the AVC encoding scheme, the standardized CAVLC scheme is first described.

[CAVLC]

In the CAVLC, for orthogonal transformation coefficients, VLC Tables are switched in accordance with the occurrence of coefficients in nearby blocks (blocks). Exp-Golomb codes illustrated in FIG. 14 to be described below are used for encoding other syntax elements, for example.

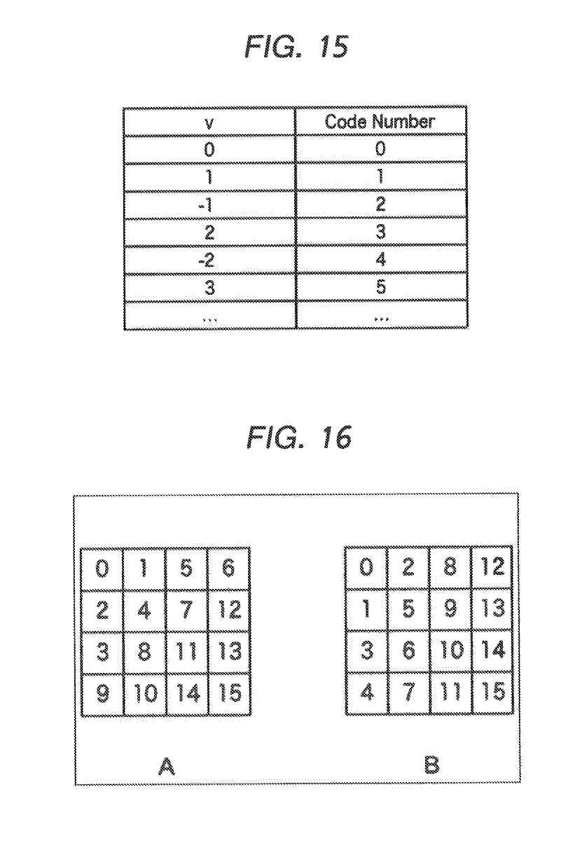

Moreover, with regard to the syntax element such as motion vectors, there is the possibility that a negative value may occur. However, in such a case, for example, it is replaced with a code number which has no sign, based on the table illustrated in FIG. 15, and then, for example, the Exp-Golomb code as illustrated in FIG. 14 is applied.

Hereinbelow, processing of the orthogonal transformation coefficients in the CAVLC for a 4×4 block is described.

The 4×4 block is converted into 4×4 two-dimensional data corresponding to each frequency component by orthogonal transformation in the AVC encoding scheme. However, it may be converted into one-dimensional data by the zigzag scanning (Zigzag-scan) system illustrated in FIG. 16A or by the field scanning (Field-scan) system illustrated in FIG. 16B depending on whether the block has been frame-encoded or field-encoded, respectively.

In a first step, the converted one-dimensional orthogonal transformation coefficients obtained in such a manner are scanned in reverse order, from a higher frequency component to a lower frequency component.

In a second step, NumCoef (the number of non-zero coefficients) and T1s (the number of coefficients of ±1 where the maximum is 3, when the scanning is performed from higher frequencies to lower frequencies) are encoded, In FIG. 7, when C is assumed to be the block and A and B are assumed to be adjacent blocks, the VLC Tables are not switched according to the NumCoef in A and B.

In a third step, Level is encoded. That is, for T1s, only positive/negative signs are encoded. As for other coefficients, code numbers are allocated and encoded. The VLC Tables are switched according to the intra/inter, the quantization parameter QP, and the Level which is lastly encoded.

In a fourth step, Run is encoded. That is, in encoding of TotalZero, the VLC Tables are switched according to the NumCoef in encoding of Run_before (the number of continuous 0s placed before a non-zero coefficient), the VLC Tables are switched according to ZerosLeft (the number of non-zero coefficients in the remainder). The encoding ends at ZerosLeft=0.

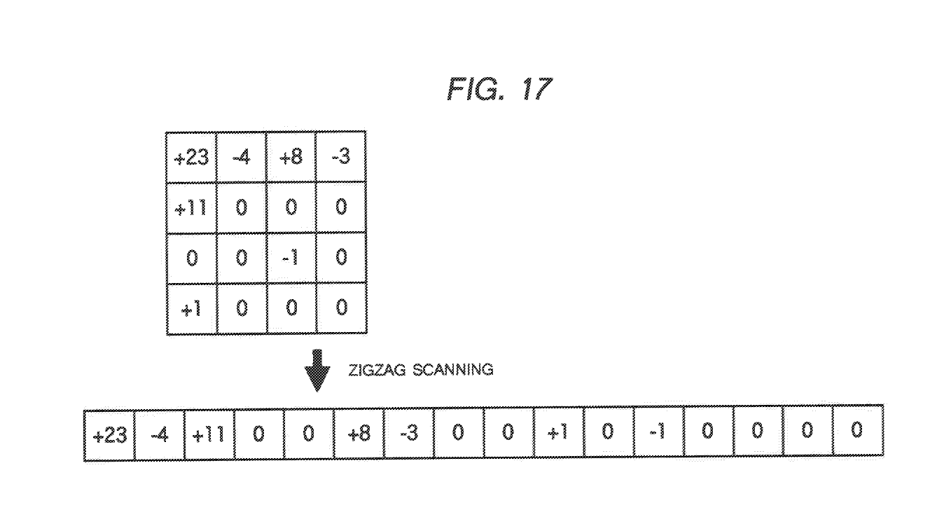

FIG. 17 illustrates a specific example of the operation principle of the CAVLC. In the example illustrated in 17, after the reverse-scanning is performed, the encoding processing is performed in the following order,

TotalCoef=7

TrailingOnes=2

Trailing_ones_sign_flag=−

Trailing_ones_sign_flag

Level=−3

Level=+8

Level=+11

Level=−4

Level=+23

Total_zeros=5 (ZerosLeft=6)

Run_before=1 (ZerosLeft=5)

Run_before=2 (ZerosLeft=4)

Run_before=0 (ZerosLeft=3)

Run_before=2 (ZerosLeft=2)

Run_before=0 (ZerosLeft=1)

Run_before=0 (ZerosLeft=0)

These coefficients are subjected to the VLC encoding, as described above, using the table which is switched according to the encoding situation such as nearby blocks.

[CABAC]

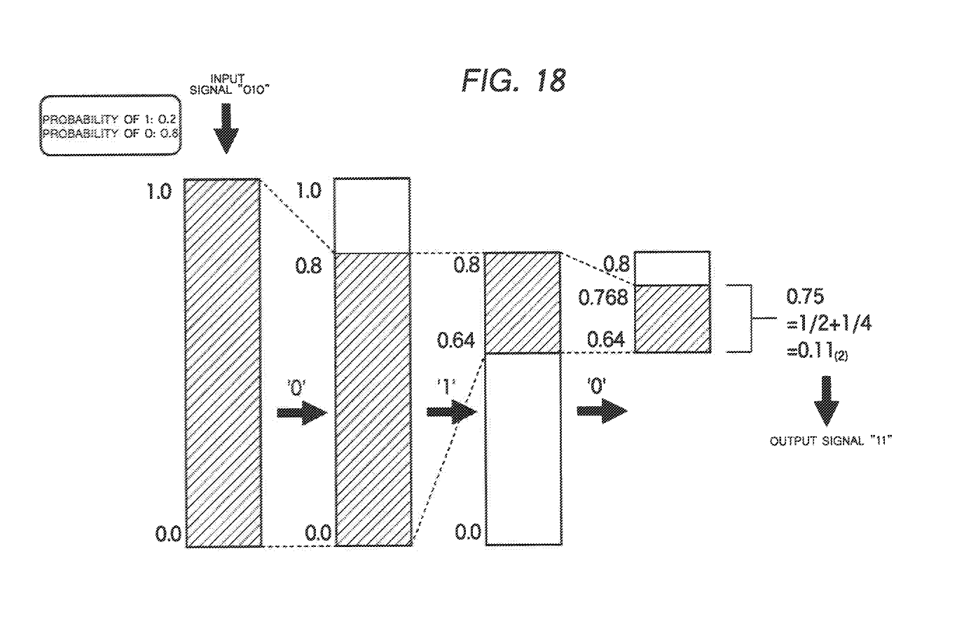

Next, the standardized CABAC scheme in the AVC encoding scheme is described. First, how binary arithmetic coding operates is described with reference to FIG. 18.

When the occurrence probability of “0” is 0.8 and the occurrence probability of “1” is 0.2, a bit string “010” as an input signal is encoded.

At this time, as illustrated in the drawing, the section [0, 1] is divided depending on the input signal as illustrated, and a signal which will become “11” in the end is output.

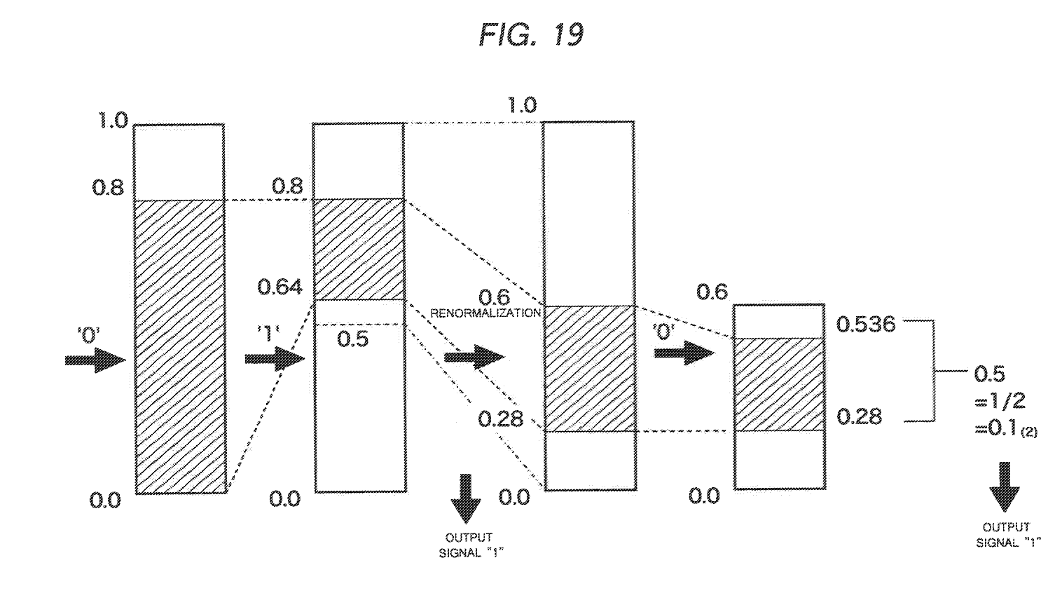

Incidentally, in FIG. 18, the number of digits of a register having a section interval such as “0.64”, for example, is actually finite. Next, a technique called renormalization illustrated in FIG. 19 is considered to effectively use the precision of the register.

That is, since it can be learned that the coordinate value of the section is 0.5 or more when 1 has been encoded, the first decimal place at that time point is output and the renormalization is performed.

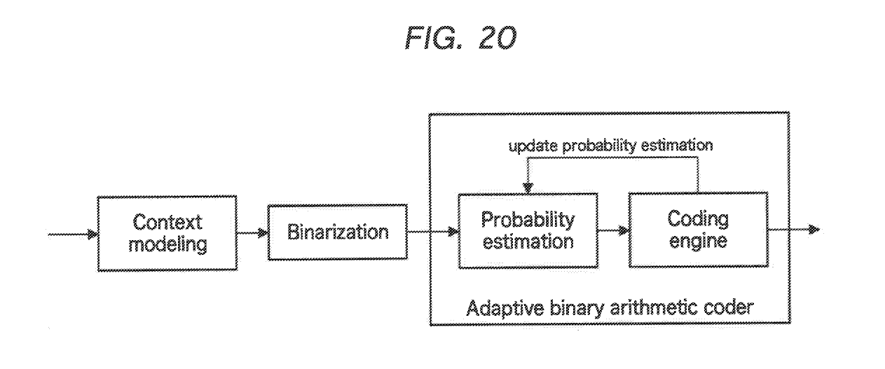

FIG. 20 is a diagram that illustrates an outline of the CABAC encoding scheme.

That is, the CABAC encoding scheme has the following characteristics. A first characteristic is to perform encoding processing for each context. A second characteristic is to convert non-binary data to binary data. A third characteristic is to actually initialize a probability table at the head of slice and sequentially update it according to generated symbols although the occurrence probabilities of “0” and “1” are fixed in the example illustrated in FIG. 18.

Hereinafter, “context” in the CABAC encoding is described using mb_skip_flag illustrated in FIG. 7 as an example,

In the CABAC encoding scheme, separate context models are prepared for different syntax elements, respectively. In addition, even for the same syntax element, a plurality of context models is prepared in accordance with the value of adjacent blocks (or macroblocks).

In FIG. 7, C is the macroblock, and A and B are adjacent macroblocks thereof. Function f(x) is defined as in the following Expression (67).

$$\begin{matrix}[ Expression 29 ] & \\ f ( X ) = \{ \begin{matrix}O ( if \{ X = skip ) \\ 1 ( otherwise )\end{matrix} & ( 67 )\end{matrix}$$

A context model of C “Context(C)” is calculated as in the following Expression (68).

Context(C)=f(A)+f(B) (68)

That is, the value of Context(C) is any value selected among 0, 1, and 2 depending on the status of A and B. That is, even for the same mb_skip_flag, the encoding processing is performed by a different arithmetic coding engine depending on the value of Context(C).

Next, the binary coding processing is described.

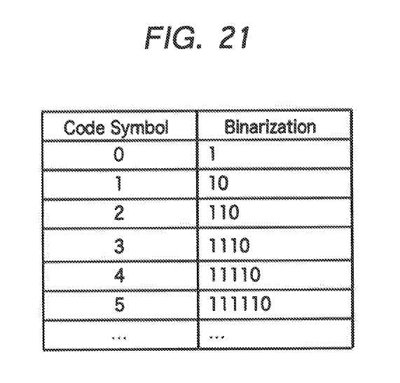

Non-binary data in the syntax elements are converted into binary data by unary_code illustrated in FIG. 21 to be described below, and the arithmetic coding processing is performed.

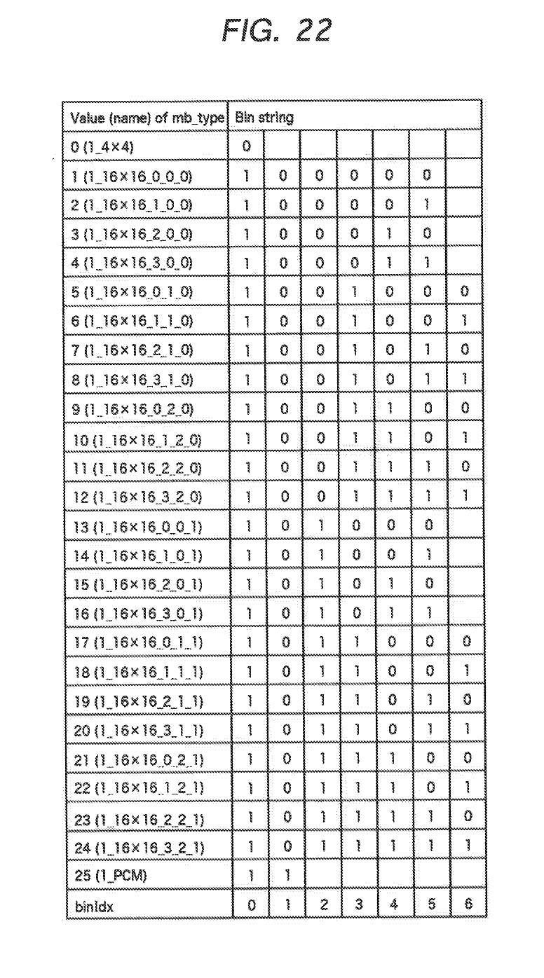

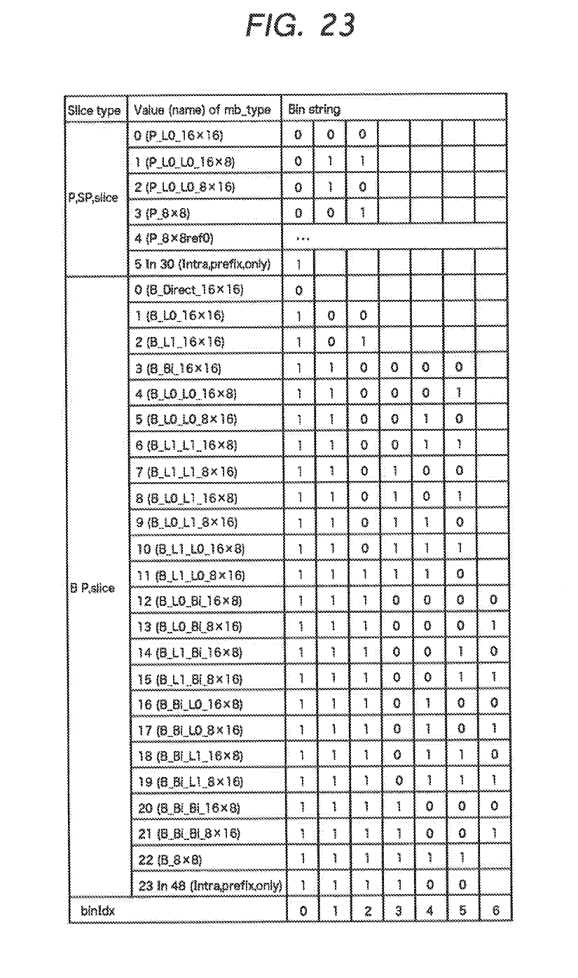

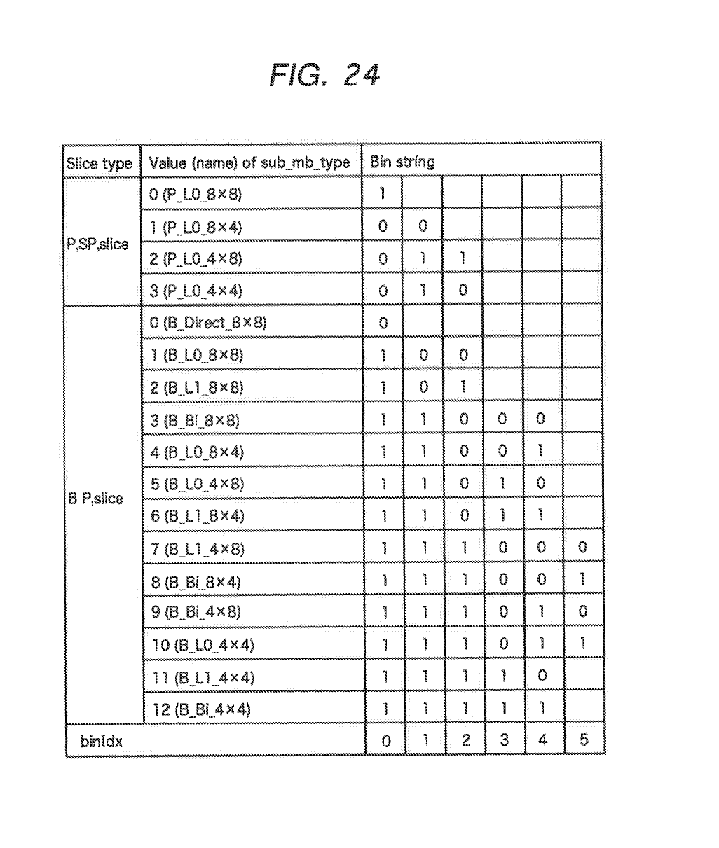

However, the macroblock type is not, limited thereto. Irregular tables illustrated in FIG. 22, FIG. 23, and FIG. 24 are defined for I slice, P slice, and B slice, respectively.

[Cost Function]

Incidentally, selection of an appropriate prediction mode is important to achieve higher encoding efficiency in the AVC encoding scheme.

An example of a selection system therefor includes a method mounted in reference software of H.264/MPEG-4 AVC, called JM (Joint Model), which is open to public in http://iphome.hhi.de/suchring/tml/index.htm.

In the JM, two mode determination methods of High Complexity Mode and Low Complexity Mode described below can be selected. Both calculate a cost function value concerning each prediction mode Mode and select a prediction mode which minimizes the cost function value as an optimal mode for the range of the block (or macroblock).

The cost function in the High Complexity Mode is represented by the following Expression (69).

Cost(ModeεΩ)=D+λ*R (69)

Here, Ω is a total set of candidate modes to encode the block (or macroblock), and D is difference energy between the decoded image and the input image in the case of encoding with the prediction mode Mode. λ is a Lagrange undecided multiplier yielded as the function of the quantization parameters. R is the total code amount including orthogonal transformation coefficients in the case of encoding with the corresponding mode.

In a word, to perform encoding with High Complexity Mode, it is necessary to calculate the above-mentioned parameters D and R. Accordingly, the encoding processing needs to be tentatively performed for all candidate prediction modes, which requires a greater amount of computations.

The cost function in the Low Complexity Mode is represented by the following Expression (70)

Cost(ModeεΩ)=D+QP2Quant(QP)*HeaderBit (70)

Here, D is difference energy between the prediction image and the input image unlike the case of High Complexity Mode. QP2Quant(QP) is provided as the function of the quantization parameter QP, and HeaderBit is a code amount relating to the header information, such as motion vectors and modes in which orthogonal transformation coefficients are not included.

That is, in the Low Complexity Mode, it is necessary to perform prediction processing for each of the candidate modes, but there is no need to perform encoding processing because a decoded image is not necessary. Therefore, a lower amount of computations can be realized than the High Complexity Mode.

Incidentally, with the intra prediction, improved encoding efficiency can be achieved by allocating a shorter code number (code_number) to a more frequently occurring prediction mode. However, the AVC encoding scheme employs fixed allocation although the more frequently occurring prediction mode changes depending on the sequence or bit rate. Accordingly, it is difficult to achieve the optimal encoding efficiency with the AVC encoding scheme.

Accordingly, the image encoding device 100 adaptively changes the code number to be allocated to each prediction mode in a feedback manner, thereby realizing optimal code number (code_number) allocation in accordance with the sequence and bit rate, and realizing improvement in encoding efficiency.

[Principle of Operation]

Hereinafter, the principles of operation in the intra prediction unit 114 and the code number allocating unit 121 are first described.

The intra prediction unit 114 performs intra prediction processing based on the AVC encoding scheme. However, with regard to the allocation of code numbers (code_number) to prediction modes of Vertical, Horizontal, and DC, it is not performed in a fixed manner but performed adaptively like in the AVC encoding scheme.

That is, a code number allocation method which is the same as the method used in the AVC encoding scheme is set as an initial value. Based on this method, the buffer in which reference images are stored is cleared. In this way, encoding processing on an IDR (Instantaneous Decoder Refresh) slice, which guarantees that reproduction from the slice is possible, is performed.

After the encoding processing is performed, the number of intra prediction modes which have occurred is counted, and the intra prediction modes are sorted in descending order in the count. As a result, the order of the code numbers (code_number) is changed so that a code number (code_number) with a smaller value will be allocated to the prediction mode with a higher frequency of occurrence.

When encoding the second I slice, the intra encoding processing is performed by using the code number (code_number), which is newly allocated by the allocation change. In a word, the code numbers (code_number) are allocated such that a smaller value is allocated to the intra prediction mode with a higher frequency of occurrence in the immediately previous slice.

In this way, it is possible to allocate the code number (code_number) which is suitable for the sequence or the bit rate, by performing the adaptive code number (code_number) allocation based on the encoding result. And, it is possible to realize higher encoding efficiency of the code stream that is an output of the image encoding device 100.

Moreover, the adaptive code number (code_number) allocation based on such frequency data can be executed in even a decoding device using the same operation principle. That is, since there is no need to transmit information on the code number allocation along with the code stream, this technology has an advantage of not impairing the encoding efficiency attributable to the addition of such information.

In addition, a plurality of P slices or B slices exists between the i slices generally. However, intra macroblocks exist even in the P slice or the B slice. In this technology, it is assumed that the operation principle is applied also to the intra macroblocks in the P slice or the B slice.

That is, a first method is a method which does not perform the code number (code_number) allocation in accordance with the mode distribution (that is, it is not a method of allocating a code number with a smaller value to a prediction mode with a higher frequency of occurrence) with respect to the P slice or the B slice, but uses a method of allocating code numbers (code_number) which is defined beforehand, as adopted in the AVC or the like, for example.

Since this method does not require a computation for code number allocation or the like, this method can be easily realized. However, this method does not perform the adaptive allocation like conventional methods.

A second method is a method which does not perform the code number (code_number) allocation in accordance with the mode distribution with respect to the P slice or the B slice but is a method which uses the code numbers (code_number) allocated as a result of the encoding of the immediately previous I slice.

Since this method uses the allocation result of the immediately previous I slice, the computation for code number allocation is not necessary. Therefore, this method can be easily realized. Moreover, this method can perform more adaptive allocation than the first method.

A third method is based on the second method but this method allocates code numbers in accordance with the mode distribution when the intra macroblocks occur in a predetermined percentage or higher in the P slice or the B slice and uses the allocation result for the subsequent P slice or B slice.

For instance, a threshold is assumed to be 50%. For the P slice or B slice, code numbers (code_number) allocated as a result of the encoding of the immediately previous I slice are used as in the second method when less than 50% of the macroblocks included in the corresponding slice is the intra macroblocks. The allocation of code numbers (code_number) based on the mode distribution is performed and the result thereof is applied to the subsequent P slide or B slice when 50% or more of the macroblocks included in the corresponding slice is the intra macroblocks.

That is, when the current P slice or B slice has the characteristic similar to that of the immediately previous I slice, in addition to the second method, code numbers (code_number) are allocated in accordance with the mode distribution like in the case of the I slide. In this way, the code numbers (code_number) can be more adaptively allocated for the P slice or the B slide.

Of course, the code number may be allocated to the intra macroblock of the P slice or B slice by a method other than these three methods.

Incidentally, although the above description is made about a case where code numbers (code_number) are allocated based on the mode distribution in the immediately previous I slice and as a result more appropriate allocation is performed, the same case may not be applied when a scene change occurs.

In general, the contents of the image changes greatly between frames before and after the scene change. Accordingly, when code numbers (code_number) are allocated based on the mode distribution in the immediately previous I slice with respect to the slice where the scene change occurs, such a method is likely to cause the image degradation.

Accordingly, for the I slice which is first encountered after the scene change, the code numbers (code_number) which have been updated in connection with the immediately previous I slice are not used, but a method of allocating predetermined code numbers (code_number) (that is, an initial value) is applied, as adopted, for example, in the AVG encoding scheme. Moreover, a flag of one bit to become default_ipred_code_number_allocation_flag within each slice header included in a code stream is transmitted,

The default_ipred_code_number_allocation_flag is flag information that specifies whether to use the initial value set beforehand or to use newly updated value as a code number (code_number) allocation method. The image decoding device that receives the code stream can easily determine which code allocation method has been used in the image encoding device 100, between the code number allocation method using predetermined (existing) code numbers has been applied and the code number allocation method using code numbers updated adaptively based on the mode distribution in the immediately previous I slice, by referring to the flag information. That is, the scene change or the like needs not be detected again to allow the image decoding device to determine the code number allocation method.

For example, when the value of the default_ipred_code_number_allocation_flag is “0”, the image decoding device determines that the image encoding device 100 has used the code number allocation method which uses the code numbers updated adaptively based on the mode distribution, with respect to the slice.

Moreover, when the value of the default_ipred_code_number_allocation_flag is “1”, the image decoding device determines that the image encoding device 100 has used the code number allocation method which uses the predetermined (existing) code numbers, with respect to the slice. That is, for this case, it is assumed that the scene change has occurred in the slice.

By performing such a process, the first I slice which is encountered first after the scene change has occurred can be encoded by using a code allocation (code_number) based on a distribution different from the distribution of the past I slice which has existed before the scene change (this may also be applied at the image decoding side). Therefore, the image encoding device 100 can appropriately allocate code numbers so that the image quality may not be deteriorated even though the scene change occurs.

This technology may be applicable to all of the intra prediction modes for a chrominance signal, the intra 4×4 prediction mode, the intra 8×8 prediction mode, and the intra 16×16 prediction mode. In addition, it may be applied to the expanded macroblock disclosed in Cited Document 1.

[Code Number Allocating Unit 121]

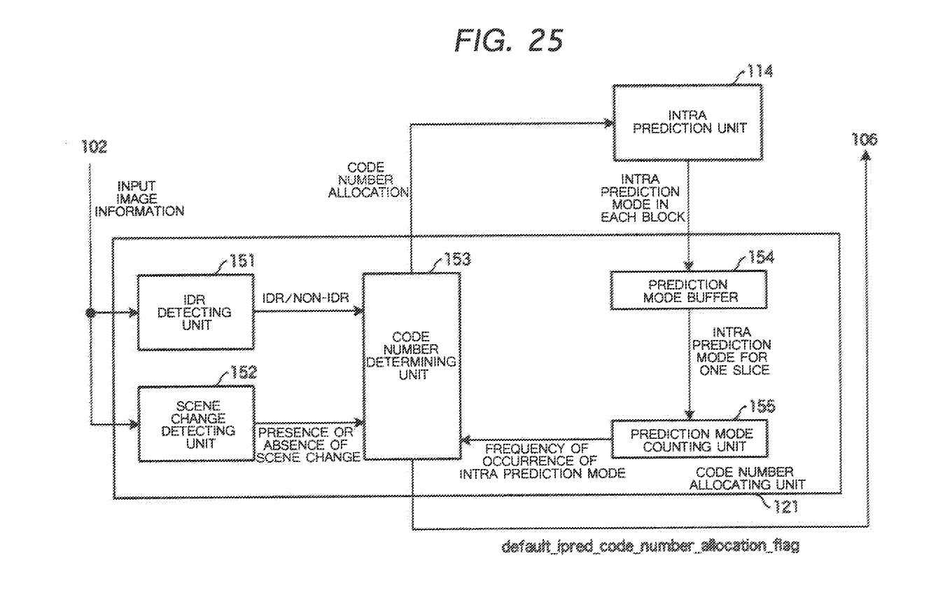

FIG. 25 is a block diagram that illustrates a detailed configuration example of the code number allocating unit 121. As illustrated in 25, the code number allocating unit 121 includes an IDR detecting unit 151, a scene change detecting unit 152, a code number determining unit 153, a prediction mode buffer 154, and a prediction mode counting unit 155.

First, when the intra prediction mode for each block is determined by the intra prediction processing in the intra prediction unit 114, information on the prediction mode is supplied to the prediction mode buffer 154. The prediction mode buffer 154 stores each piece of information on the prediction mode corresponding to one slice.

The intra prediction mode corresponding to one slice stored in the prediction mode buffer 154 is supplied to the prediction mode counting unit 155. The prediction mode counting unit 155 counts the prediction modes for each mode, and supplies the counting result, that is, information that indicates the frequency of occurrence of the intra prediction mode to the code number determining unit 153.

Moreover, input image information is supplied from the screen rearranging buffer 102 to the code number allocating unit 121. The IDR detecting unit 151 detects the IDR slice with respect to the supplied input image information. The IDR detecting unit 151 supplies information (IDR/non-IDR) that indicates whether the current slice is an IDR slice or not, to the code number determining unit 153.

The scene change detecting unit 152 performs, with respect to the supplied input image information, detection processing of detecting whether the scene change exists in the current I slice (current frame), and supplies information on the existence or absence of the scene change to the code number determining unit 153. An arbitrary method may be used as a method of detecting the scene change. For instance, a processed frame and a current frame are compared with each other in the mean of the pixel values or the dispersion (histogram) of the pixel values. When a difference thereof is larger than a predetermined threshold, it may be determined that the scene change has occurred.

For the following I slice, the code number determining unit 153 allocates (that is, updates) code numbers (code_number) in accordance with the frequencies of occurrence of the intra prediction modes based on information that indicates the frequencies of occurrence of the intra prediction modes supplied from the prediction mode counting unit 155, when the IDR detecting unit 151 fails to detect an IDR (that is, the slice is determined not to be an IDR slice) and when the scene chance detecting unit 152 determines there is no scene change.

That is, the code number determining unit 153 allocates a code number (code_number) with a smaller value to a prediction mode with a higher frequency of occurrence. The code number determining unit 153 notifies the intra prediction unit 114 of the allocation of the updated code number (code_number)

Moreover, the code number determining unit 153 sets the value of the default_ipred_code_number_allocation_flag to 0, and supplies the value to the lossless encoding unit 106,

On the other hand, when the IDR detecting unit 151 successfully detected the IDR (that is, when the slice is an IDR slice), the code number determining unit 153 adopts an initial setting (code number allocation method) which is determined, beforehand. For example, the code number determining unit 153 takes the code number allocation method adopted in the AVC encoding scheme as the initial setting. Of course, the initial setting may be any arbitrary allocation method. The code number determining unit 153 notifies the intra prediction unit 114 of the initial value of the code number (code_number) allocation.

Moreover, when the scene change is detected by the scene change detecting unit 152, the code number determining unit 153 adopts the initial setting (code number allocation method) which is determined beforehand. For example, the code number determining unit 153 takes the code number allocation method adopted in the AVC encoding scheme as the initial setting. Of course, the initial setting may be any arbitrary allocation method. The code number determining unit 153 notifies the intra prediction unit 114 of the initial value of the code number (code_number) allocation.

Moreover, the code number determining unit 153 sets the value of the default_ipred_code_number_allocation_flag to 1, and supplies the value to the lossless encoding unit 106.

The value of the default_ipred_code_number_allocation_flag is arbitrary. For example, the value may be set to 0 when the scene change has been detected and the value may be set to 1 when the scene change has not, been detected. Of course, since the requirement of the value is to indicate the presence or absence of the scene change, another value may be used. Moreover, the bit length thereof may be also arbitrary and, for example, it may be 2 bits or more Moreover, the presence or absence of the scene change may be indicated by the presence or absence of the default_ipred_code_number_allocation_flag.

Moreover, the default_ipred_code_number_allocation_flag may be transmitted even in connection with the IDR slice. In that case, the value of the flag is set to 1, as in the case where the scene change has occurred. Alternatively, both of the value for indicating that the scene change has occurred and the value for indicating that the scene change has not occurred may be set to values different from the above values, for example, to 2 and the like, so that the case of the detection of the IDR slice and the case of the occurrence of the scene change can be discriminated.

Incidentally, when the slice is a P slice or a B slice, the code number determining unit 153 updates the code numbers (code_number) only when a proportion of the intra macroblocks in the slice is equal to or greater than a predetermined threshold, that is, equal to or greater than 50%. At this point, the code number determining unit 153 supplies the latest code numbers (code_number) in accordance with the frequencies of occurrence of the intra prediction modes, to the intra prediction unit 114,

For example, when the proportion of the intra macroblocks in the slice is less than the predetermined threshold, the code numbers (code_number) which are allocated based on the encoding result of the immediately previous I slice are supplied to the intra prediction unit 114 as the code number (code_number) allocation like in the above-mentioned second method.

In this way, the code number determining unit 153 properly, adaptively allocates the code numbers to the intra, prediction modes so as to correspond to the frequencies of occurrence of the intra prediction modes. As understood from the above, the image encoding device 100 can generate a code stream with improved encoding efficiency.

[Flow of Encoding Processing]

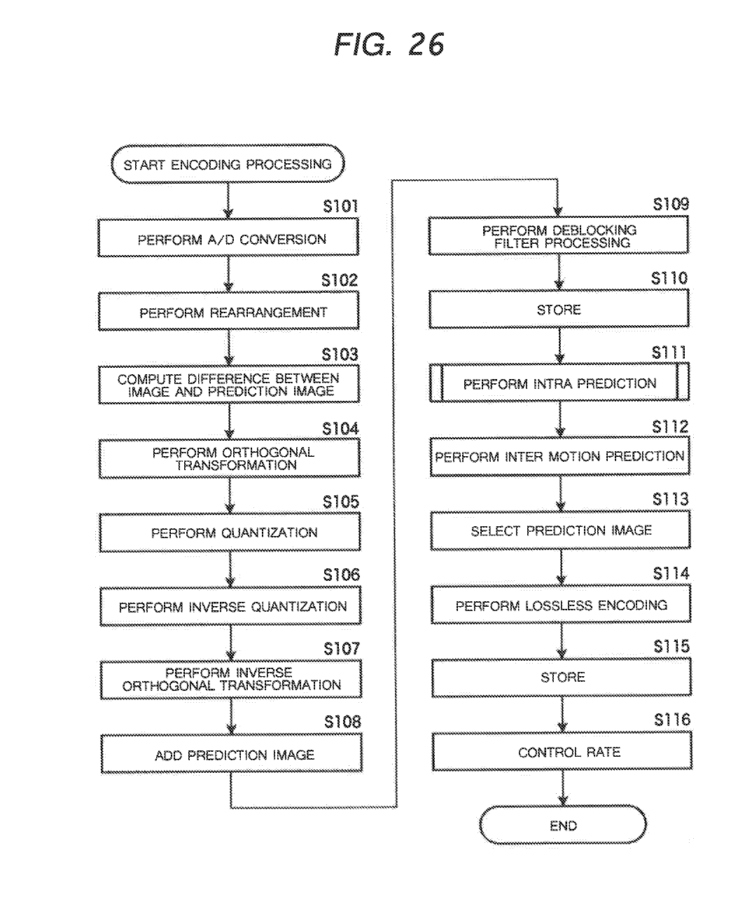

Next, the flow of respective kinds of processing executed by the image encoding device 100 mentioned above is described. An example of the flow of the encoding processing is described first with reference to the flowchart of FIG. 26.

In step S101, the A/D converter 101 converts an input image from analog to digital. In step S102, the screen rearranging buffer 102 stores the A/D-converted image, and changes the arrangement of the image, from the display order of each picture to the encoding order of each picture.

In step S103, the computing unit 103 computes a difference between the image rearranged through step S102 and a prediction image. The prediction image is supplied from the motion prediction and compensation unit 115 for the inter prediction and from the intra prediction unit 114 for the intra prediction, to the computing unit 103 through the selecting unit 116.

The difference data has a decreased data amount compared with the original image data. Accordingly, the data can be compressed to a smaller amount compared with the case where the image is encoded as it is.

In step S104, the orthogonal transformation unit 104 performs orthogonal transformation on the difference information generated through step S103. Specifically, the orthogonal transformation such as discrete cosine transformation and Karhunen-Loeve transformation is performed so that transformation coefficients are output.

In step S105, the quantization unit 105 quantizes the orthogonal transformation coefficients obtained through step S104.

The difference information quantized through step S105 is locally decoded as follows. That is, in step S106, the inverse quantization unit 106 inverse-quantizes the quantized orthogonal transformation coefficients (also called quantization coefficients) generated through step S105, with use of the characteristic corresponding to the characteristic of the quantization unit 105. In step S107, the inverse orthogonal transformation unit 109 performs inverse orthogonal transformation on the orthogonal transformation coefficients obtained through step S106, with use of the characteristic corresponding to the characteristic of the orthogonal transformation unit 104.

In step S108, the computing unit 110 adds the prediction image to the locally decoded difference information and generates the locally decoded image (an image corresponding to an input to the computing unit 103). In step S109, the deblocking filter 111 filters the image generated through step S108. Thus, the block distortion is removed.

In step S110, the frame memory 112 stores the image, from which the block distortion has been removed through step S109. The image which is not filtered by the deblocking filter 111 is supplied from the computing unit 110 to the frame memory 112 and stored therein.

In step S111, the intra prediction unit 114 performs the intra prediction processing in the intra prediction mode. In step S112, the motion prediction and compensation unit 115 performs inter motion prediction processing, in which motion prediction and motion compensation are performed in the inter prediction mode.

In step S113, the selecting unit 116 determines an optimal prediction mode, based on each cost function value output from the intra prediction unit 114 and the motion prediction and compensation unit 115. That is, the selecting unit 116 selects either the prediction image generated by the intra prediction unit 114 or the prediction image generated by the motion prediction and compensation unit 115.

Moreover, selection information that indicates which prediction image is selected is supplied to one of the intra prediction unit 114 and the motion prediction and compensation unit 115, that is, to the one whose prediction image was selected. When the prediction image of the optimal intra prediction mode is selected, the intra prediction unit 114 supplies information that indicates the optimal intra prediction mode (that is, intra prediction mode informational) to the lossless encoding unit 106.

When the prediction image of the optimal inter prediction mode is selected, the motion prediction and compensation unit 115 supplies information that indicates the optimal inter prediction mode and, as necessary, information corresponding to the optimal inter prediction mode, to the lossless encoding unit 106. Examples of the information corresponding to the optimal inter prediction mode include motion vector information, flag information, reference frame information, etc.

In step S114, the lossless encoding unit 106 encodes the transformation coefficients quantized through step S105. That is, lossless encoding such as variable length coding and arithmetic coding is performed on the difference image (secondary difference image in the case of inter).

The lossless encoding unit 106 encodes quantization parameters calculated in step S105, and adds the resultant to the encoded data. Moreover, the lossless encoding unit 106 encodes information on the prediction mode of the prediction image selected by step S113, and adds the resultant to the encoded data obtained by encoding the difference image. That is, the lossless encoding unit 106 encodes the intra prediction mode information supplied from the intra prediction unit 114, or the information corresponding to the optimal inter prediction mode supplied, from the motion prediction and compensation unit 115, and adds the resultant to the encoded data.

When the default_ipred_code_number_allocation_flag is supplied from the code number determining unit 153, the lossless encoding unit 106 encodes even the flag information and adds the resultant to the encoded data

In step S115, the storage buffer 107 stores the encoded data output from the lossless encoding unit 106. The encoded data stored in the storage buffer 107 is properly read, and transmitted to the decoding side via a transmission path.

In step S116, the rate controller 117 controls the rate of the quantization operation of the quantization unit 105, based on the compressed image, which is stored in the storage buffer 107 in step S115, so that overflow or underflow may not occur.

When step S116 ends, the encoding processing is completed.

[Flow of Intra Prediction Processing]

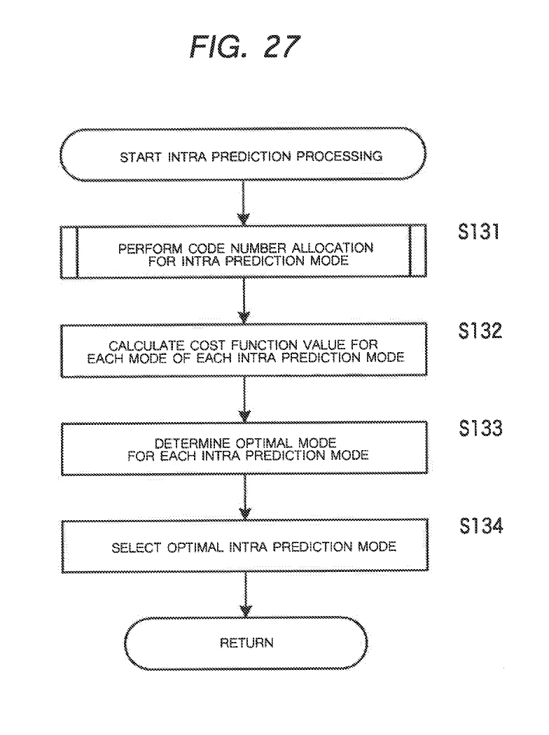

Next, an example of the flow of the intra prediction processing executed in step S111 of FIG. 26 is described with reference to FIG. 27.

When the intra prediction processing is started, the code number allocating unit 121 allocates code numbers to the intra prediction modes in step S131.

In step S132, the intra prediction unit 114 calculates a cost function value for each mode of the intra prediction modes, such as the intra 4×4 prediction mode, the intra 8×8 prediction mode, and the intra 16×16 prediction mode. In step S133, the intra prediction unit 114 determines an optimal mode for each intra prediction mode.

In step S134, the intra prediction unit 114 selects an optimal intra prediction mode by comparing the optimal modes of the respective intra prediction modes. When the optimal intra prediction mode is selected, the intra prediction unit 114 ends the intra prediction processing, returns the processing to step S111 of FIG. 26, and executes step S112 and the subsequent steps.

[Flow of Code Number Allocation Processing for I Slice]

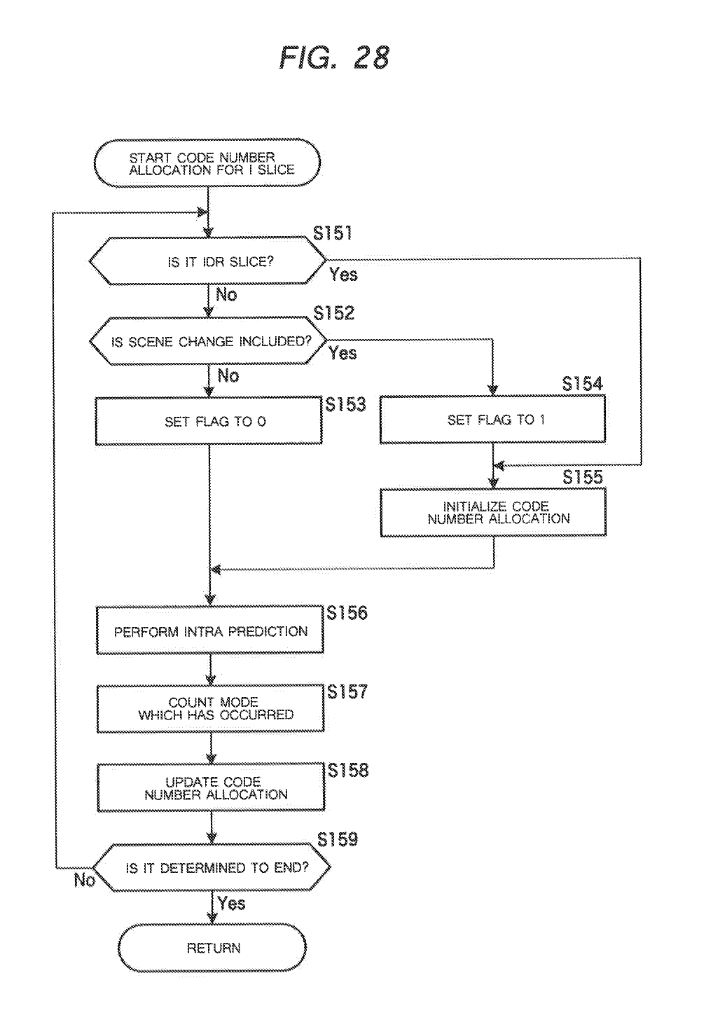

Next, an example of the flow of the code number allocation processing executed in step S131 of FIG. 27 is described. First, an example of the flow of the code number allocation processing for the I Slice is described with reference to the flowchart of FIG. 28.

The code number allocating unit 121 determines the kind of the current slice of the input image supplied from the screen rearranging buffer 102, and starts performing the code number allocation processing for the I slice when the slice is the I slice.

When the processing is started, in step S151, the IDR detecting unit 151 determines whether the slice is an IDR slice, based on the input image information supplied from the screen rearranging buffer 102. When the determination reveals that it is not an IDR slice, the IDR detecting unit 151 advances the processing to step S152.

In step S152, the scene change detecting unit 152 determines whether a scene change has occurred in the slice (present frame), based on the input image information supplied from the screen rearranging buffer 102. When the scene change has not occurred in the present frame, that is, when the scene change detecting unit 152 determines that the scene change is not included in the slice, the scene change detecting unit 152 notifies the code number determining unit 153 of the effect, and advances the processing to step S153.

In step S153, since the scene change has not occurred in the slice, the code number determining unit 153 sets the value of the default_ipred_code_number_allocation_flag to “0”, and the processing proceeds to step S156.

In step S152, when it is determined that the scene change is not included in the slice, the scene change detecting unit 152 advances the processing to step S154,

In step S154, the code number determining unit 153 sets the value of the default_ipred_code_number_allocation_flag to “1” to indicate that the scene change has occurred in the slice, and advances the processing to step S155.

Moreover, when the slice is determined to be an IDR slice in step S151, the IDR detecting unit 151 notifies the code number determining unit 153 of the effect, and advances the processing to step S155.

In step S155, the code number determining unit 153 initializes the code number allocation to a default setting. For example, the code number determining unit 153 takes the code number allocation method stipulated in the AVC encoding scheme as an initial value. When step S155 ends, the code number determining unit 153 advances the processing to step S156.

In step S156, the intra prediction unit 114 performs the intra prediction by applying the allocation of code numbers supplied from the code number determining unit 153.

That is, for example, when the code number allocation has been initialized in step S155, the intra prediction unit 114 adopts the allocation method of the initial setting as the code number allocation, and performs the intra prediction. Moreover, for example, when the flag is set to 0 in step S153, the intra prediction unit 114 adopts the allocation method which is updated based on the mode distribution in the immediately previous I frame as the code number allocation, and performs the intra prediction.

The intra prediction unit 114 supplies the intra prediction mode of each block to the prediction mode buffer 154 so as to be stored.

In step S157, the prediction mode counting unit 155 counts the prediction modes which have occurred, making reference to the data stored in the prediction mode buffer 154. The prediction mode counting unit 155 supplies the counting result (frequency of occurrence of the intra prediction mode) to the code number determining unit 153.

In step S158, the code number determining unit 153 updates the code number allocation for the following slice. That is, the code number determining unit 153 allocates code numbers (code_number) to prediction modes such that a smaller value is allocated to a prediction mode with a higher frequency of occurrence.

In step S159, the code number determining unit 153 determines whether or not the code number allocation processing is to be ended. When it is determined not to end, the processing is returned to step S151 and the subsequent steps will be executed.

Moreover, when it is determined to end the code number determination processing in step S159, the code number determining unit 153 ends the code number allocation processing, and returns the processing to step S131 of FIG. 27, so that step S132 and the subsequent steps will be executed.

[Flow of Code Number Allocation Processing for P Slice or B Slice]

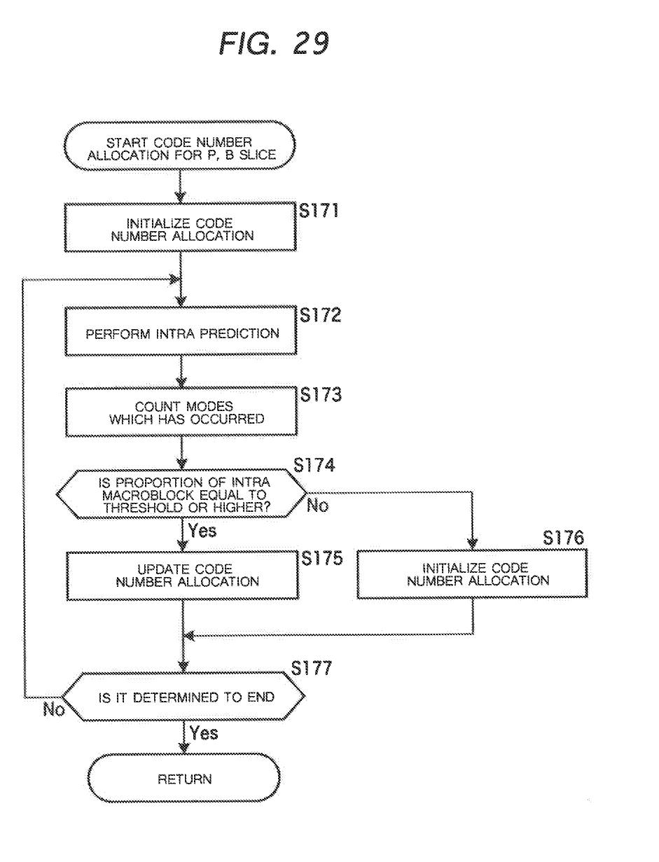

Next, an example of the flow of the code number allocation processing for a P Slice or a B slice is described with reference to the flowchart of FIG. 29.

The code number allocating unit 121 determines the kind of the current slice of the input image supplied from the screen rearranging buffer 102, and starts performing the code number allocation processing on a P slice or a B slice when the slice is not an I slice (that is, it is a P slice or a B slice).

When the processing is started, in step S171, the code number determining unit 153 initializes the code number allocation to the initial setting which is determined beforehand. For example, the code number determining unit 153 takes the code number allocation method stipulated in the AVC encoding scheme as the initial setting.

In Step S172, the intra prediction unit 114 performs the intra prediction by applying the code number allocation supplied from the code number determining unit 153. The intra prediction unit 114 supplies the intra prediction modes of each block to the prediction mode buffer 154 so as to be stored.

In step S173, the prediction mode counting unit 155 counts the prediction modes which have occurred, making reference to the data stored in prediction mode buffer 154. The prediction mode counting unit 155 supplies the counting result (frequencies of occurrence of the intra prediction modes) to the code number determining unit 153.

In step S174, the code number determining unit 153 determines whether a proportion of the intra macroblocks is more than a prescribed threshold. When it is determined that the proportion of the intra macroblocks is equal to or exceeds a prescribed percentage, the P slice or the B slice can be considered to have a characteristic similar to that of the I slice.

Therefore, the code number determining unit 153 advances the processing to step S175, and updates the code number allocation for the intra prediction modes like the case of the I slice.

That is, the code number determining unit 153 allocates a code number with a smaller value to a prediction mode with a higher frequency of occurrence.

Moreover, when it is determined that the intra macroblocks included in the slice accounts for less than the prescribed percentage, the code number determining unit 153 advances the processing to step S176 to initialize the code number allocation to the initial setting which is predetermined. For example, the code number determining unit 153 takes the code number allocation method prescribed in the AVC encoding scheme as the initial setting. In addition, in step S176, the method of allocating code numbers used for the immediately previous I frame may be adopted instead of initializing the code number allocation.

When step S175 or step S176 ends, the code number determining unit 153 determines in step S177 whether or not to end the code number allocation processing, and returns the processing to step S172 when it is determined not to end, so that the subsequent steps will be repeated.

Moreover, when it is determined to end the code number determination processing in step S177, the code number determining unit 153 ends the code number allocation processing, and returns the processing to step S131 of FIG. 27, so that step S132 and the subsequent steps will be executed.

As described above, in the image encoding device 100 which is based on the scheme which performs the intra encoding processing using two or more prediction modes like the AVC encoding scheme for instance, the method of allocating a code number (code_number) to each prediction mode is adaptively switched during the intra prediction by a feedback process. In this way, it is possible to achieve the optimal code number (code_number) allocation in accordance with the sequence or the bit rate, and to improve the encoding efficiency of the output bit stream.

Moreover, since the code number allocation is initialized when the IDR slice is detected and/or the scene change occurs, the image encoding device 100 can suppress the deterioration of the image quality by updating the code number allocation in accordance with the frequency of occurrence of the prediction mode as described above.

In addition, the image encoding device 100 provides an image decoding device with flag information that indicates the scene change having occurred so that the image decoding device can easily detect the occurrence of the scene change.

### 2. Second Embodiment

### Image Decoding Device

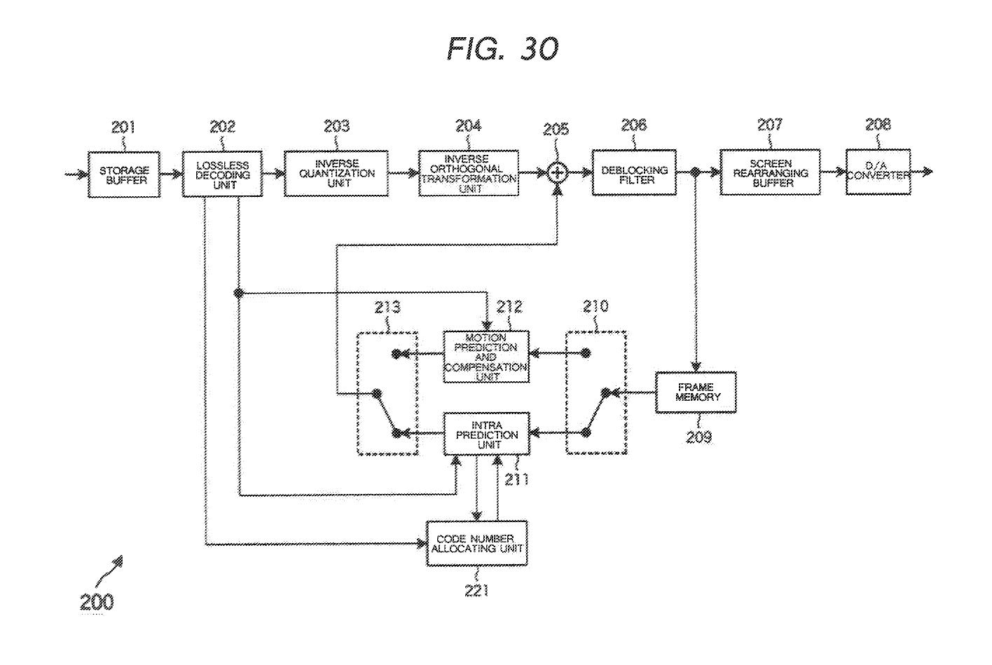

FIG. 30 is a block diagram that illustrates an example of a main configuration of an image decoding device. An image decoding device 200 illustrated in FIG. 30 is a decoding device corresponding to the image encoding device 100.

Encoded data obtained by encoding performed by the image encoding device 100 is assumed to be transmitted to the image decoding device 200 corresponding to the image encoding device 100 via a prescribed transmission path, and then be decoded.

As illustrated in FIG. 30, the image decoding device 200 includes a storage buffer 201, a lossless decoding unit 202, an inverse quantization unit 203, an inverse orthogonal transformation unit 204, a computing unit 205, a deblocking filter 206, a screen rearranging buffer 207, and a D/A converter 208. In addition, the image decoding device 200 further includes a frame memory 209, a selecting unit 210, an intra prediction unit 211, a motion prediction and compensation unit 212, and a selecting unit 213.

In addition, the image decoding device 200 yet further includes a code number allocating unit 221.

The storage buffer 201 stores transmitted encoded data. The encoded data is data obtained by the encoding performed by the image encoding device 100. The lossless decoding unit 202 decodes the encoded data read from the storage buffer 201 at given timing by using a scheme corresponding to the encoding scheme of the lossless encoding unit 106 illustrated in FIG. 1.

The lossless decoding unit 202 supplies coefficient data obtained by decoding the encoded data, to the inverse quantization unit 203.

Moreover, the lossless decoding unit 202 extracts header information included in the encoded data (code stream) through the decoding, and supplies the resultant to the code number allocating unit 221. Moreover, the lossless decoding unit 202 extracts flag information included in the encoded data (code stream) through the decoding, and supplies the resultant to the code number allocating unit 221. For example, the lossless decoding unit 202 supplies default_ipred_code_number_allocation_flag, supplied from the image encoding device 100, to the code number allocating unit 221.

The inverse quantization unit 203 quantizes the coefficient data (quantization coefficients) obtained through the decoding performed by the lossless decoding unit 202, by using a scheme corresponding to the quantization scheme of the quantization unit 105 of FIG. 1.

The inverse quantization unit 203 supplies the inverse-quantized coefficient data, that is, orthogonal transformation coefficients, to the inverse orthogonal transformation unit 204. The inverse orthogonal transformation unit 204 performs inverse orthogonal transformation on the orthogonal transformation coefficients by using a scheme corresponding to the orthogonal transformation, scheme of the orthogonal transformation unit 104 of FIG. 1, and obtains decoding residual data corresponding to residual data which is not subjected to the orthogonal transformation in the image encoding device 100.

The decoding residual data obtained through the inverse orthogonal transformation is supplied to the computing unit 205. A prediction image generated by the intra prediction unit 211 or the motion prediction and compensation unit 212 is supplied to the computing unit 205 through the selecting unit 213.

The computing unit 205 adds the decoding residual data to the prediction image to obtain decoded image data corresponding to the image data in which the prediction image remains without not being subtracted by the computing unit 103 of the image encoding device 100. The computing unit 205 supplies the decoded image data to the deblocking filter 206.

The deblocking filter 206 removes the block distortion of the supplied decoded image and then supplies the resultant to the screen rearranging buffer 207.

The screen rearranging buffer 207 rearranges the sequence of the images. That is, the sequence of frames rearranged so as to be in encoding sequence by the screen rearranging buffer 102 in FIG. 1 is rearranged such that the frames are in the original display sequence. The D/A converter 208 converts the image supplied from the screen rearranging buffer 207 from digital to analog, and outputs the resultant to a display (not illustrated) so as to be displayed.

The output of the deblocking filter 206 is further supplied to the frame memory 209.

The frame memory 209, the selecting unit 210, the intra prediction unit 211, the motion prediction and compensation unit 212, and the selecting unit 213 correspond to the frame memory 112, the selecting unit 113, the intra prediction unit 114, the motion prediction and compensation unit 115, and the selecting unit 116 of the image encoding device 100, respectively.

The selecting unit 210 reads an image to be subjected to inter processing and an image to be made reference to, from the frame memory 209, and outputs it to the motion prediction and compensation unit 212. Moreover, the selecting unit 210 also reads an image to be used in intra prediction from the frame memory 209, and supplies it to the intra prediction unit 211,

Information which indicates the intra prediction mode, obtained by decoding the header information, and the like are appropriately supplied from the lossless decoding unit 202 to the intra prediction unit 211. The intra prediction unit 211 generates, based on this information, a prediction image from the reference image obtained from the frame memory 209, and outputs the generated prediction image to the selecting unit 213.

At this time, the intra prediction unit 211 allocates an appropriate code number in accordance with the frequency of occurrence of the prediction mode by using the code number allocating unit 221. That is, the intra prediction unit 211 reproduces the code number allocation method adopted by the intra prediction unit 114 of the image encoding device 100, and performs the intra prediction by the code number allocation method the same as that of the intra prediction unit 114.

The motion prediction and compensation unit 212 acquires information (prediction mode information, motion vector information, reference frame information, flag, various parameters, etc.) obtained by decoding the header information, from the lossless decoding unit 202,

The motion prediction and compensation unit 212 generates, based on the information supplied from the lossless decoding unit 202, the prediction image from the reference image acquired from the frame memory 209, and outputs the generated prediction image to the selecting unit 213.

The selecting unit 213 selects the prediction image generated by the motion prediction and compensation unit 212 or the intra prediction unit 211, and supplies the selected prediction image to the computing unit 205.

The code number allocating unit 221 basically has the same configuration and performs the same processing as the code number allocating unit 121 of the image encoding device 100. That is, the code number allocating unit 221 performs adaptive code number allocation according to the frequency of occurrence of the prediction mode like the code number allocating unit 121.

That is, the image decoding device 200 can perform a code number allocation similar to that of the image encoding device 100. Therefore, the image encoding device 100 needs not supply the information on the code number allocation method. This may suppress deterioration of the encoding efficiency of the code stream.

[Code Number Allocating Unit]

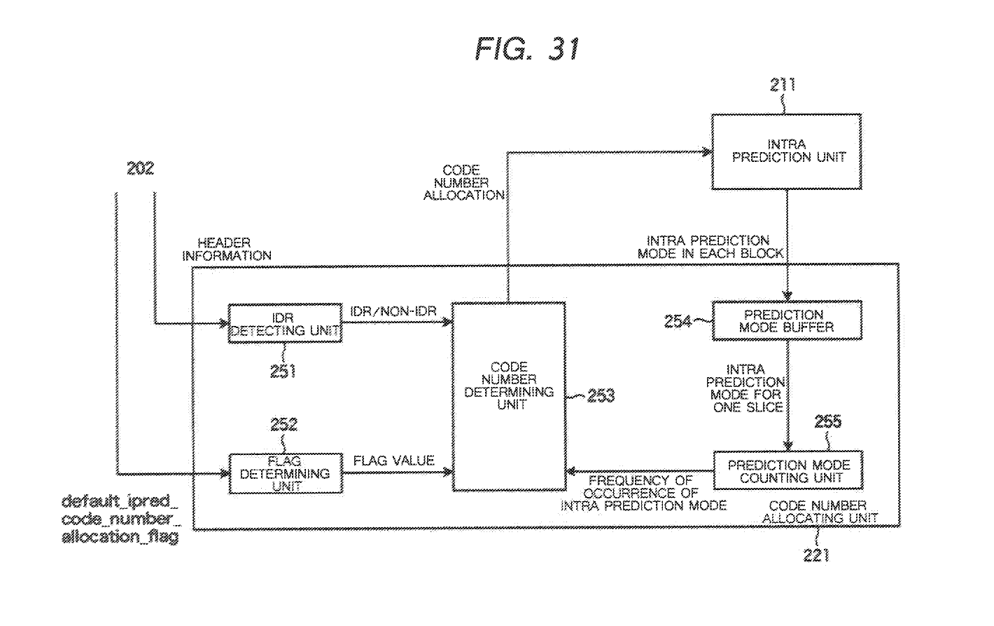

FIG. 31 is a block diagram that illustrates an example of a detailed configuration of the code number allocating unit 221. As illustrated in FIG. 31, the code number allocating unit 221 includes an IDR detecting unit 251, a flag determining unit 252, a code number determining unit 253, a prediction mode buffer 254, and a prediction mode counting unit 255.

First, when the intra prediction mode for each block is determined through the intra prediction processing by the intra prediction unit 211, information on the prediction mode is supplied to the prediction mode buffer 254. The prediction mode buffer 254 stores information on the prediction modes corresponding one slice.

The intra prediction modes corresponding to one slice stored there are supplied to the prediction mode counting unit 255. The prediction mode counting unit 255 counts the prediction modes for each mode, and supplies the counting result (information that indicates the frequency of occurrence of each intra prediction mode) to the code number determining unit 253.

The IDR detecting unit 251 detects an IDR slice, based on the header information of the code stream supplied from the lossless decoding unit 202 and received by the image decoding device 200. The IDR detecting unit 251 supplies the detection result (information (IDR/non-IDR) that indicates whether the slice is an IDR slice), to the code number determining unit 253.

The flag determining unit 252 acquires default_ipred_code_number_allocation_flag that is supplied from the image encoding device 100 along with the encoded data and that is extracted by the lossless decoding unit 202, and determines the value thereof. The flag determining unit 252 notifies the code number determining unit 253 of the flag value.

The code number determining unit 253 updates the code number allocation when the current slice is not an IDR slice but an I slice and when there is no scene change therein such that a code number with a smaller value is allocated to a prediction mode with a higher frequency of occurrence based on the counting result obtained from the prediction mode counting unit 255. The code number determining unit 253 notifies the intra prediction unit 211 of the updated code number (code_number) allocation.

When the current slice is an IDR slice or there is a scene change, the code number determining unit 253 sets (or initializes) the code number allocation to a certain initial value which is predetermined. The initial setting is common between the image decoding device and the image encoding device 100. The code number determining unit 253 notifies the intra prediction unit 211 of the effect that the code number allocation is initialized.

When the processing target is a P slice or a B slice, if there are intra macroblocks equal to or more than a predetermined threshold, the code number determining unit 253 updates the code number allocation, based on the counting result of the prediction mode counting unit 255 such that a code number with a smaller value is allocated to a prediction mode with a higher frequency of occurrence like in the case of the I slice. The code number determining unit 253 notifies the intra prediction unit 211 of the updated code number allocation.

Moreover, when the processing target is a P slice or a B slice and there are intra macroblocks less than the predetermined threshold, the code number determining unit 253 performs the code number allocation in the same manner as that used for the I slice. Moreover, the code number allocation may be initialized. The code number determining unit 253 notifies the intra prediction unit 211 of the code number allocation.

[Flow of Decoding Processing]

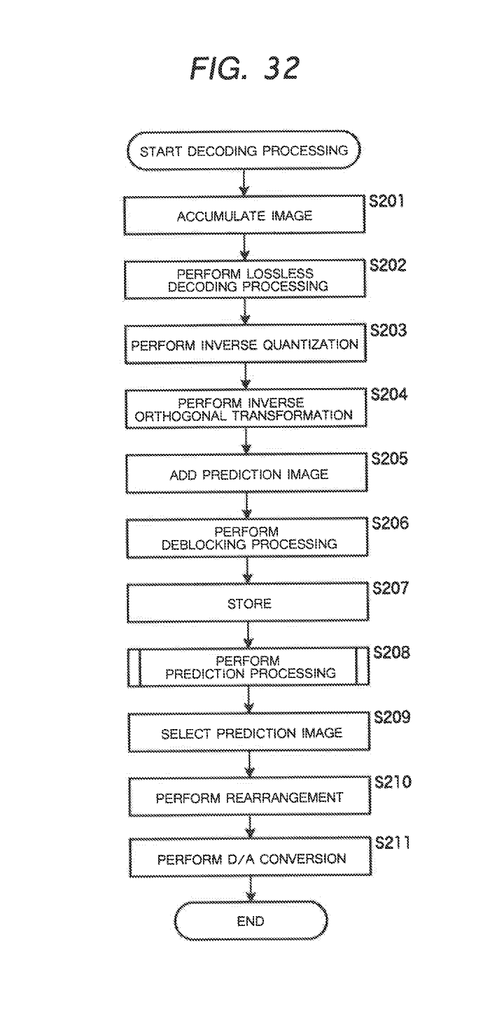

Next, the flow of various kinds of processing executed by the image decoding device 200 mentioned above is described. An example of the flow of the decoding processing is described first with reference to the flowchart of FIG. 32.

When decoding is started, in step S201, the storage buffer 201 stores transmitted encoded data. In step S202, the lossless decoding unit 202 decodes the encoded data supplied from the storage buffer 201. That is, an picture, a P picture, and a B picture encoded by the lossless encoding unit 106 of FIG. 1 are decoded.

At this time, the motion vector information, the reference frame information, the prediction mode information (intra prediction mode or inter prediction mode), the information on various flags and quantization parameters, etc are decoded.

When the prediction mode information is intra prediction mode information, the prediction mode information is supplied to the intra prediction unit 211. When the prediction mode information is inter prediction mode information, the motion vector information corresponding to the prediction mode information is supplied to the motion prediction and compensation unit 212.

In step S203, the inverse quantization unit 203 inverse-quantizes the quantized orthogonal transformation coefficients obtained through the decoding performed by the lossless decoding unit 202 by using a method corresponding to the quantization processing of the quantization unit 103 of FIG. 1. In step S204, the inverse orthogonal transformation unit 204 performs inverse orthogonal transformation on the orthogonal transformation coefficients obtained through the inverse quantization performed by the inverse quantization unit 203 by using a method corresponding to the orthogonal transformation processing of the orthogonal transformation unit 104 of FIG. 1. As a result, difference information corresponding to an input to the orthogonal transformation unit 104 (output of the computing unit 103) of FIG. 1 is decoded.

In step S205, the computing unit 205 adds the prediction image to the difference information obtained through step S204. As a result, the original image data is obtained by the decoding.

In step S206, the deblocking filter 206 properly filters the decoded image obtained through step S205. Thus, the block distortion is suitably removed from the decoded image.

In step S207, the frame memory 209 stores the decoded image which has undergone the filtering.

In step S208, the intra prediction unit 211 or the motion prediction and compensation unit 212 performs prediction processing for each image, according to the prediction mode information supplied by the lossless decoding unit 202.

That is, when the intra prediction mode information is supplied from the lossless decoding unit 202, the intra prediction unit 211 performs intra prediction processing in an intra prediction mode. Moreover, when the inter prediction mode information is supplied from the lossless decoding unit 202, the motion prediction and compensation unit 212 performs motion prediction processing in an inter prediction mode.

In step S209, the selecting unit 213 selects the prediction image. That is, the prediction image generated by the intra prediction unit 211 and the prediction image generated by the motion prediction and compensation unit 212 are supplied to the selecting unit 213. The selecting unit 213 selects either one side, that is, the side whose prediction image is received, and supplies the prediction image to the computing unit 205. The prediction image is added to the difference information in step S205.

In Step S210, the screen rearranging buffer 207 rearranges the frames of the decoded image data. That is, the sequence of frames of the decoded image data, rearranged so as to be in encoding sequence by the screen rearranging buffer 102 (see FIG. 1) of the image encoding device 100, is arranged back so as to be in the original display sequence.

In step S211, the D/A converter 208 converts the decoded image data from digital to analog, where the frames of the decoded image data are stored in the screen rearranging buffer 207 in the rearranged order. The decoded image data is output to a display (not illustrated) so that the image thereof will displayed.

[Flow of Prediction Processing]

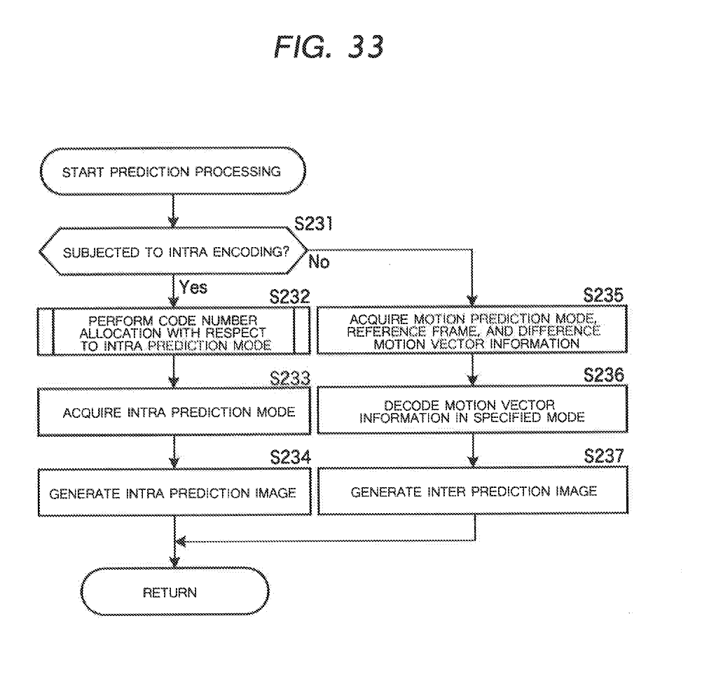

Next, an example of the detailed flow of the prediction processing executed in step S208 of FIG. 32 is described with reference to FIG. 33.

When the prediction processing is started, the lossless decoding unit 202 determines, based on the decoded prediction mode information, whether the encoded data has been subjected to the intra encoding or not in step S231.

When it is determined that the encoded data has been subjected to the intra encoding, the lossless decoding unit 202 advances the processing to step S232.

In step S232, the code number allocating unit 221 allocates a code number to the intra prediction mode. In step S233, the intra prediction unit 211 acquires the intra prediction mode from the lossless decoding unit 202. In step S234, the intra prediction unit 211 generates an intra prediction image.

When the prediction image is generated, the intra prediction unit 211 supplies the generated prediction image to the computing unit 205 through the selecting unit 213, ends the prediction processing, and returns the processing to step S208 of FIG. 32, so that step S209 and the subsequent steps will be performed.

When it is determined that the encoded data has been subjected to the inter encoding in step S231 of FIG. 33, the lossless decoding unit 202 advances the processing to step S234.

In step S235, the motion prediction and compensation unit 212 acquires information necessary to generate the prediction image, such as motion prediction mode, reference frame, and difference motion vector information, from the lossless decoding unit 282.

In step S236, the motion prediction and compensation unit 212 decodes the motion vector information in a specified mode.

In step S237, the motion prediction and compensation unit 212 generates a prediction image from the reference image by using the motion vector information.

When the prediction image is generated, the motion prediction and compensation unit 212 supplies the generated prediction image to the computing unit 205 through the selecting unit 213, ends the prediction processing, and returns the processing to step S208 of FIG. 32, so that step S209 and the subsequent steps will be performed.

[Flow of Code Number Allocation Processing for I Slice]

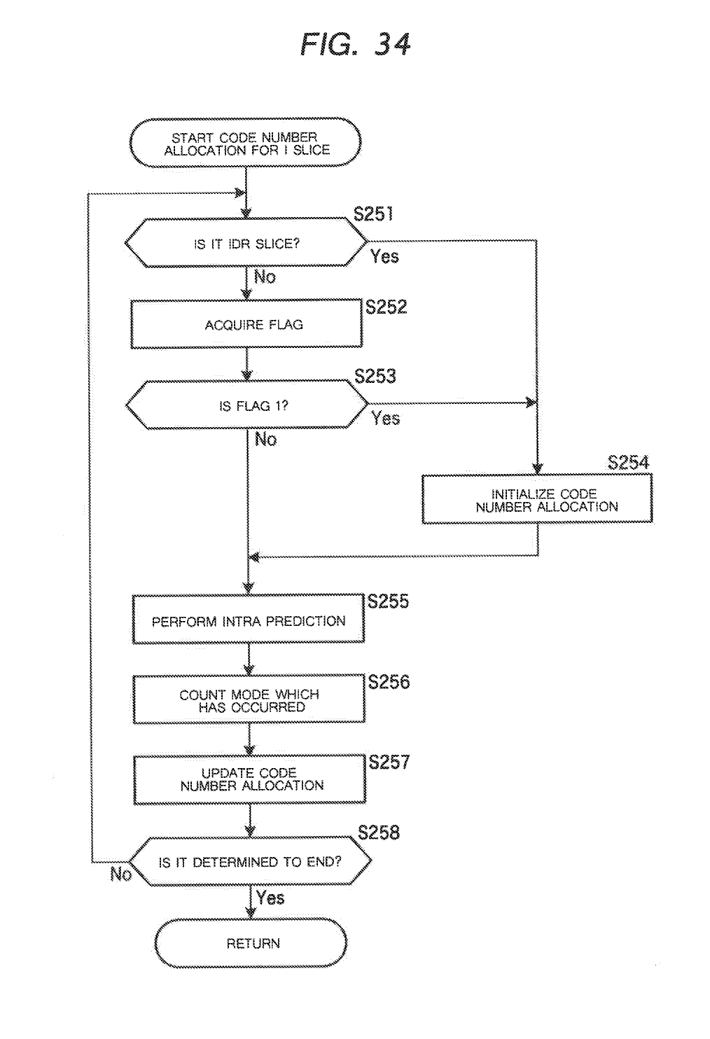

Next, the flow of code number allocation processing for an I slice performed in step S232 of FIG. 33 is described with reference to the flowchart of FIG. 34. The code number allocating unit 221 executes the code number allocation processing for an I slice illustrated in FIG. 34 when the current slice is determined to be the I slice, based on the header information supplied from the lossless decoding unit 202.

When the code number allocation processing for an I slice is started, in step S251, the IDR detecting unit 251 determines whether the current slice is an IDR slice or not. When the current slice is determined not to be an IDE slice, the IDR detecting unit 251 advances the processing to step S252.

In step S252, the flag determining unit 252 acquires flat information “default_ipred_code_number_allocation_flag” from the lossless decoding unit 202. In step S253, the flag determining unit 252 determines whether the value of the default_ipred_code_number_allocation_flag is 1 or not When the value of the default_ipred_code_number_allocation_flag is determined to be 0, the flag determining unit 252 advances the processing to step S255.

When the value of the default_ipred_code_number_allocation_flag is determined to be 1 in step S253, the flag determining unit 252 advances the processing to step S254.

Moreover, when the current slice is determined to be an IDR slice in step S251, the IDR detecting unit 251 proceeds to step S254.

In step S254, the code number determining unit 253 initializes the code number allocation for the slice. When the code number allocation is initialized, the code number determining unit 253 advances the processing to step S255.

In step S255, the intra prediction unit 211 performs the intra prediction by using the code number allocation which is set by the code number allocating unit 221. The intra prediction unit 211 supplies the intra prediction mode of each block to the prediction mode buffer 254 so that the intra prediction modes are stored.

In step S256, the prediction mode counting unit 255 counts the number of generated prediction modes corresponding to one frame.

In step S257, the code number determining unit 253 updates the code number allocation in accordance with the counting result (the frequency of occurrence of each prediction mode). That is, the code number determining unit 253 updates the code number allocation such that a code number with a smaller value is allocated to a prediction mode with a higher frequency of occurrence.

In step S258, the code number allocating unit 221 determines whether or not to end the code number allocation for the I slice, and returns to step S251 when it is determined not to end, so that the subsequent steps will be executed. Moreover, when it is determined to end the code number allocation processing for the I slice in step S258, the code number allocating unit 221 ends the code number allocation processing of the I slice, and returns the processing to step S232 of FIG. 33, so that the subsequent steps will be executed.

Since code number allocation processing for a P slice or a B slice is executed as in the case of the image encoding device 100 which has been described with reference to the flowchart of FIG. 29, the description thereof is not duplicated.

Incidentally, as for the P slice or the B slice, the code number allocating unit 221 updates the code numbers (code_number) only when a proportion of the intra macroblocks in the slice is equal to or greater than a predetermined threshold, for example, equal to or more than 50%.

By performing various kinds of processing as described above, the image decoding device 200 can perform the code number allocation like in the case of the image encoding device 100. That is, the image decoding device 200 can reproduce the code number allocation of the image encoding device 100 without being supplied with information on the code number allocation adopted in the image encoding device 100. Accordingly, it is possible to suppress the deterioration of the encoding efficiency of the encoded data

The code number allocation described above may be applied to intra prediction of chrominance signals as well as luminance signals. The adaptive code number allocation based on the frequency of occurrence of the prediction mode may be performed for both a case where it is applied to the chrominance signal and a case where it is applied to the luminance signal.

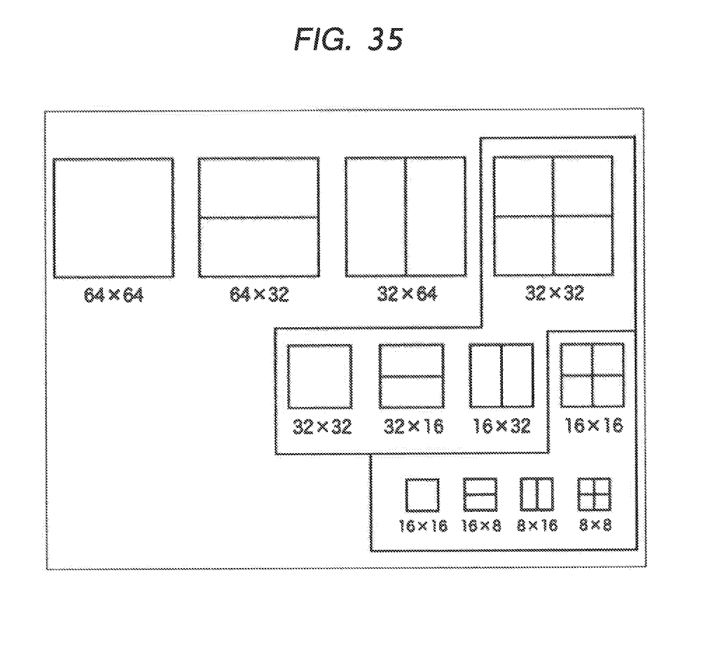

In addition, for example, besides macroblocks equal in size to or smaller than 16×16 stipulated in the specifications of the Ave encoding scheme or the like (hereinafter, referred to as macroblock), macroblocks having an expanded size (hereinafter, referred to as expanded macroblock), for example, 32×32 pixels or 64×64 pixels, as illustrated in FIG. 35, are proposed, for example, in Non-Patent Document 1. However, the above-described adaptive code number allocation can be applied to the intra prediction of the expanded macroblocks. Even in such a case, the same method may be applied,

Moreover, the code number allocation for each macroblock size may be performed independently of each other. For example, the code number allocations for a 4×4 macroblock, a 8×8 macroblock, a 16×16 macroblock, a 32×32 macroblock, a 64×64 macroblock, and a macroblock of a chrominance signal may be independently performed of each other. With this method, more highly adaptive code number allocation can be realized.

In addition, the default_ipred_code_number_allocation_flag may be prepared for each macroblock size.

In addition, the above-described adaptive code number allocation may be performed only for the expanded macroblock, and a pre-defined allocation method as defined in the AVC encoding scheme may be applied to normal macroblocks.

That is, within a slice, the above adaptive code number allocation may be applied to only part of intra macroblocks and the fixed allocation method may be applied to the other intra macroblocks.

The lower limit of the size of the block to which the adaptive code number allocation method can be applied is arbitrarily determined. For example, it may be applied to a macroblock of 8×8 or larger, or to a macroblock of 64×64 or larger. In addition, whether to or not to apply the adaptive code number allocation method may be determined based on an arbitrary parameter other than the size of the macroblock.

In addition, in the encoded data, flag information that indicates the application of the adaptive code number allocation may be added to the header of the block to which the adaptive code number allocation is applied. In such a case, the image decoding device 200 can easily identify whether the code number allocation method of each macroblock is fixed or not, based on the flag information.

The initial value of the code number allocation which is set with regard to the IDR slice or the like is arbitrary. The allocation method adopted in the AVC encoding scheme or the like may be applied, or the allocation method set by the user may be applied.

When the allocation method set by the user is used, information (for example, table information that associates prediction modes and code numbers with each other, or the like) that indicates user's setting (the code number allocation method set by the user) may be supplied from the image encoding device 100 to the image decoding device 200 so that the image decoding device 200 can identify the allocation method.

Furthermore, flag information that indicates whether the code number allocation method is the adaptive updating method, the initial setting, or the user's setting may be supplied from the image encoding device 100 to the image decoding device 200. In this case, the image decoding device 200 can easily identify the code number allocation method adopted in the image encoding device 100.

In addition, a process of counting the occurrences of each prediction mode for the last frame of the image data of a moving image may be eliminated.

In addition, the above description is made in connection with a case where the present technology is applied to the intra mode in the intra macroblock. However, the same technology also may be applied to other syntax elements, for example, the motion compensation partition mode or the like.

The above description has been made in connection with the image encoding device that performs encoding according to the scheme provided by the AVC and the image decoding device that performs decoding according to the scheme provided by the AVC as an example. However, the application range of the present technology is not limited thereto. The present technology is applicable to image encoding devices and image decoding devices which perform encoding processing based on layered blocks as illustrated in FIG. 35.

### 3. Third Embodiment

### Personal Computer

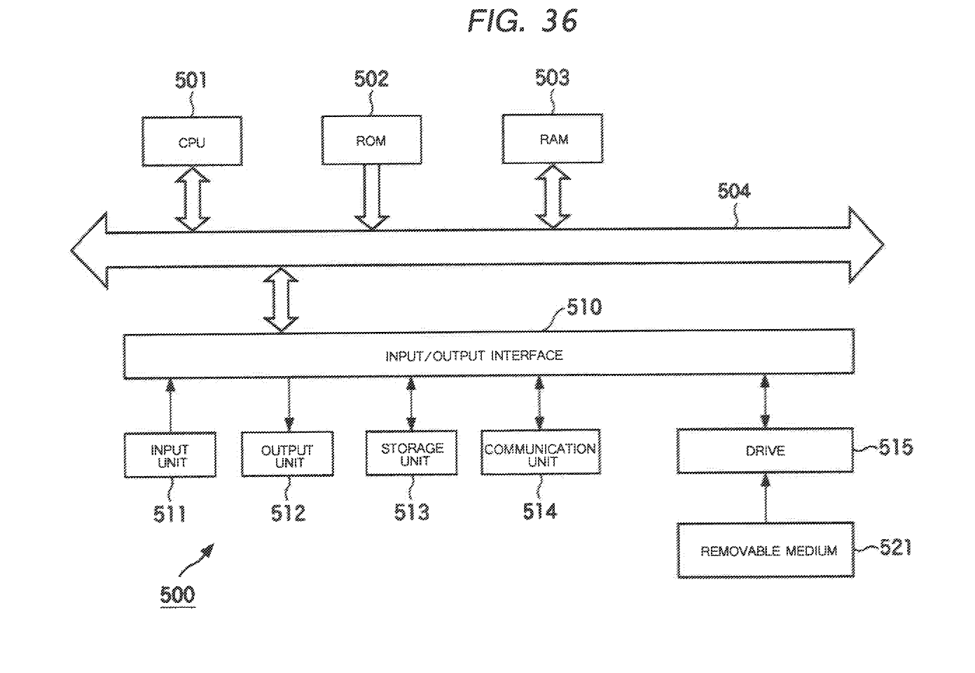

The above series of processing may be implemented in hardware or software. In such a case, for example, it may be configured as a personal computer (PC) illustrated in FIG. 36.

In FIG. 36, a CPU (Central Processing Unit) 501 of a personal computer 500 executes a variety of processing in accordance with a program which is stored in a ROM (Read Only Memory) 502 or loaded into a RAM (Random Access Memory) 503 from a storage unit 513. The RAM 503 also suitably stores data necessary for a variety of processing executed by the CPU 501.

The CPU 501, the ROM 502, and the RAM 503 are connected to one another by a bus 504. An input output interface 510 is also connected to the bus 504.

An input unit 511 including a keyboard, a mouse, a microphone, etc; an output unit 512 including a display such as a CRT (Cathode Ray Tube) and an LCD (Liquid Crystal Display), a speaker, etc; a storage unit 513 configured as a hard disk, etc; and a communication unit 514 configured as a modem, etc. are connected to the input/output interface 510. The communication unit 514 performs communication processing over networks including the Internet.

A drive 515 is also connected to the input/output interface 510 as necessary. A removable medium 521 of a magnetic disc, an optical disc, a magneto optical disc, a semiconductor memory, or the like is suitably mounted in the input/output interface. Computer programs read the removal medium may be installed in the storage unit 513 as necessary.

When the above series of processing is executed by software, programs which constitute the software are installed from a network or a recording medium.

As illustrated in FIG. 36, the recording medium is a medium with programs recorded therein, which is delivered to users independently of a main body of an apparatus to distribute the programs. It is configured as the removable medium 521 such as a magnetic disc (including a flexible disc), an optical disc (including a CD-ROM (Compact Disc-Read Only Memory) and a DVD (Digital Versatile Disc)), a magneto optical disc (including an MD (Mini Disc)), a semiconductor memory, and so on. Moreover, it may be configured as the ROM 502 with programs recorded therein, a hard disc included in the storage unit 513, or the like, which is delivered to users as a built-in form in a main body of an apparatus.

In addition, the program executed by a computer may be a program to perform processes in a time series manner according the sequence described in the specification, or a program to perform processes in parallel or individually at necessary timing in a calling manner or the like.

Moreover, steps that describe a program recorded in a recording medium may include not only steps performed in time series manner according to the sequence described in the specification but also steps which are not necessarily executed in a time series manner but are executed in parallel or individually.

The term “system” in the specification represents the entirety of apparatus composed of a plurality of devices (or apparatuses).

Moreover, a configuration which has been described above as a single device (a processing unit) may be divided into a plurality of devices (or processing units). Conversely, a configuration which has been described above as a plurality of devices (processing units) may be integrated into a single device for processing unit). Configurations other than those described above may be added to each device (or each processing unit) described above. Moreover, part of the configuration of a certain device (or processing unit) may be incorporated in the configuration of another device (processing unit) as long as such a change guarantees that the configuration or operation of a hole system is substantially the same as the original one. Moreover, the invention is not limited by the embodiments of the present technology and a diversity of changes may be made without departing from the spirit of the present technology.

For example, the image encoding device and the image decoding device described above may be applied to arbitrary electronic devices. Hereinafter, examples thereof are described.

### 4. Fourth Embodiment

### Television

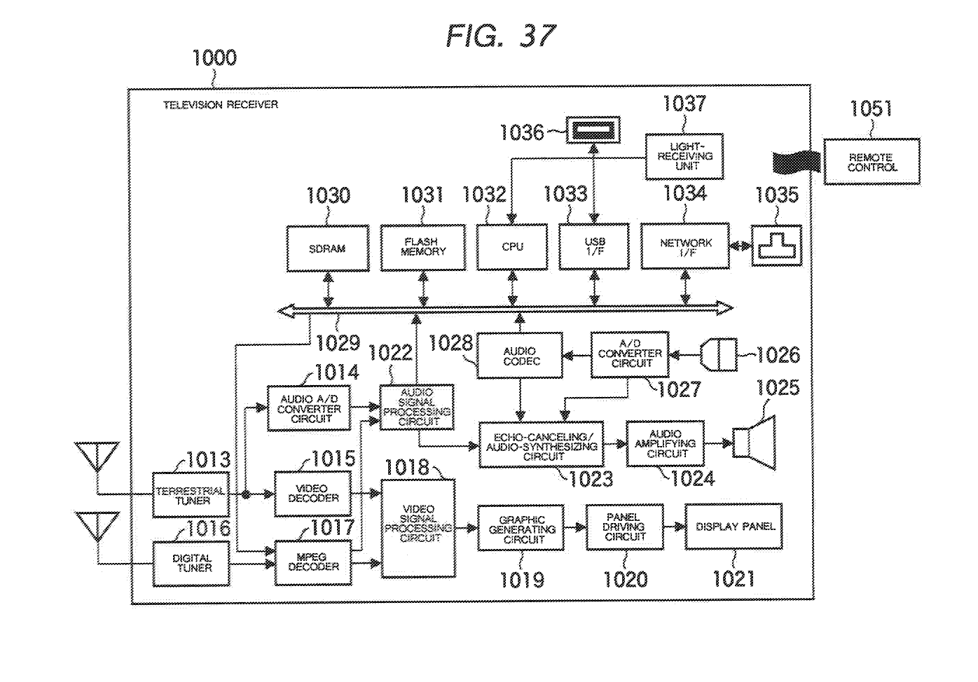

FIG. 37 is a block diagram that illustrates an example of a main configuration of a television which uses the image decoding device 200.

A television receiver 1000 illustrated in FIG. 37 includes a terrestrial tuner 1013, a video decoder 1015, a video signal processing circuit 1016, a graphic generating circuit 1019, a panel driving circuit 1020, and a display panel 1021.

The terrestrial tuner 1013 receives and demodulates a broadcasting wave signal of terrestrial analog broadcasting through an antenna to acquire a video signal, and supplies it to the video decoder 1015. The video decoder 1015 decodes the video signal supplied by the terrestrial tuner 1013, and supplies the obtained digital component signal to the video signal processing circuit 1018.

The video signal processing circuit 1018 performs prescribed processing such as noise reduction or the like on video data supplied by the video decoder 1015, and supplies the obtained video data to the graphic generating circuit 1019.

The graphic generating circuit 1019 generates video data of broadcasting programs to be displayed by the display panel 1021, image data obtained through certain processing based on applications supplied through networks, and/or the like, and supplies the generated video data and image data to the panel driving circuit 1020. Moreover, the graphic generating circuit 1019 properly performs the processing of generating the video data (graphic) used to display a screen to be used by the user, for example, for selection of items, and supplying video data obtained by superimposing the generated video data on video data of a broadcasting program to the panel driving circuit 1020.

The panel driving circuit 1020 drives the display panel 1021, based on the data supplied by the graphic generating circuit 1019, and displays the video of the broadcasting program or above-mentioned various screens on the display panel 1021.

The display panel 1021 is composed of an LCD (Liquid Crystal Display) and the like, and displays the video of a broadcasting program or the like under the control of the panel driving circuit 1020.

Moreover, the television receiver 1000 further includes an audio A/D (Analog/Digital) converter circuit 1014, an audio signal processing circuit 1022, an echo-canceling/audio-synthesizing circuit, an audio amplifier circuit 1024, and a speaker 1025.

The terrestrial tuner 1013 acquires not only the video signal but also the audio signal by demodulating the received broadcasting signal. The terrestrial tuner 1013 supplies the acquired audio signal to the audio A/D converter circuit 1014.

The audio A/D converter circuit 1014 converts the audio signal supplied by the terrestrial tuner 1013 from analog to digital, and supplies the obtained digital audio signal to the audio signal processing circuit 1022.

The audio signal processing circuit 1022 performs prescribed processing such as noise reduction or the like on audio data supplied by the audio A/D converter circuit 1014, and supplies the obtained audio data to an echo-canceling/audio-synthesizing circuit 1023.

The echo-canceling/audio-synthesizing circuit 1023 supplies the audio data supplied by the audio signal processing circuit 1022 to the audio amplifier circuit 1024.

The audio amplifier circuit 1024 performs D/A conversion processing and amplifying processing on the audio data supplied by the echo-canceling/audio synthesizing circuit 1023, adjusts the audio data to a prescribed volume level, and causes the audio to be output from the speaker 1025.

The television receiver 1000 yet further includes a digital tuner 1016 and an MPEG decoder 1017.

The digital tuner 1016 receives a broadcasting wave signal of digital broadcasting (terrestrial digital broadcasting, and BS (Broadcasting Satellite)/CS (Communications Satellite) digital broadcasting) through an antenna, demodulates the signal to acquire MPEG-TS (Moving Picture Experts Group-Transport Stream), and supplies it to the MPEG decoder 1017.

The MPEG decoder 1017 cancels the scramble given to the MPEG-TS supplied by the digital tuner 1016, and extracts a stream including data of a program which is a reproduction target (watching target). The MPEG decoder 1017 decodes audio packets of the extracted stream and supplies the obtained audio data to the audio signal processing circuit 1022 as well as decodes image packets of the stream and supplies the obtained video data to the video signal processing circuit 1018. Moreover, The MPEG decoder 1017 supplies EPG (Electronic Program Guide) data extracted from the MPEG-TS to a CPU 1032 through a path (not illustrated).

In this way, the television receiver 1000 uses the above-described image decoding device 200 as the MPEG decoder 1017 which decodes video packets. The MPEG-TS transmitted by a broadcasting station, etc. is encoded by the image encoding device 100.

The MPEG decoder 1017 reproduces the code number allocation method adopted in the image encoding device 100 by performing the adaptive code number allocation in accordance with the frequency of occurrence of the prediction mode like in the case of the image decoding device 200. Therefore, the MPEG decoder 1017 can appropriately decode the encoded data which is generated in a manner that the image encoding device 100 allocates a code number with a smaller value to a prediction mode with a higher frequency of occurrence. As a result, the MPEG decoder 1017 can improve the encoding efficiency of the encoded data

The video data supplied by the MPEG decoder 1017, like the case of the video data supplied by the video decoder 1015, is subjected to prescribed processing in the video signal processing circuit 1016, properly superimposed on the data generated by the graphic generating circuit 1019, and thereafter supplied to the display panel 1021 through the panel driving circuit 1020. As a result, the image is displayed.

The audio data supplied by the MPEG decoder 1017, like the case of the audio data supplied by the audio A/D converter circuit 1014, is subjected to prescribed processing in the audio signal processing circuit 1022, supplied to the audio amplifier circuit 1024 through the echo-canceling/audio-synthesizing circuit 1023, and subjected to the D/A conversion processing and the amplification processing. As a result, audio adjusted to a certain volume level is output from the speaker 1025.

Moreover, the television receiver 1000 yet further includes a microphone 1026 and an A/D converter circuit 1027.

The A/D converter circuit 1027 receives a signal of the voice of the user introduced into the microphone 1026 provided for voice conversation in the television receiver 1000, subjects the received audio signal to the A/D conversion processing, and supplies the obtained digital audio data to the echo-canceling/audio-synthesizing circuit 1023.

The echo-canceling/audio-synthesizing circuit 1023, when data of the voice of a user (user A) of the television receiver 1000 is supplied by the A/D converter circuit 1027, causes data of audio, which is obtained by subjecting the voice of the user A to echo cancellation and synthesizing it with different audio data, to be output from the speaker 1025 through the audio amplifier circuit 1024.

In addition, the television receiver 1000 includes an audio COmpressor/DECompressor (CODEC) 1028, an internal bus 1029, an SDRAM (Synchronous Dynamic Random Access Memory) 1030, a flash memory 1031, a CPU 1032, a USB (Universal Serial Bus) I/F 1033, and a network I/F 1034.

The A/C converter circuit 1027 receives a signal of the voice of the user introduced through the microphone 1026 for voice conversation installed in the television receiver 1000, performs the A/D conversion processing on the received audio signal, and supplies the obtained digital audio data to the audio CODED 1028.

The audio CODED 1028 converts the audio data supplied by the A/D converter circuit 1027 to data in a predetermined format suited for transmission over networks, and supplies the converted data to the network I/F 1034 through the internal bus 1029.

The network I/F 1034 is connected to a network via a cable attached to a network terminal 1035. For instance, the network I/F 1034 transmits the audio data supplied by the audio CODED 1028 to other devices connected to the network. Moreover, the network I/F 1034 receives audio data transmitted by other devices, which are connected thereto via the network, for instance, through the network terminal 1035, and supplies it to the audio CODED 1028 through the internal bus 1029.

The audio CODED 1028 converts the audio data supplied from the network I/F 1034 into the data in a prescribed format, and supplies the to the echo-canceling/audio-synthesizing circuit 1023.

The echo-canceling/audio-synthesizing circuit 1023 performs echo cancellation on the audio data supplied from the audio CODEC 1028, synthesizes the resultant audio data with different audio data to produce data of audio, and causes it to be output from the speaker 1025 through the audio amplifier circuit 1024.

The SDRAM 1030 stores a variety of data necessary for processing performed by the CPU 1032.

The flash memory 1031 stores programs executed by the CPU 1032. The program stored in the flash memory 1031 is read by the CPU 1032 at prescribed timing, for example, at the activation of the television receiver 1000. The flash memory 1031 also stores EPG data acquired by digital broadcasting, data acquired from a prescribed server through a network, and the like.

For example, the MPEG-TS including contents data which is acquired from a prescribed server through a network under the control of the CPU 1032 is stored in the flash memory 1031. The flash memory 1031 supplies the MPEG-TS to the MPEG decoder 1017 through the internal bus 1029 by the control of the CPU 1032.

The MPEG decoder 1017 processes the MPEG-TS like the case of the MPEG-TS supplied by the digital tuner 1016. The television receiver 1000 receives the contents data composed of video data, audio data, etc through the network and decodes it with the MPEG decoder 1017, so that it can display the video and output the audio.

Moreover, the television receiver 1000 includes a light-receiving unit 1037 which receives an infrared ray signal sent by a remote control 1051.

The light-receiving unit 1037 receives an infrared ray from the remote control 1051, and outputs, to the CPU 1032, a control code that indicates the contents of the user's operation obtained by demodulating the infrared ray.

The CPU 1032 executes the program stored in the flash memory 1031, and controls the whole operation of the television receiver 1000 according to the control code, or the like supplied from the light-receiving unit 1037. The CPU 1032 and each unit of the television receiver 1000 are connected to each other through a path not illustrated).

The USE I/F 1033 exchanges data with external equipment which is disposed outside the television receiver 1000 and is connected thereto through a USE cable attached to a USE terminal 1036.

The network I/F 1034 is connected to a network through a cable attached to the network terminal 1035, and thus exchanges even data other than the audio data with various devices connected to the network.

The television receiver 1000 can improve the encoding efficiency of the broadcasting signal received through an antenna, or contents data acquired through the network, using the image decoding device 200 as the MPEG decoder 1017.

### 5. Fifth Embodiment

### Mobile Phone

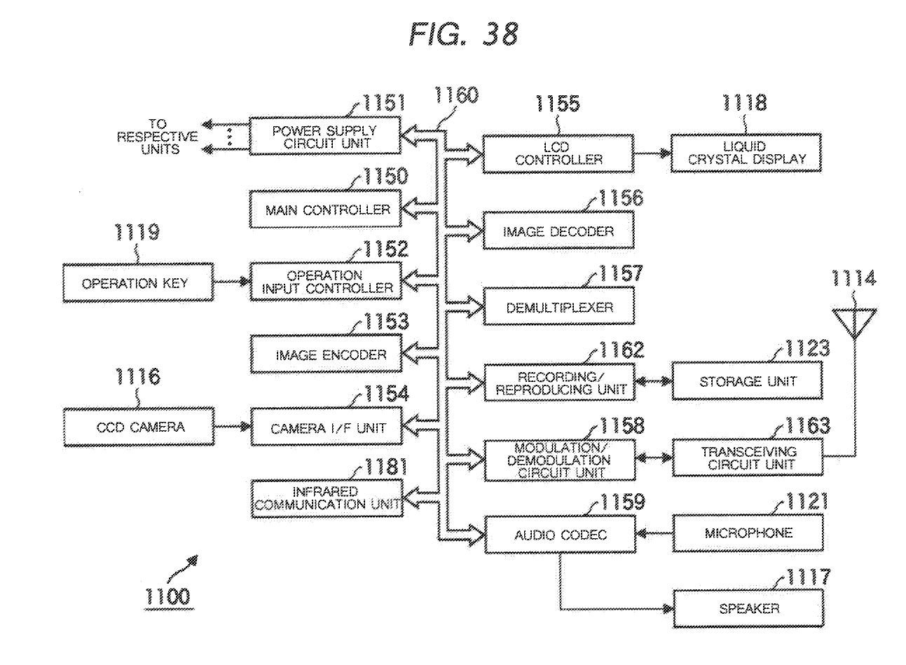

FIG. 38 is a block diagram that illustrates a main configuration of a mobile phone which uses the image encoding device 100 and the image decoding device 200.

A mobile phone 1100 illustrated in FIG. 38 includes a main controller 1150 which collectively controls each unit, a power supply circuit unit 1151, an operation input controller 1152, an image encoder 1153, a camera I/F unit 1154, an LCD controller 1155, an image decoder 1156, a demultiplexer 1157, a recording/reproducing unit 1162, a modulation/demodulation circuit unit 1158, and an audio CODEC 1159. These are mutually connected to one another via a bus 1160.

Moreover, the mobile phone 1100 includes operation keys 1119, a CCD (Charge Coupled Devices) camera 1116, a liquid crystal display 1118, a storage unit 1123, a transmitting/receiving circuit unit 1163, an antenna 1114, a microphone (mike) 1121, and a speaker 1117.

When a call-ending key or a power supply key is turned on by user's operation, the power supply circuit unit 1151 causes power to be supplied from a battery pack to each of the units, so that the mobile phone 1100 enters an operable state.

The mobile phone 1100 performs, based on the control of the main controller 1150 composed of a CPU, a ROM, a RAM, etc., various operations such as transmitting/receiving an audio signal, transmitting/receiving an electronic mail and image data, capturing an image, and recording data in various modes such as voice communication mode and data communication mode.

For instance, in the voice call mode, the mobile phone 1100 converts an audio signal, collected by the microphone (mike) 1121, into digital audio data using the audio CODEC 1159, subjects it to spread spectrum processing using the modulation/demodulation circuit unit 1158, and subjects the resultant data to D/A conversion processing and frequency transformation processing using the transmitting/receiving circuit unit 1163. The mobile phone 1100 transmits a signal for transmission obtained through those processing to a base station (not illustrated) through the antenna 1114. The signal for transmission (audio signal) transmitted to the base station is supplied to a mobile phone of an intended call party through the public telephone network.

Moreover, for instance, in the voice call mode, the mobile phone 1100 amplifies the received signal, received through the antenna 1114, using the transmitting/receiving circuit unit 1163, subjects the resultant signal to frequency transformation processing and A/D conversion, subjects the resultant signal to inverse spread spectrum processing performed by the modulation/demodulation circuit unit 1158, and converts the resultant signal into an analog audio signal using the audio CODED 1159. The mobile phone 1100 outputs the analog voice signal obtained by the conversion, from the speaker 1117.

In addition, for example, when transmitting an electronic mail in the data communication mode, the mobile phone 1100 receives text data of the electronic mail, which is input by operating the operation keys 1119, with the operation input controller 1152. The mobile phone 1100 processes the text data with the main controller 1150, and displays it on the liquid crystal display 1118 as an image through the LCD controller 1155.

Moreover, the mobile phone 1100 generates electronic mail data with the main controller 1150, based on the text data received by the operation input controller 1152, user' instructions, etc. The mobile phone 1100 subjects the electronic mail to spread spectrum processing performed by the modulation/demodulation circuit unit 1158, and subjects the resultant to the D/A conversion processing and the frequency transformation processing performed by the transmitting/receiving circuit unit 1153. The mobile phone 1100 transmits a signal for transmission obtained through those processing to the base station (not illustrated) through the antenna 1114. The signal for transmission (electronic mail) transmitted to the base station is supplied to a prescribed address through a network, and a mail server, etc.

Moreover, for example, when receiving an electronic mail in the data communication mode, the mobile phone 1100 receives a signal transmitted by the base station through the antenna 1114, amplifies the signal, and subjects the signal to the frequency transformation processing and the A/D conversion performed by the transmitting/receiving circuit unit 1163. The mobile phone 1100 restores the original electronic mail from the received signal by subjecting the received signal to the inverse spread spectrum processing performed by the modulation/demodulation circuit unit 1158. The mobile phone 1100 displays the restored electronic mail data on the liquid crystal display 1118 through the LCD controller 1155.

The mobile phone 1100 also can record (store) the received electronic mail data in the storage unit 1123 by using the recording/reproducing unit 1162.

The storage unit 1123 is a rewritable arbitrary storage medium. The storage unit 1123 may be, for instance, a semiconductor memory such as a RAM and a built-in flash memory, or may be a hard disc. It also may be a removable medium such as a magnetic disc, a magneto-optical disc, an optical disc, a USB memory, and a memory card. Of course, they may be a one other than these.

In addition, for example, when transmitting image data in the data communication mode, the mobile phone 1100 generates image data by capturing an image using the CCD camera 1116. The CCD camera 1116 includes an optical device such as a lens and a diaphragm, and a COD serving as a photoelectric conversion element, takes an image of a subject, converts the intensity of received light into an electrical signal, and generates image data of the image of the subject. The COD camera 1116 encodes the image data using the image encoder 1153 through the camera I/F unit 1154, thereby converting the image data into the encoded image data.

The mobile phone 1100 uses the image encoding device 100 described above as the image encoder 1153 that performs this processing. The image encoder 1153 adaptively allocates a code number in accordance with the frequency of occurrence of a prediction mode like in the case of the image encoding device 100. That is, the image encoder 1153 can allocate a code number with a smaller value to a prediction mode, the frequency of occurrence of which was higher in the immediately previous slice (frame), during intra prediction. As a result, the image encoder 1153 can improve the encoding efficiency of the encoded data.

Moreover, at the same time as the above processing, the mobile phone 1100 performs A/D conversion on the sound collected by the microphone (mike) 1121 while the image capturing is being performed by the COD camera 1116, using the audio CODEC 1159, and then encodes it.

The mobile phone 1100 multiplexes the digital audio data supplied by the audio CODED 1159 and the encoded image data supplied by the image encoder 1153 using the demultiplexer 1157 according to a prescribed scheme. The mobile phone 1100 subjects the multiplexed data obtained as the result thereof to the spread spectrum processing performed by the modulation/demodulation circuit unit 1158, and subjects the resultant to the D/A conversion processing and the frequency transformation processing performed by the transmitting/receiving circuit unit 1163. The mobile phone 1100 transmits a signal for transmission obtained through those processing to a base station (not illustrated) through the antenna 1114. The signal for transmission (image data) transmitted to the base station is supplied to a call party through a network, etc.

When the image data is not to be transmitted, the mobile phone 1100 can display the image data generated by using the CCD camera 1116 on the liquid crystal display 1118 through the LCD controller 1155, without allowing the generated image to pass through the image encoder 1153.

Moreover, for example, when receiving data of a moving image file linked to a temporary home page in the data communication mode, the mobile phone 1100 receives a signal transmitted by the base station through the antenna 1114, amplifies the signal, and subjects the signal to the frequency transformation processing and the A/D conversion performed by the transmitting/receiving circuit unit 1163. The mobile phone 1100 restores the multiplexed data from the received signal by subjecting the received signal to the inverse spread spectrum processing performed by the modulation/demodulation circuit unit 1158. The mobile phone 1100 separates the multiplexed data into encoded image data and encoded audio data using the demultiplexer 1157.

The mobile phone 1100 decodes the encoded image data using the image decoder 1156 to generate reproduction moving image data and displays it on the liquid crystal display 1118 through the LCD controller 1155. As a result, for example, the moving image data included in the moving image file linked to the temporary home page is displayed on the liquid crystal display 1118.

The mobile phone 1100 uses the image decoding device 200 described above as the image decoder 1156 that performs this processing. That is, the image decoder 1156 reproduces the code number allocation method adopted in the image encoding device 100 by performing the adaptive code number allocation in accordance with the frequency of occurrence of the prediction mode like in the case of the image decoding device 200. Therefore, the image decoder 1156 can appropriately decode the encoded data, which is generated by the image encoding device 100 by allocating a code number with a smaller value to a prediction with a higher frequency of occurrence. As a result, the image decoder 1156 can improve the encoding efficiency of the encoded data.

At this point, at the same time as the processing, the mobile phone 1100 converts digital audio data into the analog audio signal by using the audio CODEC 1159, and outputs this from the speaker 1117. As a result, for example, the audio data included in the moving image file linked to the temporary home page is reproduced.

Like in the case of the electronic mail, the mobile phone 1100 also can record (store) the received data linked to the temporary home page, etc. in the storage unit 1123 by using the recording/reproducing unit 1162.

Moreover, the mobile phone 1100 analyzes two dimension codes, which are captured and obtained by using the COD camera 1116, and can acquire information recorded in the two dimension codes by using the main controller 1150.

In addition, the mobile phone 1100 can communicate with an external device, by infrared rays through the IR communication unit 1181.

The mobile phone 1100 can improve the encoding efficiency of the encoded data by using the image encoding device 100 as the image encoder 1153, for example, when encoding and transmitting the image data generated by the COD camera 1116.

The mobile phone 1100 can improve the encoding efficiency of, for example, the data (encoded data) of the moving image file linked to the temporary home page or the like by using the image decoding device 200 as the image decoder 1156.

Moreover, although the description has been made about a case where the mobile phone 1100 uses the COD camera 1116, an image sensor (CMOS image sensor) that employs CMOS (Complementary Metal Oxide Semiconductor) may be used instead of the COD camera 1116. Even in this case, the mobile phone 1100 can image a subject and generate image data of the image of the subject like the case of using the CCD camera 1116.

Moreover, although the above description has been made about the mobile phone 1100 as an example, but the image encoding device 100 and the image decoding device 200 can be applied to any apparatus in the same manner as in the mobile phone 1100 as long as the apparatus has an image capturing function and a communication function like the mobile phone 1100. Examples of the apparatus may include a PDA (Personal Digital Assistants), a smart phone, a UMPO (Ultra Mobile Personal Computer), a net hook, and a note type personal computer.

### 6. Sixth Embodiment

### Hard Disc Recorder

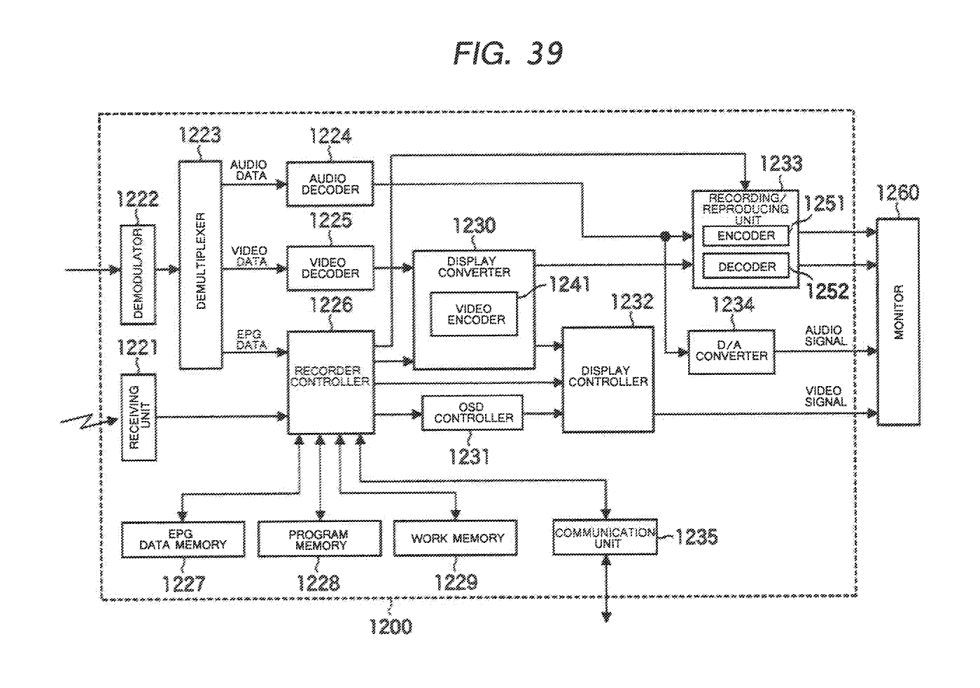

FIG. 39 is a block diagram that illustrates a main configuration of a hard disc recorder which uses the image encoding device 100 and the image decoding device 200.

A hard disc recorder (HDD recorder) 1200 illustrated in FIG. 39 is an apparatus that preserves audio data and video data of a broadcasting program included in a broadcasting wave signal (television signal) which is transmitted from a satellite, or an antenna on the ground and received by a tuner, in a built-in hard disc, and provides the preserved data to the user at timing according to an instruction of the user.

The hard disc recorder 1200 extracts, for example, the audio data and the video data from the broadcasting wave signal, decodes them properly, and can store them in the built-in hard disc. The hard disc recorder 1200 can acquire the audio data and the video data, for example, from other devices through networks, properly decode them, and store them in the built-in hard disc.

In addition, the hard disc recorder 1200 may decode the audio data and the video data recorded in the built-in hard disc for example, and supply them to a monitor 1260 so that the image thereof can be displayed on a screen of the monitor 1260 and the audio thereof can be output from a speaker of the monitor 1260. Moreover, the hard disc recorder 1200 also can decode the audio data and the video data extracted from the broadcasting wave signal acquired through the tuner, or the audio data and the video data acquired from other devices through the network, and supply the decoded data to the monitor 1260, so that the image thereof can be displayed on the screen of the monitor 1260 and the audio thereof can be output from the speaker of the monitor 1260.

Of course, other kinds of operations are also possible.

As illustrated in FIG. 39, the hard disc recorder 1200 includes a receiving unit 1221, a demodulator 1222, a demultiplexer 1223, an audio decoder 1224, a video decoder 1225, and a recorder controller 1226. In addition, the hard disc recorder 1200 further includes an EPG data memory 1227, a program memory 1228, a work memory 1229, a display converter 1230, an OSD (On Screen Display) controller 1231, a display controller 1232, a recording/reproducing unit 1233, a D/A converter 1234, and a communication unit 1235.

Moreover, the display converter 1230 includes a video encoder 1241. The recording/reproducing unit 1233 includes an encoder 1251 and a decoder 1252.

The receiving unit 1221 receives an infrared signal from a remote control (not illustrated), converts it into an electrical signal, and outputs to the recorder controller 1226. The recorder controller 1226 is configured as a microprocessor for example, and executes various kinds of processing according to a program stored in the program memory 1228. At this time, the recorder controller 1226 uses the work memory 1229 as necessary.

The communication unit 1235 is connected to the network, and performs communication processing with other devices through the network. For example, the communication unit 1235 is controlled by the recorder controller 1226, communicates with a tuner (not illustrated), and outputs mainly a channel selection control signal to the tuner.

The demodulator 1222 demodulates the signal supplied by the tuner, and outputs it to the demultiplexer 1223. The demultiplexer 1223 separates the data supplied from the demodulator 1222 into audio data, video data, and EPG data and outputs them to the audio decoder 1224, the video decoder 1225, and the recorder controller 1226, respectively.

The audio decoder 1224 decodes the input audio data, and outputs to the recording/reproducing unit 1233. The video decoder 1225 decodes the input video data, and outputs to the display converter 1230. The recorder controller 1226 supplies the input EPG data to the EPG data memory 1227 so as to be stored.

For instance, the display converter 1230 encodes the video data supplied by the video decoder 1225 or the recorder controller 1226 into video data in NTSC (National Television Standards Committee) format with the video encoder 1241, and outputs to the recording/reproducing unit 1233. Moreover, the display converter 1230 converts the size of the screen of the video data supplied by the video decoder 1225 or the recorder controller 1226 into the size corresponding to the size of the monitor 1260, converts the data into video data in the NTSC format with the video encoder 1241, converts it into an analog signal, and outputs to the display controller 1232.

The display controller 1232 superimposes an OSD signal output by the OSD (On Screen Display) controller 1231 on the video signal input from the display converter 1230, under the control of the recorder controller 1226, and outputs the resultant to a display of the monitor 1260 for display.

The audio data which is output by the audio decoder 1224, is converted into an analog signal by the D/A converter 1234 and supplied to the monitor 1260. The monitor 1260 outputs this audio signal from its own built-in speaker.

The recording/reproducing unit 1233 includes a hard disc as a storage medium in which the video data, the audio data, etc are recorded.

For instance, the recording/reproducing unit 1233 encodes the audio data, which is supplied by the audio decoder 1224, with the encoder 1251. Moreover, the recording/reproducing unit 1233 encodes the video data, which is supplied by the video encoder 1241 of the display converter 1230, with the encoder 1251. The recording/reproducing unit 1233 synthesizes the encoded data obtained by encoding the audio data and the encoded data obtained by encoding the video data with the multiplexer. The recording/reproducing unit 1233 amplifies the synthesized data by channel coding, and writes the data in the hard disc through a recording head.

The recording/reproducing unit 1233 reproduces data recorded in the hard disc with the reproducing head, amplifies the data, and divides the data into audio data and video data with a demultiplexer. The recording/reproducing unit 1233 decodes the audio data and the video data with the decoder 1252. The recording/reproducing unit 1233 converts the decoded audio data from digital to analog, and outputs the resultant to the speaker of the monitor 1260. Moreover, the recording/reproducing unit 1233 converts the decoded video data from digital to analog, and outputs the resultant to the display of the monitor 1260.

The recorder controller 1226 reads the latest EPG data from the EPG data memory 1227, based on the user instruction indicated by the infrared signal which is supplied from the remote control and received through receiving unit 1221, and supplies it to the OSD controller 1231. The OSD controller 1231 generates the image data corresponding to the input EPG data, and outputs it to the display controller 1232. The display controller 1232 outputs the video data, input from the OSD controller 1231, to the display of the monitor 1260 for display. The display controller 1232 outputs the video data, input from the OSD controller 1231, to the display of the monitor 1260 for display. As a result, an EFG (Electronic Program Guide) is displayed on the display of the monitor 1260.

Moreover, the hard disc recorder 1200 can acquire various kinds of data such as the video data, the audio data, and the EPG data supplied by other devices through a network such the Internet.

The communication unit 1235 is controlled by the recorder controller 1226, acquires the encoded data obtained by the video data, the audio data, and the EPG data, etc. transmitted from other devices through a network, and supplies it to the recorder controller 1226. The recorder controller 1226 supplies, for example, the acquired encoded data obtained by encoding the video data and the audio data to the recording/reproducing unit 1233, and stores it in the hard disc. At this time, the recorder controller 1226 and the recording/reproducing unit 1233 may perform processing such as re-encoding, as necessary.

Moreover, the recorder controller 1226 decodes the acquired encoded data which is obtained by encoding the video data and the audio data, and supplies the obtained video data to the display converter 1230. The display converter 1230 processes the video data supplied by the recorder controller 1226 as well as the video data supplied by the video decoder 1225, supplies to the monitor 1260 through the display controller 1232, and displays the image.

Moreover, in synchronization with the display of the image, the recorder controller 1226 may supply the decoded audio data to the monitor 1260 through the D/A converter 1234 so that audio may be output from the speaker.

In addition, the recorder controller 1226 decodes the acquired encoded data which is obtained by encoding the EPG data, and supplies the decoded EPG data to the EPG data memory 1227.

The above-mentioned hard disc recorder 1200 uses the image decoding device 200 as the video decoder 1225, the decoder 1252, and the built-in decoder in the recorder controller 1226. That is, the video decoder 1225, the decoder 1252, and the built-in decoder in the recorder controller 1226 reproduce the code number allocation method adopted in the image encoding device 100 by performing the adaptive code number allocation in accordance with the frequency of occurrence of the prediction mode like the case of the image decoding device 200. Therefore, the video decoder 1225, the decoder 1252, and the built-in decoder in the recorder controller 1226 can appropriately decode the encoded data, which is generated by the image encoding device 100 by allocating a code number with a smaller value to a prediction with a higher frequency of occurrence. Therefore, the video decoder 1225, the decoder 1252, and the built-in decoder in the recorder controller 1226 can improve the encoding efficiency of the encoded data

Accordingly, the hard disc recorder 1200 can improve the encoding efficiency of the video data (encoded data) received by, for example, the tuner or the communication unit 1235, or the video data (encoded data) reproduced by the recording/reproducing unit 1233.

Moreover, the hard disc recorder 1200 uses the image encoding device 100 as the encoder 1251. Accordingly, the encoder 1251 performs an adaptive code number allocation in accordance with the frequencies of occurrence of prediction modes like the case of the image encoding device 100. That is, the encoder 1251 can allocate a code number with a smaller value to a prediction mode, the frequency of occurrence of which was higher in the immediately previous slice (frame), during the intra prediction. As a result, the encoder 1251 can improve the encoding efficiency of the encoded data.

Therefore, the hard disc recorder 1200 can improve the encoding efficiency of the encoded data to be recorded in the hard disc for instance.

Moreover, although the description in the above has been made about the hard disc recorder 1200 that records the video data and/or the audio data in a hard disc. However, any recording medium may be used. Like the case of the abode-described hard disc recorder 1200, the image encoding device 100 and the image decoding device 200 can be applied to any recorders which each use a recording medium other than the hard disc, for example, a flash memory, an optical disc, or a video tape.

### 7. Seventh Embodiment

### Camera

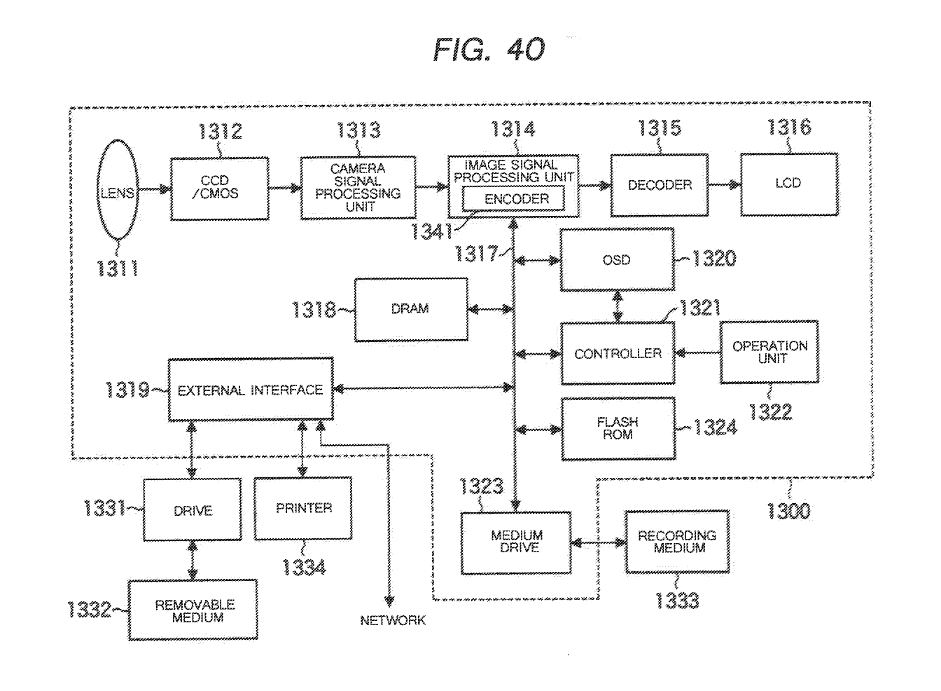

FIG. 40 is a block diagram that illustrates an example of a main configuration of a camera which uses the image encoding device 100 and the image decoding device 200.

A camera 1300 illustrated in FIG. 40 takes an image of a subject, displays the image of the subject on an LCD 1316, or records it in a recording medium 1333 as image data

A lens block 1311 causes light (that is, the image of the subject) to be incident on a CCD/CMOS 1312. The CCD/CMOS 1312 is an image sensor using CCD or CMOS, converts the intensity of the received light into an electrical signal, and supplies it to a camera signal processing unit 1313.

The camera signal processing unit 1313 converts the electrical signal supplied by the CCD/CMOS 1312 into chrominance signals between Y, Cr, and Cb, and supplies them to an image signal processing unit 1314. The image signal processing unit 1314 performs prescribed image processing on an image signal supplied by the camera signal processing unit 1313 under the control of a controller 1321, or encodes the image signal using an encoder 1341. The image signal processing unit 1314 supplies the encoded data generated by encoding the image signal to a decoder 1315. In addition, the image signal processing unit 1314 acquires data for display which is generated in an On-Screen Display (OSD) 1320, and supplies it to the decoder 1315.

In the above-mentioned processing, the camera signal processing unit 1313 properly uses a DRAM (Dynamic Random Access Memory) 1318 connected thereto through a bus 1317, to store the image data, encoded data obtained by encoding the image data, and/or the like in the DRAM 1318 as necessary.

The decoder 1315 decodes the encoded data supplied from the image signal processing unit 1314, and supplies the obtained image data (decoded image data) to the LCD 1316. Moreover, the decoder 1315 supplies the data for display, which is supplied from the image signal processing unit 1314, to the LCD 1316. The LCD 1316 properly synthesizes the image of the data for display and the image of the decoded image data supplied by the decoder 1315, and displays the synthesized image.

The on-screen display 1320 outputs, under the control of the controller 1321, display data (e.g., menu screens each composed of symbols, characters, and diagrams; icons; and/or the like) to the image signal processing unit 1314 through the bus 1317.

The controller 1321 executes various processing, based on a signal that indicates the contents of user's instruction which is made with an operation unit 1322, and controls the image signal processing unit 1314, the DRAM 1318, an external interface 1319, the on-screen display 1320, a media drive 1323, etc. through the 1317. Programs, data, and/or the like necessary to enable the controller 1321 to execute various processing are stored in a flash ROM 1324.

For example, the controller 1321 can encode the image data stored in the DRAM 1318 or decode the encoded data stored in the DRAM 1318, in place of the image signal processing unit 1314 and the decoder 1315. At this time, the controller 1321 may perform the encoding/decoding processing using a scheme which is the same as the encoding/decoding scheme of the image signal processing unit 1314 and the decoder 1315, or may perform the encoding/decoding processing using a scheme which is not supported by the image signal processing unit 1314 and the decoder 1315.

Moreover, for example, when there is an instruction to start an image printing operation supplied from the operation unit 1322, the controller 1321 reads out the image data from the DRAM 1318, supplies it to a printer 1334, connected the external interface 1319, through the bus 1317 for printing.

Moreover, for example, when there is an instruction to start an image recording operation supplied from the operation unit 1322, the controller 1321 reads out the image data from the DRAM 1318, supplies it to a recording medium 1333, mounted in a media drive 1323, through the bus 1317 for storing.

The recording medium 1333 is an arbitrary readable/writable removable medium, for example, a magnetic disc, a magneto optical disc, an optical disc, a semiconductor memory, or the like. The recording medium 1333 is also a removable medium of an arbitrary kind. That is, it may be a tape device, may be a disc, or may be a memory card. Of course, it may be a contactless IC card, etc.

Moreover, the media drive 1323 and the recording medium 1333 may be integrally formed like a non-transportable storage medium such as a built-in hard disc drive, a built-in SSD (Solid State Drive), etc., for instance.

The external interface 1319 is configured as a USB input/output terminal for instance, and comes in connection with the printer 1334 when to print an image. Moreover, a drive 1331 is also connected to the external interface 1319 as necessary. A removable medium 1332 such as a magnetic disc, an optical disc, a magneto optical disc, or a semiconductor memory is suitably mounted in the external interface so that computer programs read therefrom may be installed in the flash ROM 1324, as necessary.

In addition, the external interface 1319 includes a network interface to be connected to prescribed networks such as LAN, the Internet, etc. The controller 1321 can read the encoded data from the DRAM 1318, for instance, according to the instruction supplied from the operation unit 1322, and enables the encoded data to be supplied from the external interface 1319 to other external devices connected thereto through the network. Moreover, the controller 1321 can acquire the encoded data and/or the image data, supplied by other devices through the network, through the external interface 1319, and store it in the DRAM 1318 or supply it to the image signal processing unit 1314.

The above-mentioned camera 1300 uses the image decoding device 200 as the decoder 1315. That is, the decoder 1315 reproduces the code number allocation method adopted in the image encoding device 100 by performing the adaptive code number allocation in accordance with the frequencies of occurrence of the prediction modes like the case of the image decoding device 200. Therefore, the decoder 1315 can appropriately decode the encoded data, which is generated by the image encoding device 100 by allocating a code number with a smaller value to a prediction with a higher frequency of occurrence. As a result, the decoder 1315 can improve the encoding efficiency of the encoded data

Therefore, the camera 1300 can improve the encoding efficiency of the encoded data of the image data generated in the CCD/CMOS 1312, the encoded data of the video data read from the DRAM 1318 or the recording medium 1333, and/or the encoded data of the video data acquired through the network.

Moreover, the camera 1300 uses the image encoding device 100 as the encoder 1341. The encoder 1341 adaptively allocates code numbers in accordance with the frequencies of occurrence of prediction modes like the case of the image encoding device 100. That is, the encoder 1341 can allocate a code number with a smaller value to a prediction mode, the frequency of occurrence of which was higher in the immediately previous slice (frame), during the intra prediction. As a result, the encoder 1341 can improve the encoding efficiency of the encoded data

Therefore, the camera 1300 can improve the encoding efficiency of the encoded data to be recorded in the DRAM 1318 or the recording medium 1333 and/or the encoded data to be provided to other devices, for instance.

Moreover, a decoding method of the image decoding device 200 may be applied to decoding processing performed by the controller 1321. Moreover, an encoding method of the image encoding device 100 may be applied to encoding processing performed by the controller 1321.

Moreover, the image data which is a result of image capturing of the camera 1300 may be a moving image, or a still image.

In addition, when the camera 1300 that captures a moving image stops capturing an image once and then resumes the image capturing, according to the user's operation; the counting result (the frequencies of occurrence of prediction modes) with respect to the last frame captured when the image capturing is stopped may be stored, and then code numbers which are adaptively set by using the stored last counting result (the frequencies of occurrence of prediction modes) are allocated for the first frame captured when the following image capturing is resumed.

For the camera 1300, a case where the user frequently repeats starting and stopping the image capturing is considered. When this processing is repeated in a short time, the difference between frames is as small as in a case where continuous image capturing is performed, and there is the possibility that the similarity in design between the last frame of the preceding image capturing and the first frame of the following image capturing thereof is high. For instance, even a case is considered where the user captures an image of a certain subject using the camera 1300, stops capturing an image of the subject, restarts capturing an image of the subject once again.

For this case, when the allocation of code numbers is initialized every time the image capturing is stopped, the improvement of the encoding efficiency is likely to be impaired because of the frequent repeats of the initialization. Therefore, as described above, since the last counting result of the previous image capturing can be used at the time of starting the following image capturing, the camera 1300 can improve the encoding efficiency even further.

Moreover, when a period, of time during which the counting result is preserved is limited and a predetermined time has elapsed from the stopping of the image capturing, the preserved counting result may be eliminated, and the allocation of code numbers may be initialized at the time of starting the following image capturing.

Of course, the image encoding device 100 and the image decoding device 200 are applicable to apparatuses and/or systems other than the above-mentioned apparatuses.

Like MPEG and H.26x for example, this technology is applicable to image encoding devices and image decoding devices used when image information (bit stream) compressed by orthogonal transformation such as discrete cosine transformation, and motion compensation is received through network media such as satellite broadcastings, cable TVs, the Internet, and mobile phones, or when processing is performed in storage media such as optical discs, magnetic discs, and flash memories.

The present technology can achieve the following configurations.

(1) An image processing apparatus comprising:

an intra prediction unit that performs intra prediction by using a plurality of prediction modes and selects an optimum prediction mode, based on an obtained result of prediction;

an updating unit that updates allocation of code numbers for the respective prediction modes of the intra prediction performed by the intra prediction unit such that a smaller value is allocated to a prediction mode with a higher frequency of occurrence; and

an encoding unit that encodes the code number allocated to the prediction mode of the intra prediction, executed by the intra prediction unit, according to the updated allocation of code numbers.

(2) The image processing apparatus according to (1), wherein the updating unit updates the allocation of code numbers, according to the frequency of occurrence, for at least one prediction mode among an intra 4×4 prediction mode, an intra 8×8 prediction mode, an intra 16×16 prediction mode, an intra prediction mode for an expanded macroblock, which is an encoding process unit, expanded to have a size larger than 16×16 pixels, and an intra prediction mode for a chrominance signal.
(3) The image processing apparatus according to (1) or (2), further comprising: an IDR slice detecting unit that detects an IDR slice and determines whether the current slice is an IDR slice, wherein the updating unit initializes the allocation of code numbers with respect to the slice and sets the allocation of code numbers to a predetermined initial value when the IDR detecting unit determines that the slice is an IDR slice.
(4) The image processing apparatus according to (3), wherein the initial value of the allocation of code numbers is a code number allocation method stipulated in an AVC encoding scheme,
(5) The image processing apparatus according to any one of (1) through (4), further comprising: a scene change detecting unit that detects a scene change in the current slice, wherein the updating unit initializes the allocation of code numbers with respect to the slice and sets the allocation of code numbers to a predetermined initial value when the scene change detecting unit determines that the scene change is included in the scene.
(6) The image processing apparatus according to (5), wherein the updating unit sets a value of flag information indicating the allocation of code numbers with respect to the slice is the allocation of code numbers updated by the updating unit or the predetermined initial value, to a value that indicates the initial value.
(7) The image processing apparatus according to any one of (1) through (6), wherein the updating unit updates the allocation of code numbers with respect to a next I slice, after encoding processing on the current I slice is finished, in a manner that a smaller value is allocated to each prediction mode with a higher frequency of occurrence in the I slice.
(8) The image processing apparatus according to any one of (1) through (7), wherein the updating unit sets the allocation of code numbers for intra macroblocks included in a P slice or a B slice to the predetermined initial value.
(9) The image processing apparatus according to any one of (1) through (7), wherein the updating unit updates the allocation of code numbers for intra macroblocks included in a P slice or a B slice to allocation of code numbers that is set with respect to an immediately previous slice.
(10) The image processing apparatus according to any one of (1) through (7), wherein the updating unit updates, when the number of intra macroblocks included in a P slice or a B slice is larger than a predetermined reference, the allocation of code numbers for the intra macroblocks included in the P slice or the B slice, in a manner that a smaller value is allocated to a prediction mode with a higher frequency of occurrence.
(11) The image processing apparatus according to any one of (1) through (10), wherein the updating unit updates even allocation of a code number for a motion compensation partition mode according to the frequency of occurrence of the mode.
(12) An image processing method of an image processing apparatus, comprising:

by an intra prediction unit, performing intra prediction by using a plurality of prediction modes and selecting an optimum prediction mode, based on an obtained result of prediction;

by an updating unit, updating allocation of code numbers for the respective the prediction modes of the intra prediction such that a smaller value is allocated to a prediction mode with a higher frequency of occurrence; and

by an encoding unit, encoding a code number allocated to the prediction mode of the intra prediction, executed by the intra prediction unit, according to the updated code number allocation.

(13) An image processing apparatus comprising:

a decoding unit that decodes a code number for a prediction mode of an intra prediction;

an updating unit that updates allocation of code numbers for the respective prediction modes of the intra prediction such that a smaller value is allocated to a prediction mode with a higher frequency of occurrence; and

an intra prediction unit that performs the intra prediction in a prediction mode corresponding to the code number decoded by the decoding unit, according to the code number allocation updated by the updating unit.

(14) An image processing method of an image processing apparatus, comprising:

by a decoding unit, decoding a code number for a prediction of an intra prediction;

by an updating unit, updating allocation of code numbers for the respective prediction modes of the intra prediction such that a smaller value is allocated to a prediction mode with a higher frequency of occurrence; and

by an intra prediction unit, performing the intra prediction in a prediction mode corresponding to the decoded code number, according to the updated code number allocation.

### REFERENCE SIGNS LIST

100 Image encoding device
114 Intra prediction unit
121 Code number allocating unit
151 IDR detecting unit
152 Scene change detecting unit
153 Code number determining unit
154 Prediction mode buffer
155 Prediction mode counting unit
200 Image decoding device
211 Intra prediction unit
221 Code number allocating unit
251 IDR detecting unit
252 Flag determining unit
253 Code number determining unit
254 Prediction mode buffer
255 Prediction mode counting unit

1. An image processing apparatus comprising
an intra prediction unit that performs intra prediction by using a plurality of prediction modes and selects an optimum prediction mode based on an obtained result of prediction;
an updating unit that updates allocation of code numbers for the respective prediction modes of the intra prediction performed by the intra prediction unit such that a smaller value is allocated to the prediction mode with a higher frequency of occurrence; and
an encoding unit that encodes the code number allocated to the prediction mode of the intra prediction, executed by the intra prediction unit, according to the code number allocation updated by the updating unit.

2. The image processing apparatus according to claim 1,
wherein the updating unit updates the allocation of code numbers, according to the frequency of occurrence, for at least one prediction mode among an intra 4×4 prediction mode, an intra 8×8 prediction mode, an intra 16×16 prediction mode, an intra prediction mode for an expanded macroblock, which is an encoding process unit, expanded to have a size larger than 16×16 pixels, and an intra prediction mode for a chrominance signal.

3. The image processing apparatus according to claim 1, further comprising
an IDR slice detecting unit that detects an IDR slice and determines whether the current slice is an IDR slice,
wherein the updating unit initializes the allocation of code numbers with respect to the slice and sets the allocation of code numbers to a predetermined initial value when the slice is determined to be the IDR slice by the detection of the IDR slice detecting unit.

4. The image processing apparatus according to claim 3,
wherein the initial value of the allocation of code numbers is a code number allocation method stipulated in an AVC encoding scheme.

5. The image processing apparatus according to claim 1, further comprising:
a scene change detecting unit that detects a scene change in the current slice,
wherein the updating unit initializes the allocation of code numbers with respect to the slice and sets the allocation of code numbers to a predetermined initial value when the scene change detecting unit determines that the scene change is included in the scene.

6. The image processing apparatus according to claim 5,
wherein the updating unit sets a value of flag information indicating that the allocation of code numbers with respect to the slice is the allocation of code numbers updated by the updating unit or the predetermined initial value, to a value indicating the initial value when the scene change detecting unit determines that the scene change is included in the scene.

7. The image processing apparatus according to claim 1,
wherein the updating unit updates the allocation of code numbers with respect to a next I slice after encoding processing on the current I slice is finished, in a manner that a smaller value is allocated to each prediction mode with a higher frequency of occurrence in the I slice.

8. The image processing apparatus according to claim 1,
wherein the updating unit sets the allocation of code numbers for intra macroblocks included in a P slice or a B slice to a predetermined initial value.

9. The image processing apparatus according to claim 1,
wherein the updating unit updates the allocation of code numbers for intra macroblocks included in a P slice or a B slice to the allocation of code numbers which is set with respect to an immediately previous I slice.

10. The image processing apparatus according to claim 1,
wherein the updating unit updates, when the number of intra macroblocks included in a P slice or a B slice is larger than a predetermined reference, the allocation of code numbers for intra macroblocks included in the P slice or the B slice such that a smaller value is allocated to a prediction mode with a higher frequency of occurrence.

11. The image processing apparatus according to claim 1,
wherein the updating unit updates even allocation of a code number for a motion compensation partition mode according to the frequency of occurrence of the mode.

12. An image processing method of an image processing apparatus, comprising:
by an intra prediction unit, performing intra prediction by using a plurality of prediction modes and selecting an optimum prediction mode, based on an obtained result of prediction;
by an updating unit, updating allocation of code numbers for the respective prediction modes of the intra prediction such that a smaller value is allocated to a prediction mode with a higher frequency of occurrence; and
by an encoding unit, encoding a code number for an executed prediction mode of the intra prediction, the code number being allocated according to the updated code number allocation.

13. An image processing apparatus comprising:
a decoding unit that decodes a code number for a prediction of intra prediction;
an updating unit that updates allocation of code numbers for the respective prediction modes of the intra prediction such that a smaller value is allocated to a prediction mode with a higher frequency of occurrence; and
an intra prediction unit that performs the intra prediction in a prediction mode corresponding to the code number decoded by the decoding unit, according to the allocation of code numbers updated by the updating unit.

14. An image processing method of an image processing apparatus, comprising:
by a decoding unit, decoding a code number for a prediction of intra prediction;
by an updating unit, updating allocation of code numbers for the respective prediction modes of the intra prediction such that a smaller value is allocated to a prediction mode with a higher frequency of occurrence; and
by an intra prediction unit, performing the intra prediction in a prediction mode corresponding to the decoded code number, according to the updated allocation of code numbers.
